(19) United States
(12) Patent Application Publication
(10) Pub. No.: US 2016/0359944 A1
(43) Pub. Date: Dec. 8, 2016

(54) METHOD FOR PROVIDING MULTIMEDIA SERVICE AND ELECTRONIC DEVICE THEREFOR

(71) Applicant: Samsung Electronics Co., Ltd., Gyeonggi-do (KR)

(72) Inventors: Suha YOON, Seoul (KR); Eun-Seok RYU, Seoul (KR); Euichang JUNG, Seoul (KR)

(73) Assignee: Samsung Electronics Co., Ltd.

(21) Appl. No.: 15/172,994

(22) Filed: Jun. 3, 2016

(30) Foreign Application Priority Data
Jun. 4, 2015 (KR) 10-2015-0079312

(51) Int. Cl. H04L 29/06; H04W 72/00; H04L 12/18

(52) U.S. Cl. CPC H04L 65/80; H04L 12/1886; H04L 65/607; H04L 65/604; H04L 65/4076; H04W 72/005

(57) ABSTRACT

A device and a method for providing multimedia content to various electronic devices are provided. A method for operating the electronic device includes establishing an MBMS session through a communication interface; receiving multimedia data through the MBMS session; receiving additional multimedia data through a unicast session in response to a user request, and reproducing a high quality multimedia content corresponding to the multimedia data by decoding the received multimedia data with the received additional multimedia data.

### PRIORITY

This application claims priority under 35 U.S.C. §119(a) to Korean Application Serial No. 10-2015-0079312, which was filed in the Korean Intellectual Property Office on Jun. 4, 2015, the entire content of which is incorporated herein by reference.

### BACKGROUND

1. Field of the Disclosure

The present disclosure relates generally to a device and a method for providing multimedia content to various electronic devices.

2. Description of the Related Art

Commonly, users of electronic devices can receive streaming multimedia content, such as news, soap operas, sporting events, etc., while commuting via subway trains, buses, etc.

Generally, when a streaming service is provided, an electronic device may receive streaming multimedia content from a multimedia server through a network, e.g., Long Term Evolution (LTE), Wideband Code Division Multiple Access (WCDMA), or Wi-Fi.

Multimedia content, which is streamed to electronic devices, may include broadcast content. In many cases, the broadcast content is simultaneously used by multiple users. Accordingly, a node (e.g., a network device or a content server) that provides multimedia content may switch to a multimedia broadcast multicast service (MBMS) mode, based on a total amount of multimedia content transmitted to at least one electronic device in a unicast mode, and then provide the multimedia content.

When switching multimedia content in the MBMS mode, the node that provides multimedia content may transmit the corresponding multimedia content such that all electronic devices that operate in the MBMS mode can receive the multimedia content. As a result, however, the node providing the multimedia content may not be able to satisfy the different quality levels of multimedia content expected by the electronic devices that have various display characteristics or various audio characteristics.

### SUMMARY

Accordingly, an aspect of the present disclosure is to provide a device and a method for providing multimedia content based on multimedia content quality of an electronic device.

Another aspect of the present disclosure is to provide a device and a method for providing an efficient multimedia service based on a quality of multimedia content in connection with an electronic device.

In accordance with an aspect of the present disclosure, an electronic device is provided, which includes a communication interface; a processor; and a memory that stores instructions that, when executed, cause the processor to: establish an MBMS session through the communication interface; receive multimedia data through the MBMS session; receive additional multimedia data through a unicast session in response to a user request; and reproduce a high quality multimedia content corresponding to the multimedia data by decoding the received multimedia data with the received additional multimedia data

In accordance with another aspect of the present disclosure, a method is provided for operating an electronic device. The method includes establishing an MBMS session through a communication interface; receiving multimedia data through the MBMS session; receiving additional multimedia data through a unicast session in response to a user request, and reproducing a high quality multimedia content corresponding to the multimedia data by decoding the received multimedia data with the received additional multimedia data.

In accordance with another aspect of the present disclosure, an electronic device is provided, which includes a communication; a processor; and a memory that stores instructions that, when executed, cause the processor to transmit multimedia content to an external device through a unicast session; to determine whether to switch an MBMS mode, based on an amount of the multimedia content transmitted; to establish an MBMS session through the communication interface, in response to determining to switch the MBMS mode; to determine a quality parameter, based on a service quality required by the external device; and to transmit a first portion of the multimedia content, which corresponds to the quality parameter, through the MBMS session.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 illustrates a system for providing a multimedia service according to an embodiment of the present disclosure;

FIG. 2 illustrates an electronic device in a network environment according to an embodiment of the present disclosure;

FIG. 3 illustrates an electronic device according to an embodiment of the present disclosure;

FIG. 4 illustrates a program module according to an embodiment of the present disclosure;

FIG. 5 illustrates an electronic device for transmitting multimedia content according to an embodiment of the present disclosure;

FIG. 6 illustrates a wireless communication system for transmitting multimedia content according to an embodiment of the present disclosure;

FIG. 7 illustrates a configuration for transmitting multimedia data, which has been encoded hierarchically, according to an embodiment of the present disclosure;

FIG. 8 illustrates a wireless communication system for switching to an MBMS mode according to an embodiment of the present disclosure;

FIG. 9 is a signal flow diagram illustrating a process of switching to an MBMS mode and transmitting multimedia content according to an embodiment of the present disclosure;

FIG. 10 illustrates a wireless communication system for switching to an MBMS mode according to an embodiment of the present disclosure;

FIG. 11 is a signal flow diagram illustrating a process of switching to an MBMS mode and transmitting multimedia content according to an embodiment of the present disclosure;

FIG. 12 illustrates a wireless communication system for switching to an MBMS mode according to an embodiment of the present disclosure;

FIG. 13 is a signal flow diagram illustrating a process of switching to an MBMS mode and transmitting multimedia content according to an embodiment of the present disclosure;

FIG. 14 illustrates a wireless communication system for switching to an MBMS mode according to an embodiment of the present disclosure;

FIG. 15 is a signal flow diagram illustrating a process of switching to an MBMS mode and transmitting multimedia content according to an embodiment of the present disclosure;

FIG. 16 illustrates a wireless communication system for switching to an MBMS mode according to an embodiment of the present disclosure;

FIG. 17 is a signal flow diagram illustrating a process of switching to an MBMS mode and transmitting multimedia content according to an embodiment of the present disclosure;

FIG. 18 illustrates a wireless communication system for switching to an MBMS mode according to an embodiment of the present disclosure;

FIG. 19 is a signal flow diagram illustrating a process of switching to an MBMS mode and transmitting multimedia content according to an embodiment of the present disclosure;

FIG. 20 illustrates a wireless communication system for switching to an MBMS mode according to an embodiment of the present disclosure;

FIG. 21 is a signal flow diagram illustrating a process of switching to an MBMS mode and transmitting multimedia content according to an embodiment of the present disclosure;

FIG. 22 illustrates a wireless communication system for switching to an MBMS mode according to an embodiment of the present disclosure;

FIG. 23 is a signal flow diagram illustrating a process of switching to an MBMS mode and transmitting multimedia content according to an embodiment of the present disclosure;

FIG. 24 illustrates a wireless communication system for switching to an MBMS mode according to an embodiment of the present disclosure;

FIG. 25 is a signal flow diagram illustrating a process of switching to an MBMS mode and transmitting multimedia content according to an embodiment of the present disclosure;

FIG. 26 illustrates a wireless communication system for switching to an MBMS mode according to an embodiment of the present disclosure;

FIG. 27 is a signal flow diagram illustrating a process of switching to an MBMS mode and transmitting multimedia content according to an embodiment of the present disclosure;

FIG. 28 illustrates a wireless communication system for switching to an MBMS mode according to an embodiment of the present disclosure;

FIG. 29 is a signal flow diagram illustrating a process of switching to an MBMS mode and transmitting multimedia content according to an embodiment of the present disclosure;

FIG. 30 illustrates a wireless communication system for switching to an MBMS mode according to an embodiment of the present disclosure;

FIG. 31 is a signal flow diagram illustrating a process of switching to an MBMS mode and transmitting multimedia content according to an embodiment of the present disclosure;

FIG. 32 is a signal flow diagram illustrating a process of transmitting multimedia content in connection with a network element according to an embodiment of the present disclosure;

FIG. 33 is a signal flow diagram illustrating a process of transmitting multimedia content in connection with a network element according to an embodiment of the present disclosure;

FIG. 34 is a flowchart illustrating a method for providing a multimedia service in connection with an electronic device according to an embodiment of the present disclosure;

FIG. 35 is a flowchart illustrating a method for providing an MBMS service in connection with an electronic device for providing multimedia content according to an embodiment of the present disclosure;

FIG. 36 is a flowchart illustrating a method for improving quality of multimedia content through a unicast session in connection with an electronic device according to an embodiment of the present disclosure;

FIG. 37 is a flowchart illustrating a method for transmitting additional multimedia data through a unicast session in connection with an electronic device for transmitting multimedia content according to an embodiment of the present disclosure;

FIG. 38 is a flowchart illustrating a method for improving quality of multimedia content through a unicast session, during MBMS service switching, in connection with an electronic device according to an embodiment of the present disclosure;

FIG. 39 is a flowchart illustrating a method for transmitting additional multimedia data through a unicast session, during MBMS service switching, in connection with an electronic device for transmitting multimedia content according to an embodiment of the present disclosure;

FIG. 40 is a flowchart illustrating a method for additionally setting a unicast session, during MBMS service switching, and improving quality of multimedia content in connection with an electronic device according to an embodiment of the present disclosure;

FIG. 41 is a flowchart illustrating a method for additionally setting a unicast session, during MBMS service switching, and transmitting additional multimedia data in connection with an electronic device for transmitting multimedia content according to an embodiment of the present disclosure; and

FIG. 42 illustrates a configuration for transmitting multimedia data corresponding to different service qualities of multimedia content of electronic devices according to an embodiment of the present disclosure.

### DETAILED DESCRIPTION OF EMBODIMENTS OF THE DISCLOSURE

Hereinafter, various embodiments of the present disclosure will be described with reference to the accompanying drawings. In the following description, specific details such as detailed configuration and components are merely provided to assist the overall understanding of these embodiments of the present disclosure. Therefore, those skilled in the art understand that various changes and modifications of the embodiments described herein can be made without departing from the scope and spirit of the present disclosure. In addition, descriptions of well-known functions and constructions are omitted for clarity and conciseness.

In describing the drawings, similar reference numerals may be used to designate similar elements.

Herein, terms are used merely to describe certain embodiments and are not intended to limit the present disclosure. For example, singular forms may include plural forms as well, unless the context explicitly indicates otherwise.

Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined as such in the various embodiments of the present disclosure.

The terms “have”, “may have”, “include”, and “may include” indicate the presence of disclosed corresponding features, numbers, steps, functions, operations, elements, parts, etc., but do not limit additional one or more features, numbers, steps, functions, operations, elements, parts, etc.

The terms “A or B”, “at least one of A or/and B” and “one or more of A or/and B” include any and all combinations of A and/or B. For example, “A or B”, “at least one of A and B” or “at least one of A or B” means (1) including at least one A, (2) including at least one B, or (3) including both at least one A and at least one B.

Although the term such as “first” and “second” may help identify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. Accordingly, a first element may be referred to as a second element, and similarly, a second element may be referred to as a first element.

When an element (e.g., a first element) is “connected to” or “(operatively or communicatively) coupled with/to” another element (e.g., a second element), the first element may be directly connected or coupled to the second element, or there may be an intervening element (e.g., a third element) therebetween. However, when the first element is “directly connected” or “directly coupled” to the second element, there is no intervening element therebetween.

The expression “configured to (or set to)” may be replaced with “suitable for”, “having the capacity to”, “designed to”, “adapted to”, “made to”, or “capable of” according to context.

Further, the expression “configured to (set to)” does not necessarily mean “specifically designed to” on a hardware level. Instead, the expression “apparatus configured to . . . ” may mean that the apparatus is “capable of . . . ” along with other devices or parts in a certain situation. For example, “a processor configured to (or set to) perform A, B, and C” may be a dedicated processor, e.g., an embedded processor, for performing a corresponding operation, or a generic-purpose processor, e.g., a central processing unit (CPU) or an application processor (AP), capable of performing a corresponding operation by executing one or more software programs stored in a memory device.

Herein, an electronic device may include a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), an MP3 player, a mobile medical appliance, a camera, and/or a wearable device (e.g., smart glasses, a head-mounted-device (HMD), electronic clothes, an electronic bracelet, an electronic necklace, an electronic appcessory, an electronic tattoo, a smart mirror, or a smart watch).

The electronic device may also be a smart home appliance, such as a television, a digital video disk (DVD) player, an audio, a set-top box, a home automation control panel, a security control panel, a television (TV) box (e.g., Samsung HomeSync®, Apple TV®, or Google TV®), a game console (e.g., Xbox® and PlayStation®), an electronic dictionary, an electronic key, a camcorder, and an electronic photo frame.

The electronic device may also be a flexible device.

The electronic device may also be a combination of one or more of the aforementioned or other devices.

Further, the electronic device is not limited to the aforementioned devices, and may include a new electronic device.

Herein, the term “user” may indicate a person who uses an electronic device or a device (e.g., an artificial intelligence (AI) electronic device) that uses an electronic device.

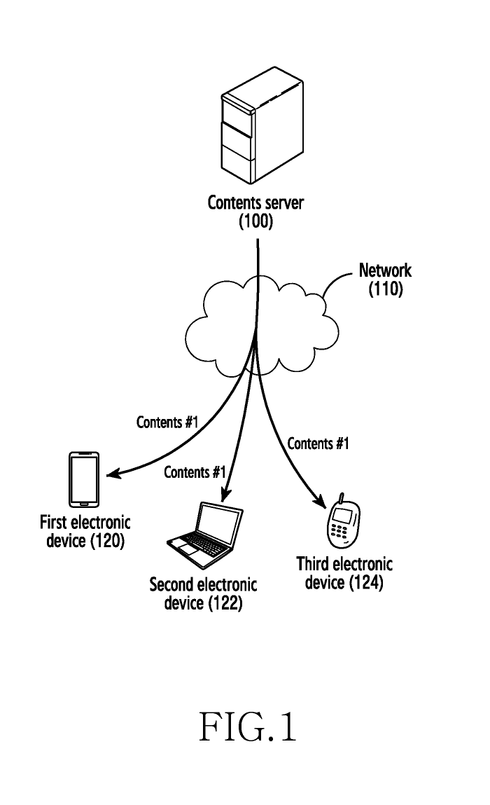

FIG. 1 illustrates a system for providing a multimedia service according to an embodiment of the present disclosure.

Referring to FIG. 1, a content server 100 transmits multimedia content to electronic devices 120, 122, and 124 through a network 110.

The network 110 may transmit the same content (for example, content #1) to each of the electronic devices 120, 122, and 124 through a dedicated channel related to each of the electronic devices 120, 122, and 124. For example, the network 110 may stream content #1 through a unicast session related to the electronic devices 120, 122, and 124.

The network 110 may switch the mode for transmitting the corresponding content to an MBMS (mode based on a total amount of content transmitted to the electronic devices 120, 122, and 124. For example, when the total amount of content transmitted to the electronic devices 120, 122, and 124 exceed a reference value, the network 110 may set up an MBMS session with the electronic devices 120, 120, and 124 and transmit the corresponding content. The MBMS session may include a multicast session or a broadcast session.

When switching to the MBMS mode, the content server 100 or the network 110 may determine a quality parameter based on a content quality required by each of the electronic devices 120, 122, and 124. For example, the content server 100 or the network 110 may determine a quality parameter in order to support a lowest content quality required by the electronic devices 120, 122, and 124. The content server 100 or the network 110 may hierarchically encode multimedia content based on the determined quality parameter and then transmit a least a part of the encoded multimedia data, which corresponds to the quality parameter, through an MBMS session. In this regard, the quality parameter may include at least one of video quality of the content and audio quality thereof. For example, the video quality may be classified a standard definition (SD), high definition (HD), full HD (FHD), etc.

The content server 100 or the network 110 may transmit additional multimedia data to at least one of the electronic devices 120, 122, and 124 that requires quality improvement. For example, assuming the second electronic device 122 requires quality improvement, the content server 100 or the network 110 may transmit additional multimedia data to the second electronic device 122 through a unicast session related to the second electronic device 122.

Thereafter, the electronic devices 120, 122, and 124 may reproduce the multimedia content that has been received through the MBMS session and/or the unicast session.

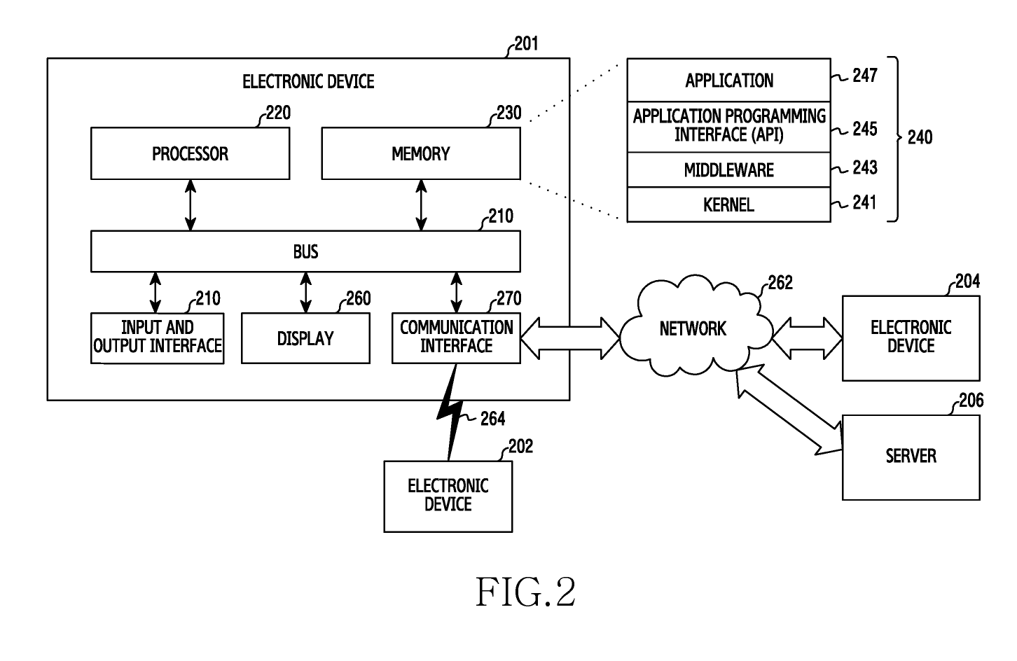

FIG. 2 illustrates an electronic device in a network environment according to an embodiment of the present disclosure.

Referring to FIG. 2, an electronic device 201 includes a bus 210, a processor 220 (e.g., including processing circuitry), a memory 230, an input/output interface 250 (e.g., including input/output circuitry), a display 260 (e.g., including display circuitry), and a communication interface 270 (e.g., including communication circuitry). Alternatively, the electronic device 201 may omit some of the illustrated elements and/or may include other elements.

The bus 210 may include a circuit that interconnects the elements 220 to 270 and delivers communication (e.g., a control message and/or data) between the elements.

The processor 220 may include one or more of a CPU, an AP, and a Communication Processor (CP). For example, the processor 220 may carry out operations or data processing related to control and/or communication of at least one other element of the electronic device 201.

The processor 220 may reproduce multimedia content received from a network through at least one of a unicast session or an MBMS session. For example, the processor 220 may reproduce multimedia content received from the network through the unicast session, may reproduce multimedia content received from the network through the MBMS session, and may switch to an MBMS mode in response to a mode switching request signal provided from the network while receiving multimedia content through the unicast session. The processor 220 may also reproduce multimedia content received from the network through the MBMS session in response to MBMS mode switching. In this case, the processor 220 may decode at least a part (e.g., multimedia data) of hierarchically encoded multimedia content, which has been received through the MBMS session, and may restore and reproduce the corresponding multimedia content.

The processor 220 may receive additional multimedia data through the unicast session from the network, while receiving multimedia data through the MBMS session. The processor 220 may decode the multimedia data, which has been received through the MBMS session, and the additional multimedia data, which has been received through the unicast session, and may restore and reproduce the multimedia content with improved quality. In this regard, the unicast session may be set up with the network before MBMS mode switching, or the unicast session may be newly set up after the MBMS session setup.

The processor 220 may determine whether or not to improve the quality of multimedia content. For example, when MBMS mode switching has degraded the quality of multimedia content, the processor 220 may transmit a quality improvement request signal to the network. When switching to the MBMS mode has occurred, the processor 220 may control the display 260 to display mode switching information. When the processor 220 has detected information regarding an input for a quality improvement request through the input/output interface 250, e.g., in response to the mode switching information displayed on the display 260, the processor 220 may transmit a quality improvement request signal to the network.

The processor 220 may receive additional multimedia data through the unicast session in response to a quality improvement request signal, while receiving multimedia data through the MBMS session. The processor 220 may decode the multimedia data, which has been received through the MBMS session, and the additional multimedia data, which has been received through the unicast session, and may restore and reproduce multimedia content with improved quality.

The memory 230 may include a volatile memory and/or a non-volatile memory. The memory 230 may store instructions or data related to at least one other element of the electronic device 201. The memory 230 stores software and/or a program 240 including a kernel 241, middleware 243, an application programming interface (API) 245, and an application program (or “application”) 247. At least some of the kernel 241, the middleware 243, and the API 245 may be referred to as an Operating System (OS).

The input/output interface 250 may function as an interface for transferring instructions or data input from a user or another external device to the other elements of the electronic device 201. Further, the input/output interface 250 may output instructions or data received from the other elements of the electronic device 201 to the user or an external device.

The display 260 may display various types of content (e.g., text, images, videos, icons, and/or symbols) to the user. The display 260 may include a touch screen, and may receive a touch input, a gesture input, a proximity input, and/or a hovering input by using an electronic pen or a part of the user's body.

The communication interface 270 may set communication between the electronic device 201 and a first external device 202, a second external device 204, and/or a server 206. For example, the communication interface 270 may be connected (wired or wirelessly) to a network 262 to communicate with the second external electronic device 204 and/or the server 206.

Examples of the wireless communication may include LTE, LTE-Advance (LTE-A), Code Division Multiple Access (CDMA), WCDMA, Universal Mobile Telecommunications System (UMTS), WiBro (Wireless Broadband), and Global System for Mobile Communications (GSM). In addition, the wireless communication may include short range communication 264. Examples of the short range communication 264 may include Wi-Fi, Bluetooth, Near Field Communication (NFC), Global Navigation Satellite System (GNSS), etc.

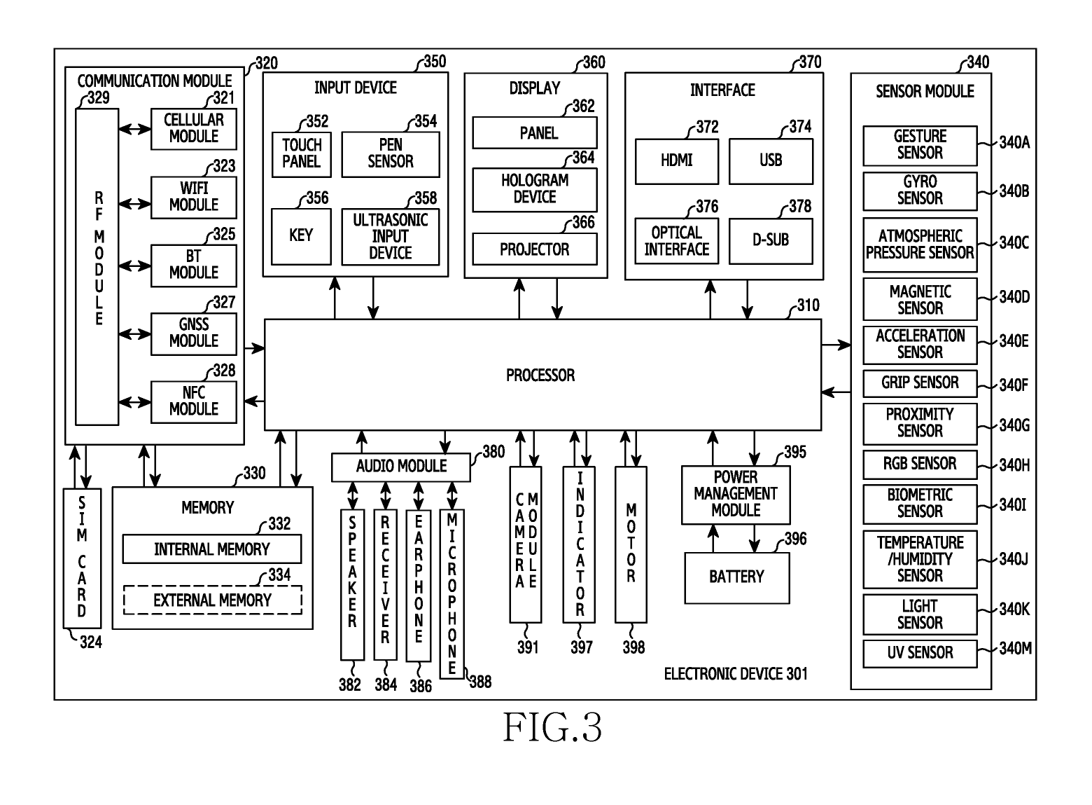

FIG. 3 illustrates an electronic device according to an embodiment of the present disclosure.

Referring to FIG. 3, the electronic device 301 includes a processor 310 (e.g., an AP), a communication module 320, a subscriber identification module (SIM) card 324, a memory 330, a sensor module 340, an input device 350, a display 360, an interface 370, an audio module 380, a camera module 391, a power management module 395, a battery 396, an indicator 397, and a motor 398.

The processor 310 may control a plurality of hardware or software elements connected to the processor 310 by driving an OS or an application program and may perform processing of various pieces of data and calculations. For example, the processor 310 may be implemented as a system on chip (SoC). The processor 310 may further include a Graphic Processing Unit (GPU) and/or an image signal processor. The processor 310 may also include at least some of the other elements illustrated in FIG. 3, e.g., a cellular module 321.

The communication module 320 includes a cellular module 321, a Wi-Fi module 323, a Bluetooth module 325, a GNSS module 327 (e.g., a GPS module, a Glonass module, a Beidou module, and/or a Galileo module), an NFC module 328, and a Radio Frequency (RF) module 329.

The cellular module 321 may provide a voice call, an image call, a text message service, or an Internet service through a communication network. The cellular module 321 may distinguish and authenticate the electronic device 301 within a communication network using the SIM card 324. The cellular module 321 may perform at least some of the functions that the processor 310 may provide. The cellular module 321 may include a CP.

The Wi-Fi module 323, the Bluetooth module 325, the GNSS module 327, and/or the NFC module 328 may include a processor that processes data transmitted and received through the corresponding module. Further, two or more of the cellular module 321, the Wi-Fi module 323, the BT module 325, the GNSS module 327, and the NFC module 328 may be included in an integrated chip (IC) or an IC package.

The RF module 329 may transmit/receive a communication signal (e.g., an RF signal).

At least one of the cellular module 321, the Wi-Fi module 323, the BT module 325, the GNSS module 327, and the NFC module 328 may transmit/receive an RF signal through a separate RF module.

The SIM card 324 may be removable or embedded, and may contain unique identification information (e.g., an Integrated Circuit Card Identifier (ICCID)) or subscriber information (e.g., an International Mobile Subscriber Identity (IMSI)).

The memory 330 includes an internal memory 332 and an external memory 334. The external memory 334 may be functionally and/or physically connected to the electronic device 201 through various interfaces.

The sensor module 340 may measure a physical quantity or detect the operating state of the electronic device 301, and may convert the measured or detected information into an electrical signal. The sensor module 340 includes a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (e.g., a red, green, blue (RGB) sensor), a biometric sensor 340I, a temperature/humidity sensor 340J, a luminance sensor 340K, and a ultraviolet (UV) sensor 340M. Additionally or alternatively, the sensor module 340 may include an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 340 may further include a control circuit for controlling one or more sensors included therein. The electronic device 301 may further include a processor configured to control the sensor module 340 as a part of or separately from the processor 310, and may control the sensor module 340 while the processor 310 is in a sleep state.

The input device 350 includes a touch panel 352, a (digital) pen sensor 354, a key 356, and an ultrasonic input unit 358.

The display 360 includes a panel 362, a hologram device 364, and a projector 366. The interface 370 includes a High-Definition Multimedia Interface (HDMI) 372, a Universal Serial Bus (USB) 374, an optical interface 236, and a D-subminiature (D-sub) 378.

The audio module 380 may bidirectionally convert a sound and an electrical signal. The audio module 380 may process sound information that is input or output through a speaker 382, a receiver 384, earphones 386, a microphone 388, etc.

The camera module 391 takes still and moving images and may include one or more image sensors (e.g., a front sensor or a back sensor), a lens, an Image Signal Processor (ISP), and/or a flash (e.g., a light emitting diode (LED) or a xenon lamp).

The power management module 395 may manage power of the electronic device 301. The power management module 395 may include a power management integrated circuit (PMIC), a charger IC, or a battery gauge. The PMIC may use a wired and/or wireless charging method.

The indicator 397 may indicate a particular state (e.g., a booting state, a message state, a charging state, etc.) of the electronic device 301 or a part thereof (e.g., the processor 310).

The motor 398 may convert an electrical signal into mechanical vibration, and may generate vibration, a haptic effect, etc.

The electronic device 301 may include a processing unit (e.g., a GPU) for supporting a mobile TV. For example, the processing unit for supporting mobile TV may process media data according to a certain standard, such as Digital Multimedia Broadcasting (DMB), Digital Video Broadcasting (DVB), or mediaFLO™.

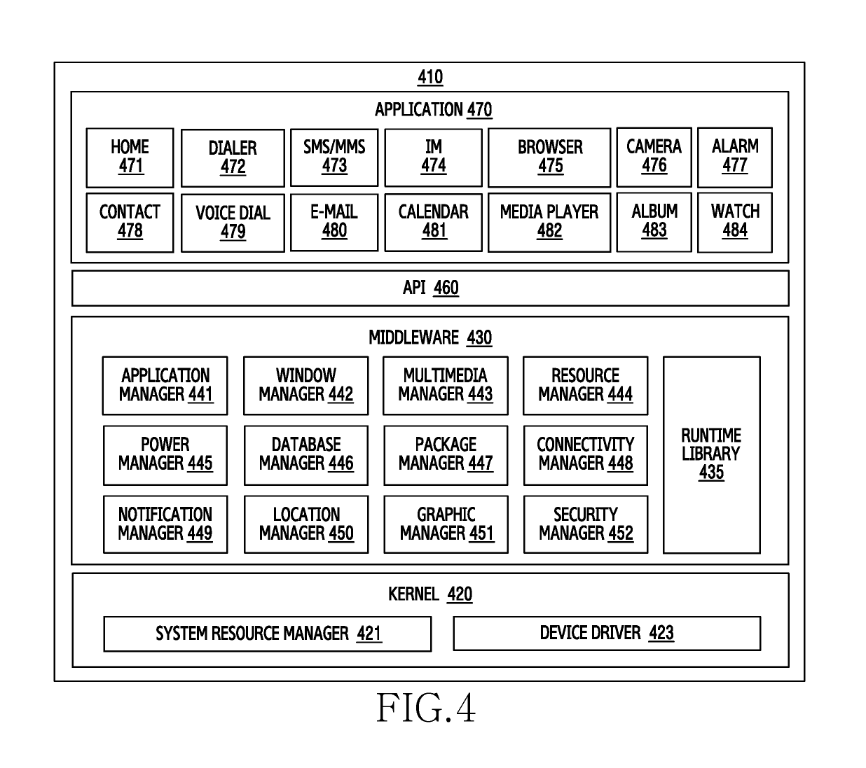

FIG. 4 illustrates a program module according to an embodiment of the present disclosure.

Referring to FIG. 4, the program module 410 may include an OS for controlling resources related to an electronic device and/or various applications executed in the OS. Examples of the OS include Android®, iOS®, Windows®, Symbian®, Tizen®, Bada®, etc.

The program module 410 includes a kernel 420, middleware 430, an API 460, and applications 470. At least a part of the program module 410 may be preloaded on the electronic device, or may be downloaded from an external electronic device.

The kernel 420 includes a system resource manager 421 and a device driver 423. The system resource manager 421 may control, assign, or collect system resources. The device driver 423 may include a display driver, a camera driver, a Bluetooth driver, a shared memory driver, a USB driver, a keypad driver, a Wi-Fi driver, an audio driver, and/or an Inter-Process Communication (IPC) driver.

The middleware 430 may provide a function required by the applications 470 in common or provide various functions to the applications 470 through the API 460 so that the applications 470 can efficiently use limited system resources within the electronic device. The middleware 430 includes a runtime library 435, an application manager 441, a window manager 442, a multimedia manager 443, a resource manager 444, a power manager 445, a database manager 446, a package manager 447, a connectivity manager 448, a notification manager 449, a location manager 450, a graphic manager 451, and a security manager 452.

The runtime library 435 may include a library module that a compiler uses to add new functions through a programming language while the applications 470 are executed.

The application manager 441 may manage a life cycle of at least one of the applications 470.

The window manager 442 may manage a Graphical User Interface (GUI) resources used on a screen.

The multimedia manager 443 may identify formats required for the reproduction of various media files and may encode or decode a media file using a codec suitable for the corresponding format.

The resource manager 444 may manage resources of at least one of the applications 470, such as a source code, a memory, and a storage space.

The power manager 445 may operate together with a basic input/output System (BIOS) to manage a battery or power, and may provide power information required for the operation of the electronic device.

The database manager 346 may generate, search, or change a database to be used in at least one of the applications 470.

The package manager 447 may manage the installation or the updating of an application distributed in the form of a package file.

The connectivity manager 448 may manage wireless connection such as Wi-Fi or Bluetooth.

The notification manager 449 may display or notify of an event, such as an incoming message, an appointment, proximity notification, etc.

The location manager 450 may manage location information of the electronic device.

The graphic manager 451 may manage a graphic effect to be provided to the user and a user interface relating thereto.

The security manager 452 may provide all security functions required for system security or user authentication.

When the electronic device has a telephone call function, the middleware 430 may further include a telephony manager for managing the voice call function or video call function of the electronic device.

The middleware 430 may include a middleware module that forms combinations of various functions of the above described elements. The middleware 430 may provide a module customized to each operating system type in order to provide differentiated functions. Further, the middleware 430 may dynamically remove some of the existing elements, or may add new elements.

The API 460 includes a set of API programming functions, and may be provided in a different configuration according to the OS. For example, for Android® or iOS®, one API set may be provided for each platform, and for Tizen®, two or more API sets may be provided for each platform.

The applications 470 include a home application 471, a dialer application 472, a short message service/multimedia message service (SMS/MMS) application 473, an Instant Message (IM) 474, a browser application 475, a camera application 476, an alarm application 477, a contacts application 478, a voice dialer application 479, an e-mail application 480, a calendar application 481, a media player application 482, an album 483 application, and a clock application 484. The applications 470 may also include other applications, such as a health care application (e.g., an application for measuring an amount of exercise or a blood glucose level), or an application for providing environment information (e.g., an application for providing atmospheric pressure, humidity, and/or temperature information).

The applications 470 may include applications designated according to attributes of the external electronic device. For example, a health care application may be designated to a mobile medical appliance.

The applications 470 may include an application received from the external device, and/or a preloaded application or a third party application that can be downloaded from the server.

The names of the elements of the program module 410 may change depending on the type of OS.

At least some of the program module 410 may be implemented in software, firmware, hardware, or a combination of two or more thereof. At least some of the program module 410 may be implemented (e.g., executed) by a processor. At least some of the program module 410 may include a module, a program, a routine, a set of instructions, and/or a process for performing one or more functions.

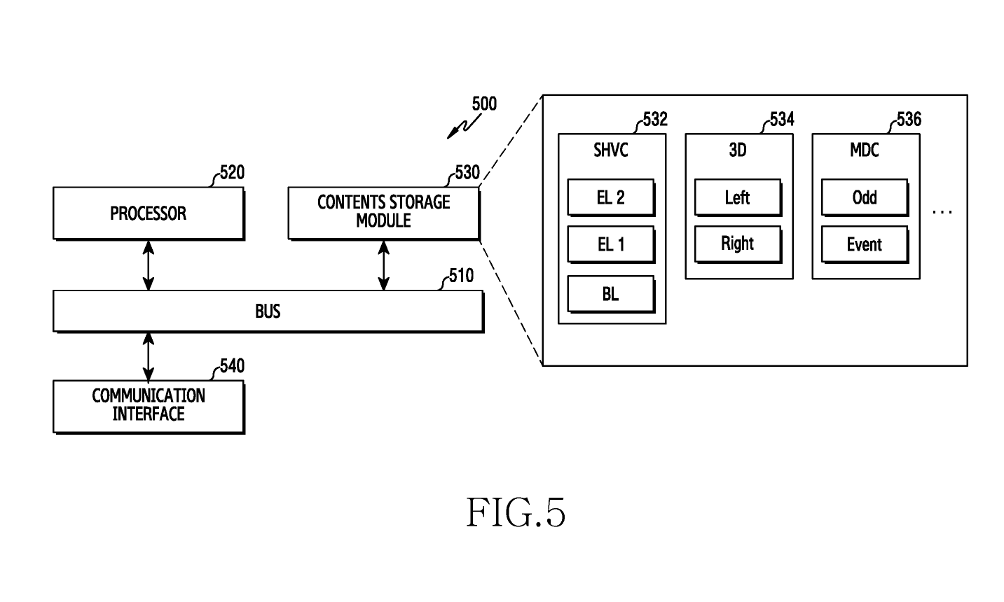

FIG. 5 is a block diagram of an electronic device for transmitting multimedia content according to an embodiment of the present disclosure.

Referring to FIG. 5, the electronic device 500 includes a bus 510, a processor 520 (e.g., including processing circuitry), a content storage module 530, and a communication interface 540 (e.g., including communication circuitry). Alternatively, the electronic device 500 may omit some of the illustrated elements and/or may further include other elements.

The bus 510 may include a circuit that interconnects the elements 520 to 540 and delivers communication (e.g., a control message and/or data) between the elements.

The processor 520 may carry out operations or data processing related to control and/or communication of at least one other element of the electronic device 500.

The processor 520 may conduct a control such that multimedia content, which is stored in the content storage module 530, is transmitted through a unicast session related to each external device (e.g., the electronic devices 120, 122, and 124 illustrated in FIG. 1), which is functionally connected to the electronic device 500.

The processor 520 may switch the content transmission scheme to an MBMS mode based on a total amount of content transmitted to the external devices. For example, when the total amount of content transmitted through a unicast session related to each external device exceeds a reference value, the processor 520 may set an MBMS session with the external devices and continuously transmit the corresponding multimedia content.

When switching to the MBMS mode, the processor 520 may determine a quality parameter of multimedia content, which is to be transmitted to the external devices in the MBMS mode, based on the service qualities required by the external devices. For example, the processor 520 may determine a lowest service quality, among the service qualities required by the external devices, as the quality parameter of multimedia content that is to be transmitted in the MBMS mode. The processor 520 may transmit multimedia data, which is at least a part of multimedia content that has been encoded hierarchically in order to correspond to the quality parameter of the content, to the external devices. In this regard, the hierarchical encoding may include a scalable high efficiency video coding (SHVC) scheme. The quality parameter may include at least one of video quality of the content, such as SD, HD, or FHD, and the audio quality thereof.

After switching to the MBMS mode, the processor 520 may determine whether or not an external device requires a quality improvement. For example, the processor 520 may determine whether an external device requires a quality improvement, based on at least one of a service quality required by the external device, the user's service setting information, information regarding a billing system to which the user has subscribed, and the amount of remaining data of the user. For example, when a quality improvement request signal is received from an external device that operates in the MBMS mode, the processor 520 may determine that the corresponding external device requires a quality improvement.

When an external device requires improvement of quality of multimedia content, the processor 520 may transmit additional multimedia data for quality improvement through a unicast session with the external device. In this regard, the additional multimedia data may include at least a part additional multimedia data, besides the multimedia data that has been transmitted through the MBMS session, among the multimedia content that have been encoded hierarchically. For example, the processor 520 may transmit different additional multimedia data to each external device in order to correspond to the respective service quality required by each external device. As described above, the unicast session may be set with the corresponding external device before MBMS mode switching, or may be newly set after MBMS session setup.

The content storage module 530 may store commands or data related to at least one other element of the electronic device 500. For example, when the electronic device 500 is an element of a network, the content storage module 530 may store multimedia content received from a content server. For example, the content storage module 530 may store pieces of hierarchically encoded multimedia data (different layers BL, EL1, and EL2) 532, binocular (or 3D) images (left and right) 534 for stereoscopic images, and pieces of multimedia data (odd and even) 536 resulting from multiple description coding (MDC).

The communication interface 540 may set communication between the electronic device 500 and an external device. For example, the communication interface 540 may communicate with the external device, such as an electronic device or a content server, through wireless or wired communication.

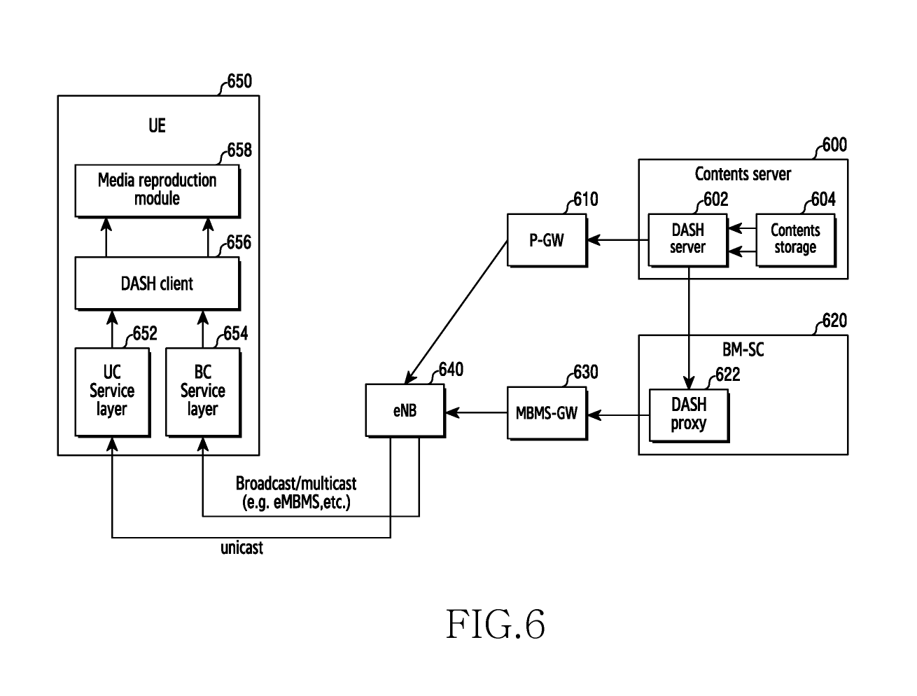

FIG. 6 illustrates a wireless communication system for transmitting multimedia content according to an embodiment of the present disclosure. For example, the wireless communication system will be described transmitting multimedia content using a streaming protocol of a dynamic adaptive streaming over a hypertext transfer protocol (HTTP) (DASH) type. However, the wireless communication system may also transmit multimedia content in the same manner using a different stream protocol, such as HTTP live streaming (HLS) or smooth streaming.

Referring to FIG. 6, the wireless communication system includes a content server 600, network elements, and a user equipment (UE) 650.

The content server 600 includes a DASH server 602 and a content storage module 604. Alternatively, the content server 600 may omit some of the illustrated elements or may additionally include a different element.

The UE 650 includes a media reproduction module 658, a DASH client 656, a unicast (UC) service layer 652, and a broadcast (BC) service layer 654.

The content server 600 may transmit multimedia content, which is stored in the content storage module 604, to a network element through the DASH server 602.

The network elements include a packet data network (PDN)-gateway (P-GW) 610, a broadcast-multicast service center (BM-SC) 620, an MBMS-gateway (GW) 630, and an evolved node B (eNB) 640. Alternatively, at least one of the network elements may be omitted, and/or different elements may be additionally provided.

When multimedia content is provided to the UE 650, the P-GW 610 control multimedia content, which has been provided from the DASH server 602 through a unicast session, to be transmitted to the UE 650. For example, the P-GW 610 may allocate an Internet protocol (IP) address to the UE 650. The P-GW 610 may request the content server 600 to provide multimedia content, which corresponds to the request of the UE 650.

The P-GW 610 may control multimedia content, which has been provided from the DASH server 602 in response to the request of the UE 650, to be transmitted to the UE 650 through the eNB 640. In this case, the P-GW 610 may control the multimedia content to be transmitted to the corresponding UE 650 based on the IP address that has been allocated to the UE 650.

The eNB 640 may transmit the multimedia content, which has been provided from the P-GW 610, to the corresponding UE 650 through the unicast session of the UE 650.

The UE 650 may receive multimedia content through a unicast session (i.e., the UC service layer 652). The media reproduction module 658 may reproduce the multimedia content provided through the DASH client 656. The BM-SC 620 may control the MBMS service. For example, the BM-SC 620 may control the start of the MBMS service and the transmission of multimedia content using the MBMS service. Additionally, the BM-SC 620 may perform an authentication procedure related to the UE 650.

The BM-SC 620 may determine whether or not to provide the MBMS service based on a total amount of content transmitted to the UE 650 through the P-GW 610. For example, when the total amount multimedia content transmitted through a unicast session related to external devices including the UE 650, from the P-GW 610, exceeds a reference value, the BM-SC 620 may determine to start the MBMS service with regard to the UE 650 and any other external devices. The BM-SC 620 may control an MBMS session with the eNB 640 and with the UE 650 to be set through the MBMS-GW 630 in response to the start of the MBMS service.

When the multimedia content transmission type has switched to the MBMS mode, a DASH proxy 622 of the BM-SC 620 may transmit multimedia content, which has been provided from the DASH server 602, to the MBMS-GW 630.

The MBMS-GW 630 may transmit multimedia content (e.g., at least a part of hierarchically encoded multimedia content), which has been provided from the BM-SC 620, to the eNB 640 through the MBMS session.

The eNB 640 may transmit the multimedia content, which has been provided from the BM-SC 620, to the corresponding UE 650 through the MBMS session of the UE 650.

The UE 650 may receive multimedia content through the MBMS session (i.e., the BC service layer 654). The media reproduction module 658 may reproduce the multimedia content provided through the DASH client 656.

The P-GW 610 may control additional multimedia data, which is provided from the DASH server 602 through the unicast session with the UE 650 during transmission of multimedia data to the UE 650 through the MBMS session by the BM-SC 620, to be transmitted to the UE 650. In this regard, the additional multimedia data may include additional data (e.g., EL1 and EL2) for improving the quality of multimedia data (e.g., BL), which is transmitted through the MBMS session, among the hierarchically encoded multimedia content.

The DASH client 656 may restore multimedia content using the multimedia data, which has been received through the BC service layer 654, and the additional multimedia data, which has been received through the UC service layer 652. The media reproduction module 658 may reproduce the multimedia content restored by the DASH client 656.

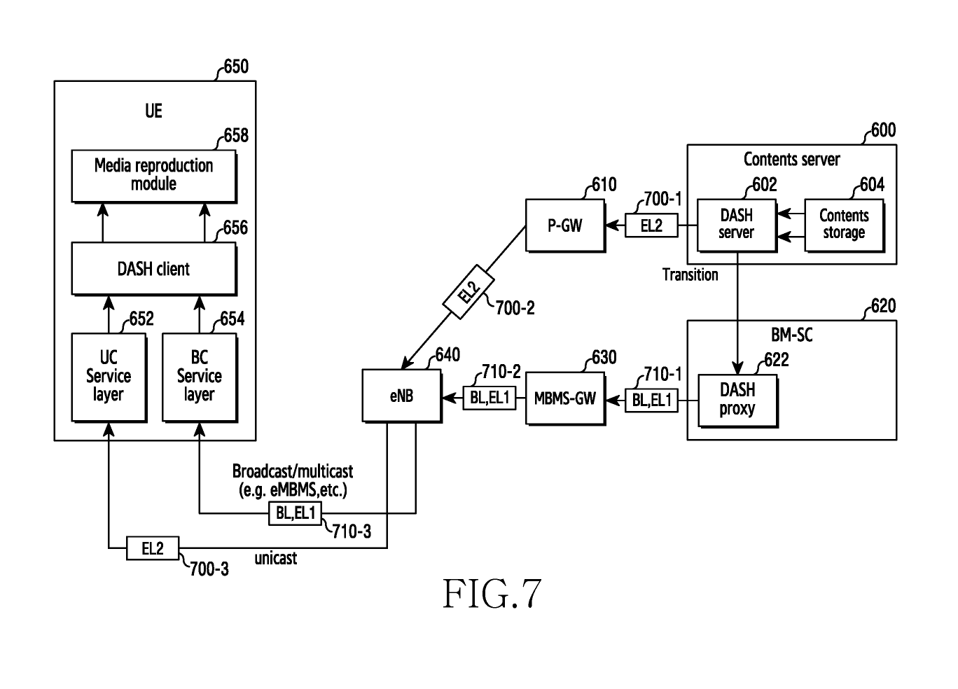

FIG. 7 illustrates a wireless communication system for transmitting multimedia data, which has been encoded hierarchically, according to an embodiment of the present disclosure.

Referring to FIG. 7, the BM-SC 620 of the wireless communication system may determine whether or not to provide an MBMS service based on a total amount of multimedia content transmitted to each UE (including UE 650) through a unicast session.

When the MBMS mode is determined as the multimedia content transmission type, at least some modules (e.g., a quality determination module) of the wireless communication system may determine the quality parameter of multimedia content based on the service quality required by the UEs including the UE 650 that receives the multimedia content.

The BM-SC 620 transmits BL and EL1 data of the hierarchically encoded multimedia content, based on the quality parameter of the multimedia content, to the UE 650 through MBMS sessions 710-1, 710-2, and 710-3.

The wireless communication system sets unicast sessions 700-1, 700-2, and 700-3 with the UE 650 in order to improve the service quality of the UE 650. The wireless communication system (e.g., the content server 600 or the P-GW 610) transmits additional multimedia data EL2, which improves the service quality of the UE 650, to the UE 650 through the unicast sessions 700-1, 700-2, and 700-3. The additional multimedia data EL2 may be determined based on the service quality required by the UE 650.

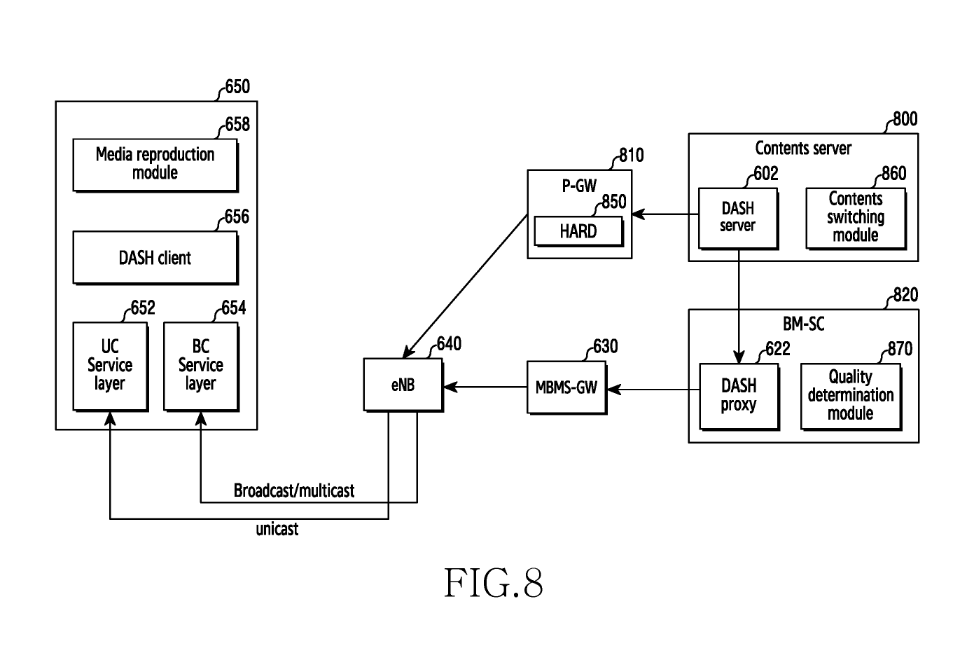

Alternatively, a high attach rate detection (HARD) module, a quality determination module, and a content switching module, which provide an MBMS service in a wireless communication system, may be included in one of the network elements or a content server, as will be described in FIG. 8.

FIG. 8 illustrates a wireless communication system for switching to an MBMS mode according to an embodiment of the present disclosure. Notably, the elements in FIG. 8 are the same as those illustrated in FIGS. 6 and 7, except that the P-GW 610 is replaced with a P-GW 810, which includes a HARD module 850, the content server 600 is replaced with a content server 800, which includes the DASH server 602 and a content switching module 860, and the BM-SC 620 is replaced with a BM-SC 820, which includes the DASH proxy 622 and a quality determination module 870.

Referring to FIG. 8, the P-GW 810 may control multimedia content, which has been provided from the DASH server 602 through unicast session, to be transmitted to the UE 650. The HARD module 850 may detect the total amount of multimedia content, which is transmitted to the UEs including the UE 650 through the P-GW 810, and transmit the detected amount to the BM-SC 820. For example, when multimedia content is transmitted through at least one unicast session, the HARD module 850 may periodically detect the total amount multimedia content transmitted and then transmit the periodically detected amount to the BM-SC 820.

The BM-SC 820 may determine whether or not to switch the corresponding multimedia content transmission type to the MBMS mode based on the total amount of multimedia content transmitted, as provided from the HARD module 850.

When switching to the MBMS mode has been determined, the quality determination module 870 of the BM-SC 820 may determine the quality parameter in the MBMS mode based on the service quality required the UEs that receive multimedia content. For example, the quality determination module 870 may determine a lowest service quality, among service qualities required by respective UEs that receive multimedia content, as the quality parameter of multimedia content that is to be transmitted in the MBMS mode. In this regard, the quality determination module 870 may acquire the service quality, which is required by the UE 650, from the UE 650 or from the content server 800.

The content server 800 may process multimedia content, which is to be transmitted through the MBMS session, based on the quality parameter of multimedia content provided from the quality determination module 870. For example, when information regarding hierarchically encoded multimedia content is stored in a content storage module (i.e., the content storage module of FIG. 6), the content server 800 may select at least a part of the hierarchically encoded multimedia content, which corresponds to the quality parameter of the multimedia content. For example, when the original copy of multimedia content is stored in a content storage module, the content switching module 860 may hierarchically encode the corresponding multimedia content. The DASH server 602 of the content server 800 may select at least a part of the multimedia content, which has been hierarchically encoded by the content switching module 860, based on the quality parameter of the multimedia content.

The content server 800 may transmit at least a part of the multimedia content, which corresponds to the quality parameter of multimedia content determined by the quality determination module 870, to the UE 650, through the MBMS session.

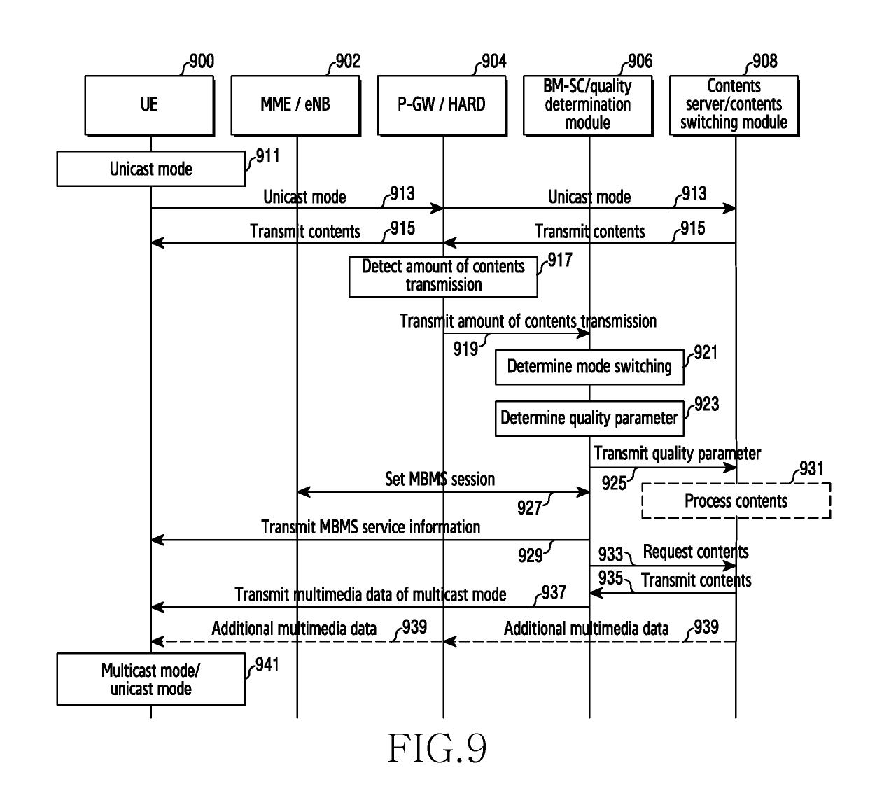

FIG. 9 is a signal flow diagram illustrating a process for switching to an MBMS mode and transmitting multimedia content according to an embodiment of the present disclosure.

Referring to FIG. 9, a UE 900 provides a multimedia service in a unicast mode in operation 911. For example, the UE 900 may set a unicast session through an eNB 902 and a P-GW 904.

In operation 913, the UE 900 transmits a content request signal (e.g., http-GET) to a content server 908 through the unicast session.

In operation 915, the content server 908 transmits multimedia content (e.g., http-REPLY) to the UE 900 through the unicast session, in response to the content request signal.

In operation 917, a HARD module of the P-GW 904 detects the total amount multimedia content, which is transmitted to at least one UE 900 through each unicast session from the P-GW 904.

In operation 919, the P-GW 904 transmits the total amount of transmitted multimedia content, to a BM-SC 906. For example, when the total amount of transmitted multimedia content detected by the HARD module exceeds a reference value, the P-GW 904 may transmit the corresponding total amount to the BM-SC 906. The P-GW 904 may periodically transmit the total amount of transmitted multimedia content, as detected by the HARD module, to the BM-SC 906.

In operation 921, the BM-SC 906 determines to switch the corresponding multimedia content transmission type to an MBMS mode, based on the total amount of transmitted multimedia content, which has been provided from the P-GW 904.

In operation 923, a quality determination module of the BM-SC 906 determines the quality parameter of the MBMS mode, in response to the MBMS mode switching determination. For example, the quality determination module may determine the quality parameter of the MBMS mode based on the service quality required by each UE, including UE 900, which receives multimedia content. The quality determination module may request the UE 900 to provide service quality information and then may receive the service quality from the UE 900, or the quality determination module may receive service quality information for the UE 900 from the content server 908.

In operation 925, the BM-SC 906 transmits the quality parameter of the MBMS mode to the content server 908.

In operation 927, the BM-SC 906 sets an MBMS session with the eNB 902 in response to the MBMS mode switching determination.

In operation 929, the BM-SC 906 transmits MBMS service information to the UE 900, through the eNB 902, in response to MBMS session setup. For example, the eNB 902 may transmit MBMS session setup information to the UE 900 in response to setup of an MBMS session with the BM-SC 906 (e.g., a multicast control channel (MCCH) update).

The eNB 902 may set a physical MBMS session with the UE 900 through the MBMS session setup information. For example, the BM-SC 906 may transmit MBMS service information to the UE 900 through the MBMS session. The BM-SC 906 may also transmit MBMS service characteristic information, such as the kind of the MBMS service, service quality information, etc., to the UE 900.

The content server 908 may process multimedia content, which is to be transmitted through the MBMS session, based on the quality parameter of multimedia content related to the MBMS mode. For example, when the multimedia content has not been encoded hierarchically, the content server 908 may hierarchically encode the multimedia content through a content switching module in operation 931. The content server 908 may select at least a part of the hierarchically encoded multimedia content, based on the quality parameter of the multimedia content. However, when the multimedia content has been encoded hierarchically, the content server 908 may omit the content processing operation.

In operations 933 and 935, the content server 908 transmits at least a part (e.g., multimedia data) of multimedia content, which corresponds to the quality parameter of the MBMS mode, to the BM-SC 906, in response to a content request (e.g., http-GET) of the BM-SC 906.

In operation 937, the BM-SC 906 transmits at least a part (e.g., multimedia data) of the multimedia content, to the UE 900, through the MBMS session. For example, the BM-SC 906 may transmit the multimedia data to the corresponding UE 900, in response to a request of the UE 900, through the MBMS session.

In operation 941, the UE 900 provides a multimedia service in a multicast mode. For example, the UE 900 may restore and reproduce multimedia content, based on the multimedia data provided through the MBMS session.

When the service quality regarding multimedia content needs to be improved, the UE 900 may also receive additional multimedia data from the content server 908 through a unicast session (in operation 939. In this case, in operation 941, the UE 900 restores and reproduces the multimedia content with improved quality, based on the multimedia data provided through the MBMS session and the additional multimedia data provided through the unicast session.

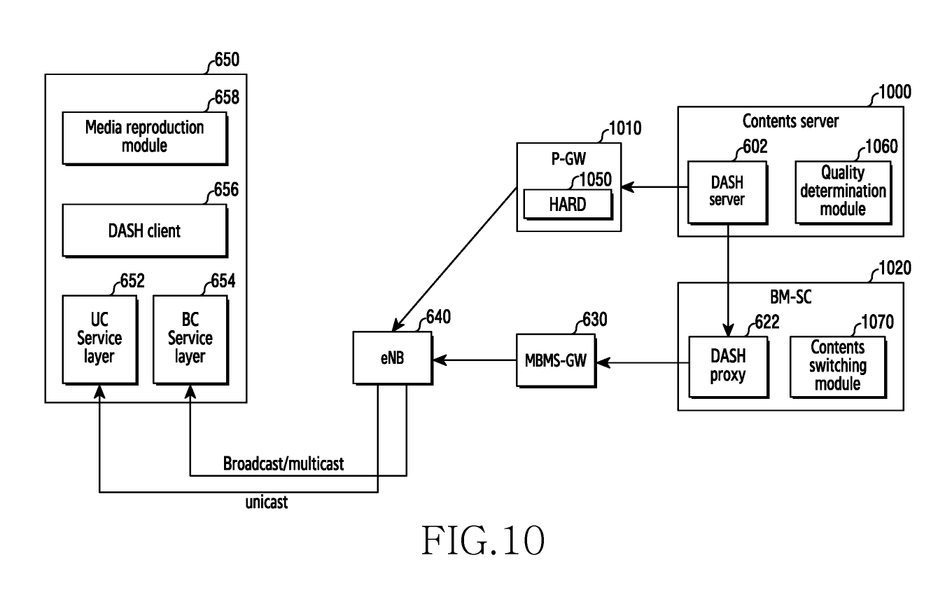

FIG. 10 illustrates a wireless communication system for switching to an MBMS mode according to an embodiment of the present disclosure. Notably, the elements in FIG. 10 are the same as those illustrated in FIGS. 6 and 7, except that the P-GW 610 is replaced with a P-GW 1010, which includes a HARD module 1050, the content server 600 is replaced with a content server 1000, which includes the DASH server 602 and a quality determination module 1070, and the BM-SC 620 is replaced with a BM-SC 1020, which includes the DASH proxy 622 and a content switching module 1060.

Referring to FIG. 10, the P-GW 1010 may control multimedia content, which has been provided from the DASH server 602 through a unicast session, to be transmitted to the UE 650. In this case, the HARD module 1050 may detect the total amount of multimedia content, which is transmitted to each UE through the P-GW 1010, and transmit the detected amount to the BM-SC 1020.

The BM-SC 1020 may determine whether or not to switch the corresponding multimedia content transmission type to the MBMS mode, based on the total amount of transmitted multimedia content, as provided from the HARD module 1050.

When switching to the MBMS mode has been determined, the BM-SC 1020 may set an MBMS session with the UE 650. The BM-SC 1020 may transmit MBMS mode switching information to the content server 1000.

The quality determination module 1070 of the content server 1000 may determine the quality parameter in the MBMS mode, based on the service qualities required by the UE, including the UE 650, that receive multimedia content, in response to the MBMS mode switching information.

When the original copy of multimedia content is stored in a content storage module (i.e., the content storage module of FIG. 6), the content server 1000 may transmit a quality parameter of the multimedia content, which has been determined by the quality determination module 1070, and the corresponding multimedia content, to the BM-SC 1020.

The BM-SC 1020 may conduct processing such that, based on the quality parameter of multimedia content provided from the content server 1000, the corresponding multimedia content can be transmitted through the MBMS session. For example, the content switching module 1060 of the BM-SC 1020 may hierarchically encode multimedia content, which has been provided from the content server 1000. The BM-SC 1020 may select at least a part of the multimedia content, which has been hierarchically encoded by the content switching module 1060, based on the quality parameter of the multimedia content.

The BM-SC 1020 may transmit at least a part (e.g., multimedia data) of multimedia content, which corresponds to the quality parameter of the multimedia content, to the UE 650, through the MBMS session.

When information regarding hierarchically encoded multimedia content is stored in a content storage module, the content server 1000 may select at least a part of the hierarchically encoded multimedia content, which corresponds to the quality parameter of the multimedia content, and transmit the same to the BM-SC 1020.

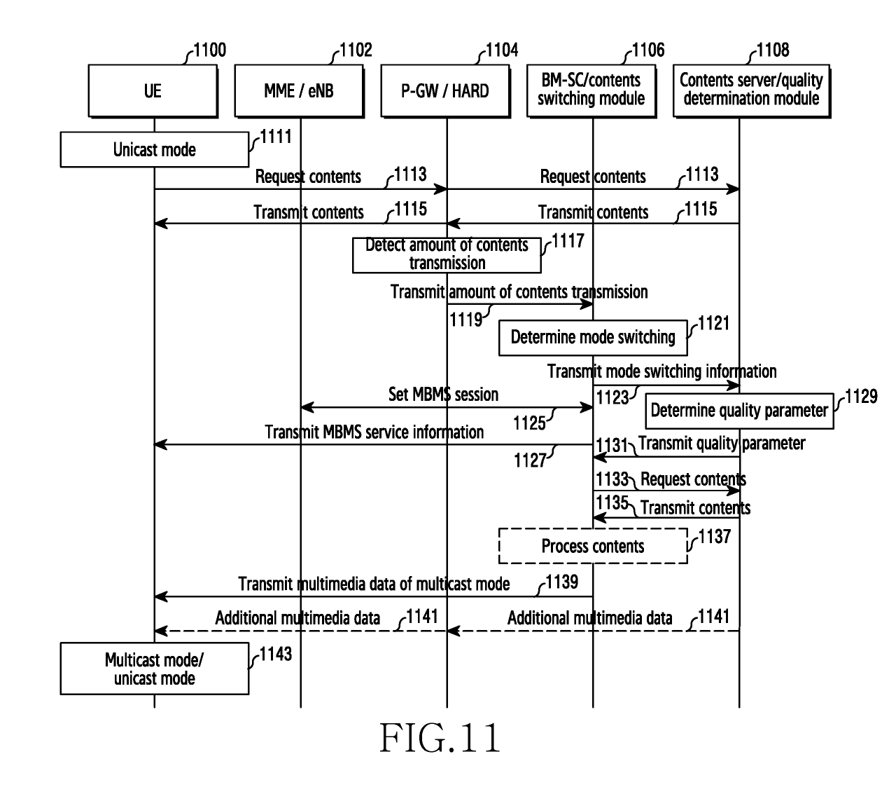

FIG. 11 is a signal flow diagram illustrating a process of switching to an MBMS mode and transmitting multimedia content according to an embodiment of the present disclosure.

Referring to FIG. 11, a UE 1100 provides a multimedia service in a unicast mode in operation 1111. For example, the UE 1100 may set a unicast session through an eNB 1102 and a P-GW 1104.

In operation 1113, the UE 1100 transmits a content request signal to a content server 1108 through the unicast session.

In operation 1115, the content server 1108 transmits multimedia content to the UE 1100 through the unicast session, in response to the content request signal.

In operation 1117, the HARD module of the P-GW 1104 detects the total amount of multimedia content, which is transmitted to each UE through each unicast session from the P-GW 1100.

In operation 1119, the P-GW 1104 transmits the total amount of transmitted multimedia content, as detected by the HARD module, to a BM-SC 1106.

In operation 1121, the BM-SC 1106 determines to switch the corresponding multimedia content transmission type to an MBMS mode, based on the total amount of transmitted multimedia content, as provided from the P-GW 1104.

In operation 1123, the BM-SC 1106 transmits MBMS mode switching information to the content server 1108, in response to the MBMS mode switching determination.

In operation 1125, the BM-SC 1106 sets an MBMS session with the eNB 1102, in response to the MBMS mode switching determination.

In operation 1127, the BM-SC 1106 transmits MBMS service information to the UE 1100 through the eNB 1102, in response to MBMS session setup. For example, the BM-SC 1106 may set an MBMS session with the UE 1100, based on the MBMS service information through the eNB 1102.

In operation 1129, the content server 1108 determines the quality parameter of the MBMS mode through the quality determination module, in response to the MBMS mode switching information. For example, the quality determination module may determine the lowest service quality, among pieces of service quality information required by respective UEs, as the quality parameter of multimedia content that is to be transmitted in the MBMS mode.

In operation 1131, the content server 1108 may transmit the quality parameter of the MBMS mode to the BM-SC 1106.

In operations 1133 and 1135, the content server 1108 transmits multimedia content to the BM-SC 1106, in response to the content request of the BM-SC 1106. For example, when multimedia content that has not been hierarchically encoded is stored in a content storage module, the content server 1108 may transmit multimedia content to the BM-SC 1106, in response to the content request of the BM-SC 1106. When hierarchically encoded multimedia content is stored in the content storage module, the content server 1108 may select at least a part of the hierarchically encoded multimedia content, which corresponds to the quality parameter of the MBMS mode, and transmit the selected part to the BM-SC 1106.

When multimedia content that has not been encoded hierarchically is received from the content server 1108, the BM-SC 1106 may hierarchically encode the multimedia content, through the content switching module in operation 1137. The BM-SC 1106 may select at least a part of the hierarchically encoded multimedia content, based on the quality parameter of the multimedia content.

When at least a part of the hierarchically encoded multimedia content is received from the content server 1108, the BM-SC 1106 may omit the content processing operation of operation 1137.

In operation 1139, the BM-SC 1106 transmits at least a part (e.g., multimedia data) of the multimedia content, to the UE 1100, through the MBMS session.

In operation 1143, the UE 1100 provides a multimedia service in a multicast mode. For example, the UE 1100 restores and reproduces the multimedia content, based on the multimedia data provided through the MBMS session.

However, when the service quality regarding multimedia content should be improved, the UE 1100 may receive additional multimedia data, from the content server 1108, through a unicast session, in operation 1141. In this case, in operation 1143, the UE 1100 restores and reproduces the multimedia content with improved quality, based on the multimedia data provided through the MBMS session and the additional multimedia data provided through the unicast session.

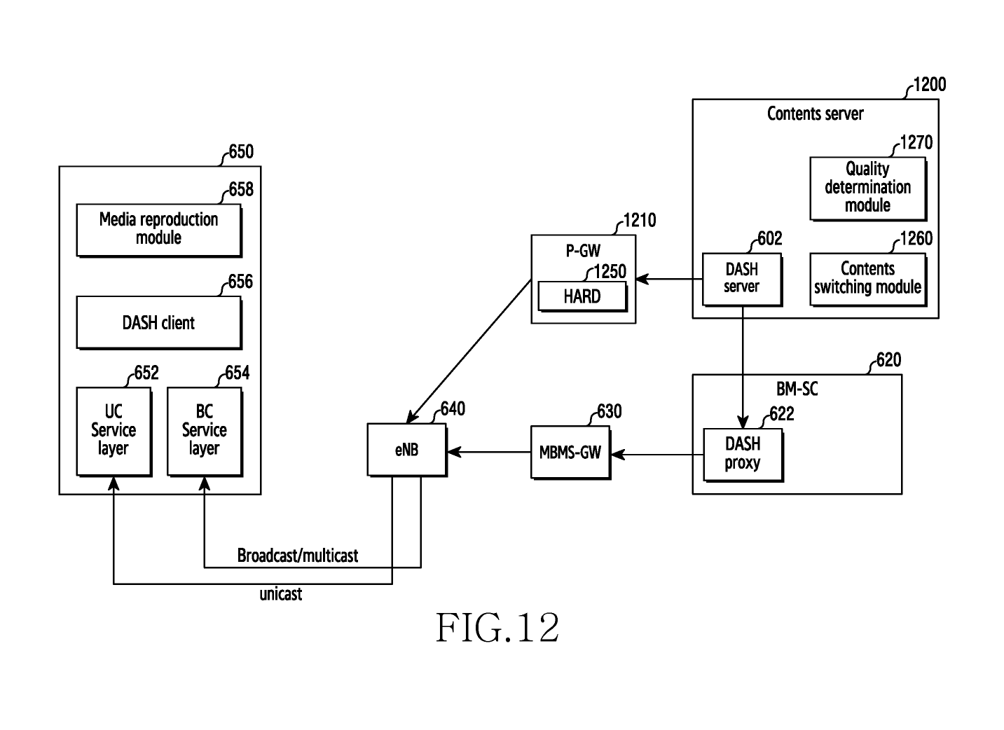

FIG. 12 illustrates a wireless communication system for switching to an MBMS mode according to an embodiment of the present disclosure. Notably, the elements in FIG. 12 are the same as those illustrated in FIGS. 6 and 7, except that the P-GW 610 is replaced with a P-GW 1210, which includes a HARD module 1250, and the content server 600 is replaced with a content server 1200, which includes the DASH server 602, a content switching module 1260, and a quality determination module 1270.

Referring to FIG. 12, the P-GW 1210 may control multimedia content, which has been provided from the DASH server 602 through a unicast session, to be transmitted to each UE, including UE 650, connected thereto. In this case, the HARD module 1250 may detect the total amount of multimedia content, which is transmitted to each UE through the P-GW 1210, and transmit the detected amount to the BM-SC 620.

The BM-SC 620 may determine whether or not to switch the corresponding multimedia content transmission type to the MBMS mode, based on the total amount of transmitted multimedia content, which is provided from the HARD module 1250.

When switching to the MBMS mode has been determined, the BM-SC 620 may set an MBMS session with the UE 650. The BM-SC 620 may transmit MBMS mode switching information to the content server 1200.

The quality determination module 1270 of the content server 1200 may determine the quality parameter in the MBMS mode, based on the service quality required by each UE, including UE 650, which receives multimedia content, in response to the MBMS mode switching information.

The content server 1200 may process multimedia content, which is to be transmitted through the MBMS session, based on the quality parameter of multimedia content determined by the quality determination module 1270. For example, when information regarding hierarchically encoded multimedia content is stored in a content storage module (i.e., the content storage module 604 of FIG. 6), the content server 1200 may select at least a part of the hierarchically encoded multimedia content, which corresponds to the quality parameter of the multimedia content.

For example, when the original copy of multimedia content is stored in a content storage module, the content switching module 1260 may hierarchically encode the corresponding multimedia content. The DASH server 602 may select at least a part of the multimedia content, which has been hierarchically encoded by the content switching module 1260, based on the quality parameter of the multimedia content.

The content server 1200 may transmit at least a part (e.g., multimedia data) of multimedia content, which has been processed so as to correspond to the quality parameter of multimedia content, to the BM-SC 620.

The BM-SC 620 may transmit at least a part (e.g., multimedia data) of multimedia content, which has been provided from the content server 1200, to the UE 650, through the MBMS session.

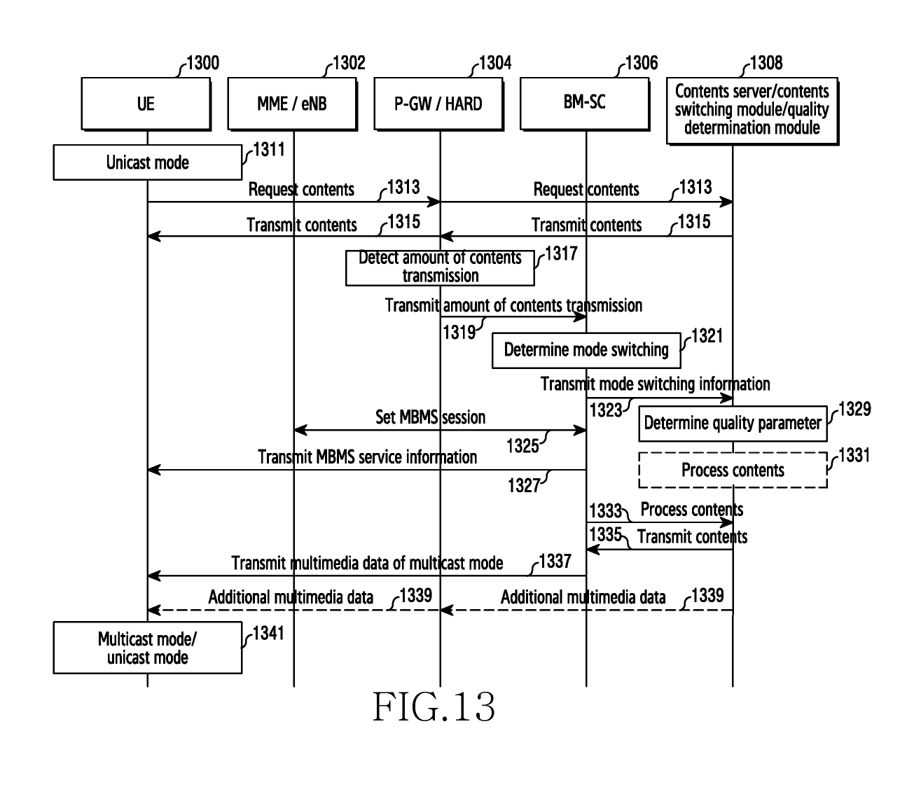

FIG. 13 is a signal flow diagram illustrating a process for switching to an MBMS mode and transmitting multimedia content according to an embodiment of the present disclosure.

Referring to FIG. 13, a UE 1300 provides a multimedia service in a unicast mode in operation 1311.

In operation 1313, the UE 1300 transmits a content request signal to a content server 1308 through the unicast session.

In operation 1315, the content server 1308 transmits multimedia content, to the UE 1300, through the unicast session, in response to the content request signal.

In operation 1317, a HARD module of the P-GW 1304 detects the total amount of multimedia content, which is transmitted to each UE, including the UE 1300, through each unicast session from the P-GW 1304.

In operation 1319, the P-GW 1304 transmits the total amount of transmitted multimedia content, as detected by the HARD module, to a BM-SC 1306.

In operation 1321, the BM-SC 1306 determines to switch the corresponding multimedia content transmission type to an MBMS mode, based on the total amount of transmitted multimedia content, as detected by the HARD module.

In operation 1323, the BM-SC 1306 transmits MBMS mode switching information to the content server 1308, in response to the MBMS mode switching determination.

In operation 1325, the BM-SC 1306 sets an MBMS session with the eNB 1302, in response to the MBMS mode switching determination.

In operation 1327, the BM-SC 1306 transmits MBMS service information, to the UE 1300, through the eNB 1302, in response to MBMS session setup, and may set an MBMS session with the UE 1300.

In operation 1329, the content server 1308 may determine the quality parameter of the MBMS mode through the quality determination module, in response to the MBMS mode switching information.

In operation 1331, the content server 1308 may process multimedia content, which is to be transmitted through the MBMS session, based on the quality parameter of multimedia content related to the MBMS mode. For example, when the multimedia content has not been encoded hierarchically, the content server 1308 may hierarchically encode the multimedia content through a content switching module. The content server 1308 may then select at least a part of the hierarchically encoded multimedia content, based on the quality parameter of the multimedia content. For example, when the multimedia content has been encoded hierarchically, the content server 1308 may omit the content processing operation of operation 1331.

In operations 1333 and 1335, the content server 1308 transmits at least a part (e.g., multimedia data) of multimedia content, which corresponds to the quality parameter of the MBMS mode, to the BM-SC 1306, in response to a content request of the BM-SC 1306.

In operation 1337, the BM-SC 1306 transmits at least a part (e.g., multimedia data) of the multimedia content, to the UE 1300, through the MBMS session.

In operation 1341, the UE 1300 provides a multimedia service in a multicast mode. For example, the UE 1300 restores and reproduces multimedia content, based on the multimedia data provided through the MBMS session.

However, when the service quality regarding multimedia content should be improved, the UE 1300 may receive additional multimedia data from the content server 1308 through a unicast session in operation 1339. Thereafter, in operation 1341, the UE 1300 restores and reproduces the multimedia content with improved quality, based on the multimedia data provided through the MBMS session and the additional multimedia data provided through the unicast session.

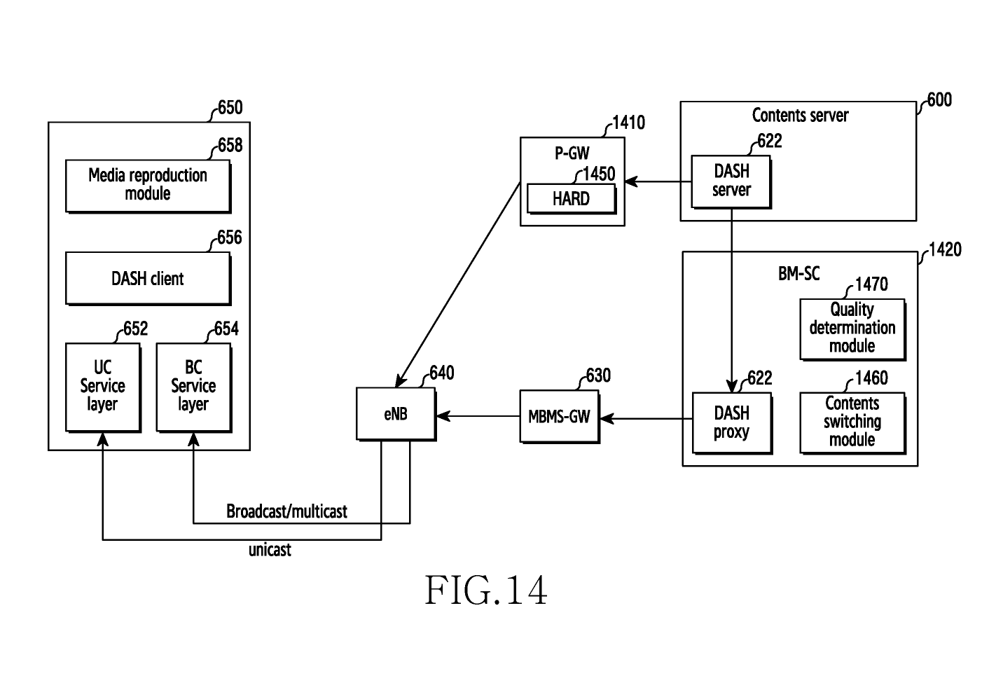

FIG. 14 illustrates a wireless communication system for switching to an MBMS mode according to an embodiment of the present disclosure. Notably, the elements in FIG. 14 are the same as those illustrated in FIGS. 6 and 7, except that the P-GW 610 is replaced with a P-GW 1410, which includes a HARD module 1450, and the BM-SC 620 is replaced with a BM-SC 1420, which includes the DASH server 602, a content switching module 1460, and a quality determination module 1470.

Referring to FIG. 14, the P-GW 1410 may control multimedia content, which has been provided from the DASH server 602 through a unicast session, to be transmitted to each UE, including UE 650, connected thereto. In this case, the HARD module 1450 may detect the total amount of multimedia content, which is transmitted to each UE through the P-GW 610, and transmit the detected amount to the BM-SC 1420.

The BM-SC 1420 may determine whether or not to switch the corresponding multimedia content transmission type to the MBMS mode, based on the total amount of transmitted multimedia content, as provided from the HARD module 1450.

When switching to the MBMS mode has been determined, the BM-SC 1420 may set an MBMS session with the UE 650. The BM-SC 1420 may transmit MBMS mode switching information to the content server 600.

When switching to the MBMS mode has been determined, the quality determination module 1470 of the BM-SC 1420 may determine the quality parameter in the MBMS mode, based on the service quality required by each UE that receives multimedia content. For example, the quality determination module 1470 may acquire the service quality, which is required by the UE 650, from the UE 650 or from the content server 600.

The content server 600 may transmit multimedia content information, which is to be transmitted to the UE 650 through an MBMS session, to the BM-SC 1420, in response to MBMS mode switching information. For example, the multimedia content information may include original copy data of multimedia content, which has been transmitted to the UE 650 through a unicast session.

The BM-SC 1420 may conduct processing such that multimedia content, which has been provided from the content server 600, based on the quality parameter of multimedia content determined by the quality determination module 1470, can be transmitted through the MBMS session. For example, the content switching module 1460 of the BM-SC 1420 may hierarchically encode multimedia content, which has been provided from the content server 600. The BM-SC 1420 may select at least a part of the multimedia content, which has been hierarchically encoded by the content switching module 1460, the part corresponding to the quality parameter of the multimedia content.

The BM-SC 1420 may transmit at least a part (e.g., multimedia data) of multimedia content, which corresponds to the quality parameter of the multimedia content, to the UE 650 through the MBMS session.

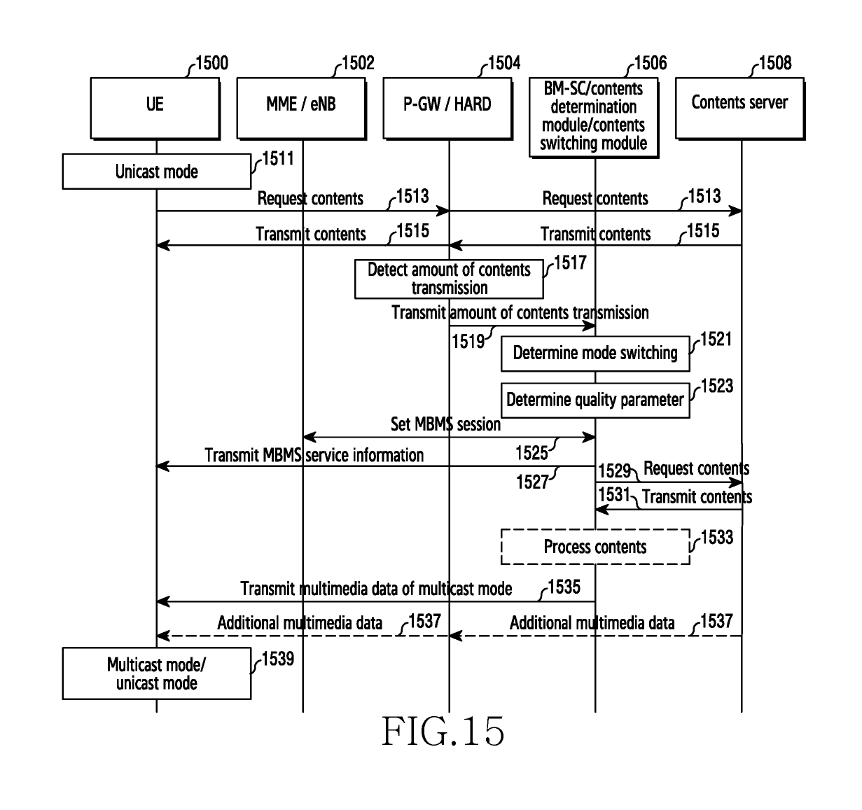

FIG. 15 is a signal flow diagram illustrating a process of switching to an MBMS mode and transmitting multimedia content according to an embodiment of the present disclosure.

Referring to FIG. 15, a UE 1500 provides a multimedia service in a unicast mode in operation 1511.

In operation 1513, the UE 1500 transmits a content request signal to a content server 1508 through the unicast session.

In operation 1515, the content server 1508 transmits multimedia content, to the UE 1500, through the unicast session, in response to the content request signal.

In operation 1517, a HARD module of the P-GW 1504 detects the total amount of multimedia content, which is transmitted to each UE through each unicast session from the P-GW 1504.

In operation 1519, the P-GW 1504 transmits the total amount of transmitted multimedia content, as detected by the HARD module, to a BM-SC 1506. For example, when a transmission event has occurred, the P-GW 1504 may transmit the total amount of transmitted multimedia content, as detected by the HARD module, to the BM-SC 1506. The transmission event may occur periodically or may occur when the total amount of transmitted multimedia content exceeds a reference value.

In operation 1521, the BM-SC 1506 determines to switch the corresponding multimedia content transmission type to an MBMS mode, based on the total amount of transmitted multimedia content, as detected by the HARD module.

In operation 1523, the BM-SC 1506 determines the quality parameter of the MBMS mode through a quality determination module, in response to the MBMS mode switching determination. For example, the quality determination module may determine the quality parameter of the MBMS mode, based on the service qualities required by each UE connected thereto. For example, the required service quality of the UE 1500 may be provided from the UE 1500 or from the content server 1508.

In operation 1525, the BM-SC 1506 sets an MBMS session with the eNB 1502, in response to the MBMS mode switching determination.

In operation 1527, the BM-SC 1506 transmits MBMS service information, to the UE 1500, through the eNB 1502, in response to MBMS session setup, and may set an MBMS session with the UE 1500.

In operations 1529 and 1531, the content server 1508 transmits multimedia content to the BM-SC 1506, in response to the content request of the BM-SC 1506. For example, when multimedia content that has been encoded hierarchically is stored in a content storage module, the content server 1508 may transmit the hierarchically encoded multimedia content to the BM-SC 1106, in response to the content request of the BM-SC 1506.

In operation 1533, the BM-SC 1506 may hierarchically encode multimedia content, which has been provided from the content server 1508, through a content switching module. The BM-SC 1506 may select at least a part of the hierarchically encoded multimedia content, based on the quality parameter of the multimedia content.

When the hierarchically encoded multimedia content is received from the content server 1508, the BM-SC 1506 may omit the content processing operation of operation 1533. Particularly, the BM-SC 1506 may select at least a part of the hierarchically encoded multimedia content, which has been provided from the content server 1508, based on the quality parameter of the multimedia content.

In operation 1535, the BM-SC 1506 transmits at least a part (e.g., multimedia data) of the multimedia content to the UE 1500 through the MBMS session.

In operation 1539, the UE 1500 provides a multimedia service in a multicast mode. For example, the UE 1500 restores and reproduces multimedia content, based on the multimedia data provided through the MBMS session.

However, when the service quality regarding multimedia content should be improved, the UE 1500 may receive additional multimedia data from the content server 1508 through a unicast session in operation 1537. Thereafter, in operation 1539, the UE 1500 restores and reproduces the multimedia content with improved quality, based on the multimedia data provided through the MBMS session and the additional multimedia data provided through the unicast session.

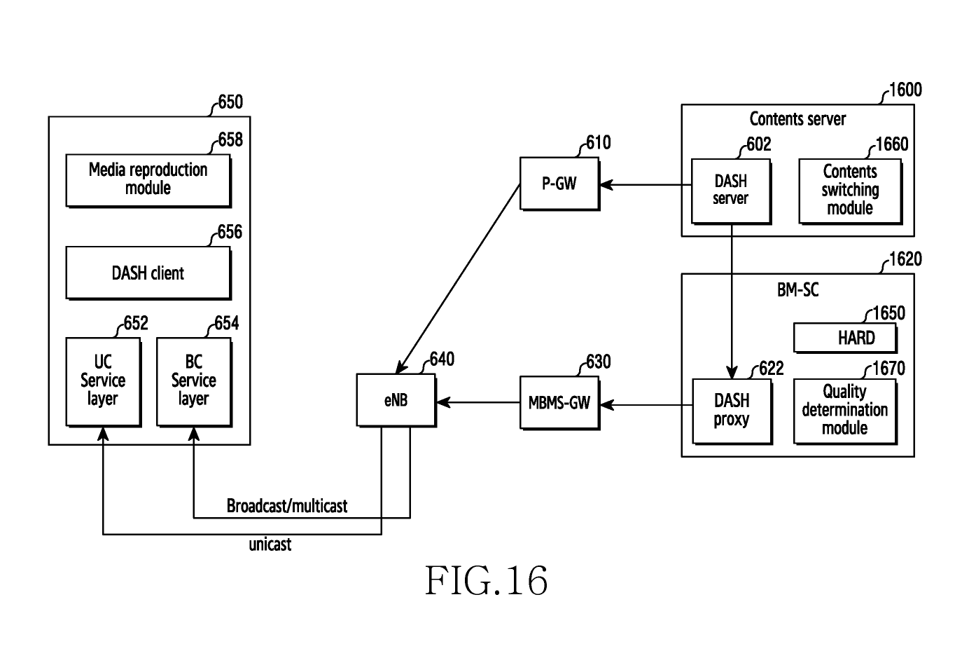

FIG. 16 illustrates a wireless communication system for switching to an MBMS mode according to an embodiment of the present disclosure. Notably, the elements in FIG. 16 are the same as those illustrated in FIGS. 6 and 7, except that the content server 600 is replaced with a content server 1600, which includes the DASH server 602 and a content switching module 1660, and the BM-SC 620 is replaced with a BM-SC 1620, which includes the DASH proxy 622, a HARD module 1650, and a quality determination module 1670.

Referring to FIG. 16, the HARD module 1650 in the BM-SC 1620 detects the total amount of multimedia content, which is transmitted to each UE through the P-GW 610. For example, when multimedia content is transmitted through each unicast session from the P-GW 610, the HARD module 1650 may periodically detect the total amount of transmitted multimedia content.

The BM-SC 1620 may determine whether or not to switch the corresponding multimedia content transmission type to an MBMS mode, based on the total amount of transmitted multimedia content, as detected by the HARD module 1650.

When switching to the MBMS mode has been determined, the quality determination module 1670 of the BM-SC 1620 may determine the service quality parameter in the MBMS mode, based on the service quality required by each UE that receives multimedia content. For example, the quality determination module 1670 may acquire the service quality required by the UE 650, from the UE 650 or from the content server 1600.

The content server 1600 may process multimedia content, which is to be transmitted through the MBMS session, based on the quality parameter of multimedia content provided from the quality determination module 1670. For example, when information regarding hierarchically encoded multimedia content is stored in a content storage module (i.e., the content storage module 604 of FIG. 6), the content server 1600 may select at least a part of the hierarchically encoded multimedia content, which corresponds to the quality parameter of the multimedia content. For example, when hierarchically encoded multimedia content is not stored in a content storage module, the content switching module 1660 of the content server 1600 may hierarchically encode the corresponding multimedia content.

The DASH server 602 of the content server 1600 may select at least a part of the multimedia content, which has been hierarchically encoded by the content switching module 1660, based on the quality parameter of the multimedia content.

The content server 1600 may transmit at least a part (e.g., multimedia data) of the multimedia content, which corresponds to the quality parameter of multimedia content determined by the quality determination module 1670, to the UE 650, through the MBMS session.

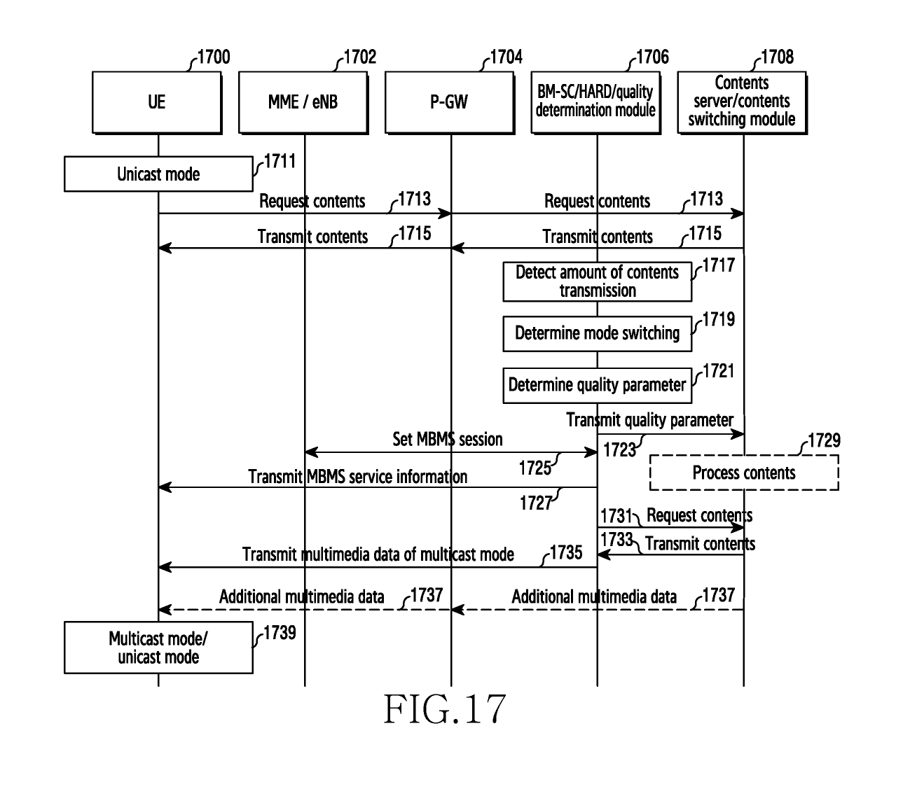

FIG. 17 is a signal flow diagram illustrating a process of switching to an MBMS mode and transmitting multimedia content according to an embodiment of the present disclosure.

Referring to FIG. 17, a UE 1700 provides a multimedia service in a unicast mode in operation 1711.

In operation 1713, the UE 1700 transmits a content request signal to a content server 1708 through the unicast session.

In operation 1715, the content server 1708 transmits multimedia content, to the UE 1700, through the unicast session, in response to the content request signal. For example, the content server 1708 may transmit multimedia content to the UE 1700 through a P-GW 1706.

In operation 1717, a HARD module of the BM-SC 1706 detects the total amount of multimedia content, which is transmitted to each UE through each unicast session from the P-GW 1704.

In operation 1719, the BM-SC 1706 determines to switch the corresponding multimedia content transmission type to an MBMS mode, based on the total amount of transmitted multimedia content, as detected by the HARD module.

In operation 1721, the quality determination module of the BM-SC 1706 determines the quality parameter of the MBMS mode, in response to the MBMS mode switching determination. For example, the quality determination module may determine the quality parameter of the MBMS mode, based on the service quality, which is required by each UE. For example, the service quality required by the UE 1700 may be provided from the UE 1700 or from the content server 1708. The quality parameter may include at least one of a video quality of multimedia content, which is transmitted through the MBMS session, and an audio quality thereof.

In operation 1723, the BM-SC 1706 transmits the quality parameter of the MBMS mode, which has been determined by the quality determination module, to the content server 1708.

In operation 1725, the BM-SC 1706 sets an MBMS session with the eNB 1702, in response to the MBMS mode switching determination.

In operation 1727, the BM-SC 1706 transmits MBMS service information, to the UE 1700, through the eNB 1702, in response to MBMS session setup, and may set an MBMS session with the UE 1700.

In operation 1729, the content server 1708 may process multimedia content, which is to be transmitted through the MBMS session, based on the quality parameter of the MBMS mode. For example, when the multimedia content has not been encoded hierarchically, the content server 1708 may hierarchically encode the multimedia content through a content switching module in operation 1729. The content server 1708 may select at least a part of the hierarchically encoded multimedia content, based on the quality parameter of the multimedia content. However, when the multimedia content has been encoded hierarchically, the content server 1708 may omit the content processing operation of operation 1729.

In operation s 1731 and 1733, the content server 1708 transmits at least a part (e.g., multimedia data) of multimedia content, which corresponds to the quality parameter of the MBMS mode, to the BM-SC 1706, in response to a content request of the BM-SC 1706.

In operation 1735, the BM-SC 1706 transmits at least a part (e.g., multimedia data) of the multimedia content, to the UE 1700, through the MBMS session.

In operation 1739, the UE 1700 provides a multimedia service in a multicast mode. For example, the UE 1700 restores and reproduces multimedia content, based on the multimedia data provided through the MBMS session.

Alternatively, when the service quality regarding multimedia content should be improved, the UE 1700 may receive additional multimedia data from the content server 1708 through a unicast session in operation 1737. Thereafter, in operation 1739, the UE 1700 restores and reproduces the multimedia content with improved quality, based on the multimedia data provided through the MBMS session and the additional multimedia data provided through the unicast session.

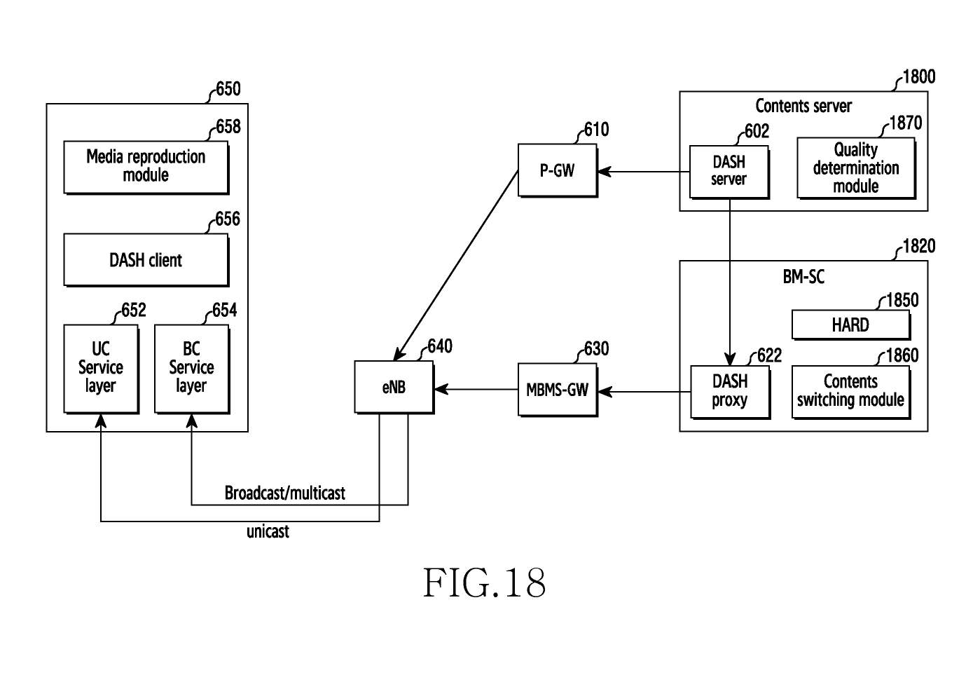

FIG. 18 illustrates a wireless communication system for switching to an MBMS mode according to an embodiment of the present disclosure. Notably, the elements in FIG. 18 are the same as those illustrated in FIGS. 6 and 7, except that the content server 600 is replaced with a content server 1800, which includes the DASH server 602 and a quality determination module 1870, and the BM-SC 620 is replaced with a BM-SC 1820, which includes the DASH proxy 622, a HARD module 1850, and a content switching module 1860.

Referring to FIG. 18, the HARD module 1850 in the BM-SC 1820 detects the total amount of multimedia content, which is transmitted to each UE through each unicast session from a P-GW 610.

The BM-SC 1820 may determine whether or not to switch the corresponding multimedia content transmission type to an MBMS mode, based on the total amount of transmitted multimedia content, as detected by the HARD module 1850.

When switching to the MBMS mode has been determined, the BM-SC 1820 may set an MBMS session with the UE 650. The BM-SC 1820 may transmit MBMS mode switching information to the content server 1800.

The quality determination module 1870 of the content server 1800 may determine the quality parameter in the MBMS mode, based on the service quality required by each UE that receives multimedia content, in response to the MBMS mode switching information.

When the original copy of multimedia content is stored in a content storage module (i.e., the content storage module 604 of FIG. 6), the content server 1800 may transmit the quality parameter of multimedia content, which has been determined by the quality determination module 1870, and the corresponding multimedia content, to the BM-SC 620.

The BM-SC 1820 may conduct processing such that, based on the quality parameter of multimedia content provided from the content server 1800, the corresponding multimedia content can be transmitted through the MBMS session. For example, the content switching module 1860 of the BM-SC 1820 may hierarchically encode multimedia content, which has been provided from the content server 1800. The BM-SC 1820 may select at least a part of the multimedia content, which has been hierarchically encoded by the content switching module 1860, based on the quality parameter of the multimedia content.

The BM-SC 1820 may transmit at least a part (e.g., multimedia data) of multimedia content, which corresponds to the quality parameter of the multimedia content, to the UE 650, through the MBMS session.

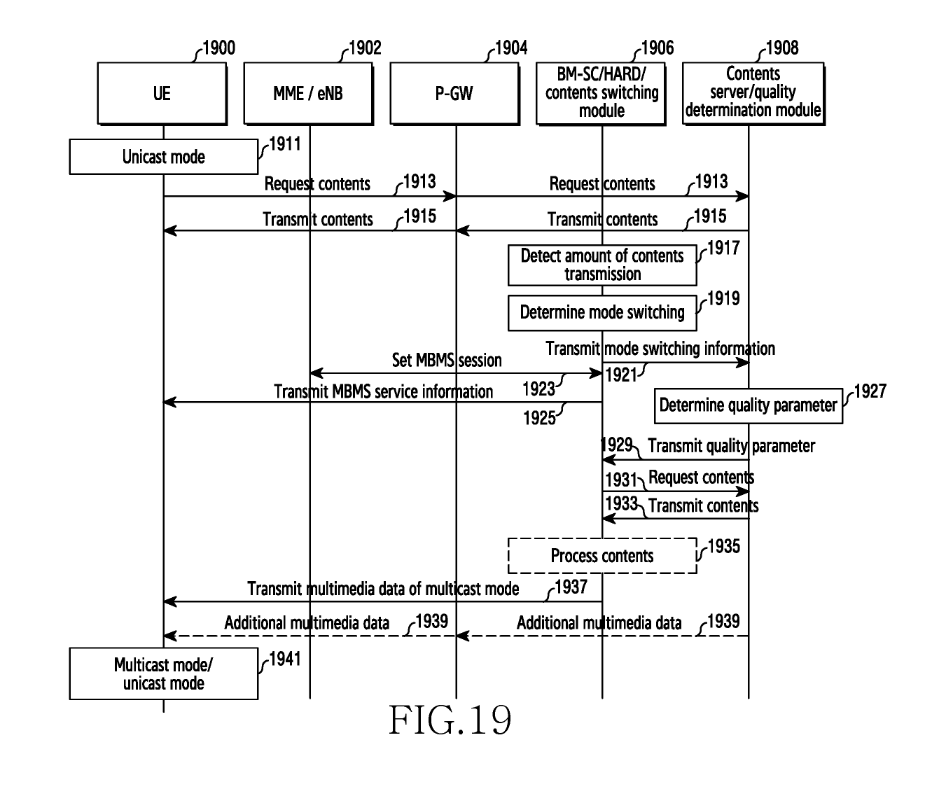

FIG. 19 is a signal flow diagram illustrating a process of switching to an MBMS mode and transmitting multimedia content according to an embodiment of the present disclosure.

Referring to FIG. 19, a UE 1900 provides a multimedia service in a unicast mode in operation 1911. The UE 1900 may set a unicast session for receiving multimedia content through an eNB 1902 and a P-GW 1904.

In operation 1913, the UE 1900 may transmit a content request signal to a content server 1908 through the unicast session.

In operation 1915, the content server 1908 transmits multimedia content, to the UE 1900, through the unicast session, in response to the content request signal.

In operation 1913, a HARD module of the BM-SC 1906 detects the total amount of multimedia content, which is transmitted to each UE through each unicast session from the P-GW 1904.

In operation 1919, the BM-SC 1906 determines to switch the corresponding multimedia content transmission type to an MBMS mode, based on the total amount of transmitted multimedia content, which has been detected through the HARD module.

In operation 1921, the BM-SC 1906 transmits MBMS mode switching information to the content server 1908, in response to the MBMS mode switching determination.

In operation 1923, the BM-SC 1906 sets an MBMS session with the eNB 1902, in response to the MBMS mode switching determination.

In operation 1925, the BM-SC 1906 transmits MBMS service information, to the UE 1900, through the eNB 1902, in response to MBMS session setup. For example, the BM-SC 1906 may set an MBMS session with the UE 1900, based on the MBMS service information through the eNB 1902.

In operation 1927, the content server 1908 determines the quality parameter of the MBMS mode through the quality determination module, in response to the MBMS mode switching information. For example, the quality determination module may determine the quality parameter of multimedia content, which is to be transmitted in the MBMS mode, based on the service quality information transmitted from the content server 1908 to each UE, including UE 1900, through a unicast session.

In operation 1929, the content server 1908 transmits the quality parameter of the MBMS mode to the BM-SC 1906.

In operations 1931 and 1933, the content server 1908 transmits multimedia content, to the BM-SC 1906, in response to the content request of the BM-SC 1906. For example, when multimedia content that has not been encoded hierarchically is stored in a content storage module, the content server 1908 may transmit multimedia content, to the BM-SC 1906, in response to the content request of the BM-SC 1906. When hierarchically encoded multimedia content is stored in the content storage module, the content server 1908 may select at least a part of the hierarchically encoded multimedia content, which corresponds to the quality parameter of the MBMS mode, and transmit the selected part to the BM-SC 1906.

When multimedia content that has not been encoded hierarchically is received from the content server 1908, the BM-SC 1906 may hierarchically encode the received multimedia content through the content switching module in operation 1935. The BM-SC 1906 may select at least a part of the hierarchically encoded multimedia content, based on the quality parameter of the multimedia content.

When at least a part of the hierarchically encoded multimedia content is received from the content server 1908, the BM-SC 1906 may omit the content processing operation of operation 1935.

In operation 1937, the BM-SC 1906 transmits at least a part (e.g., multimedia data) of the multimedia content, to the UE 1900, through the MBMS session.

In operation 1941, the UE 1900 provides a multimedia service in a multicast mode. For example, the UE 1900 restores and reproduces multimedia content, based on the multimedia data provided through the MBMS session.

Alternatively, when the service quality regarding multimedia content should be improved, the UE 1900 may receive additional multimedia data from the content server 1908 through a unicast session in operation 1939. Thereafter, in operation 1941, the UE 1900 restores and reproduces the multimedia content with improved quality, based on the multimedia data provided through the MBMS session and the additional multimedia data provided through the unicast session.

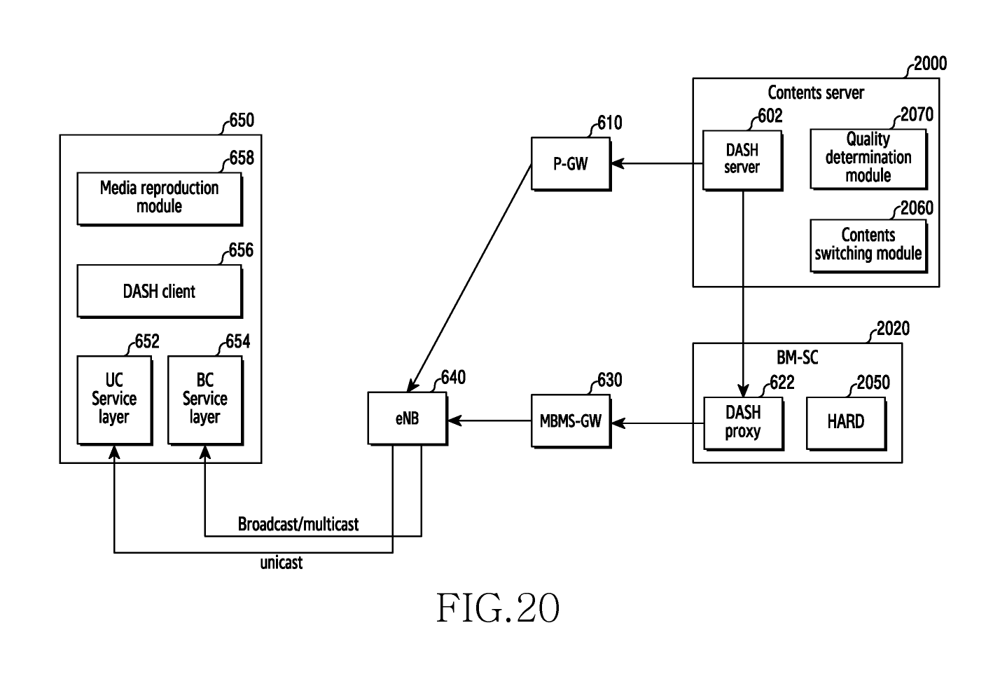

FIG. 20 illustrates a wireless communication system for switching to an MBMS mode according to an embodiment of the present disclosure. Notably, the elements in FIG. 20 are the same as those illustrated in FIGS. 6 and 7, except that the content server 600 is replaced with a content server 2000, which includes the DASH server 602, a content switching module 2060, and a quality determination module 2070, and the BM-SC 620 is replaced with a BM-SC 2020, which includes the DASH proxy 622 and a HARD module 2050.

Referring to FIG. 20, the HARD module 2050 in the BM-SC 2020 may detect the total amount of multimedia content, which is transmitted to each UE through each unicast session from the P-GW 610.

The BM-SC 2020 may determine whether or not to switch the corresponding multimedia content transmission type to an MBMS mode, based on the total amount of transmitted multimedia content, as detected by the HARD module 2050.

When switching to the MBMS mode has been determined, the BM-SC 2020 may set an MBMS session with the UE 650. The BM-SC 2020 may transmit MBMS mode switching information to the content server 2000.

The quality determination module 2070 of the content server 2000 may determine the quality parameter in the MBMS mode, based on the service quality required by each UE that receives multimedia content, in response to the MBMS mode switching information.

The content server 2000 may process multimedia content, which is to be transmitted through the MBMS session, based on the quality parameter of multimedia content determined by the quality determination module 2070. For example, when information regarding hierarchically encoded multimedia content is stored in a content storage module (i.e., the content storage module 604 of FIG. 6), the content server 2000 may select at least a part of the hierarchically encoded multimedia content, which corresponds to the quality parameter of the multimedia content. For example, when the original copy of multimedia content is stored in the content storage module, the content switching module 2060 may hierarchically encode the corresponding multimedia content. The DASH server 602 may select at least a part of the multimedia content, which has been hierarchically encoded by the content switching module 2060, based on the quality parameter of the multimedia content.

The content server 2000 may transmit at least a part (e.g., multimedia data) of multimedia content, which has been processed to correspond to the quality parameter of multimedia content, to the BM-SC 2020.

The BM-SC 2020 may transmit at least a part (e.g., multimedia data) of multimedia content, which has been provided from the content server 2000, to the UE 650, through the MBMS session.

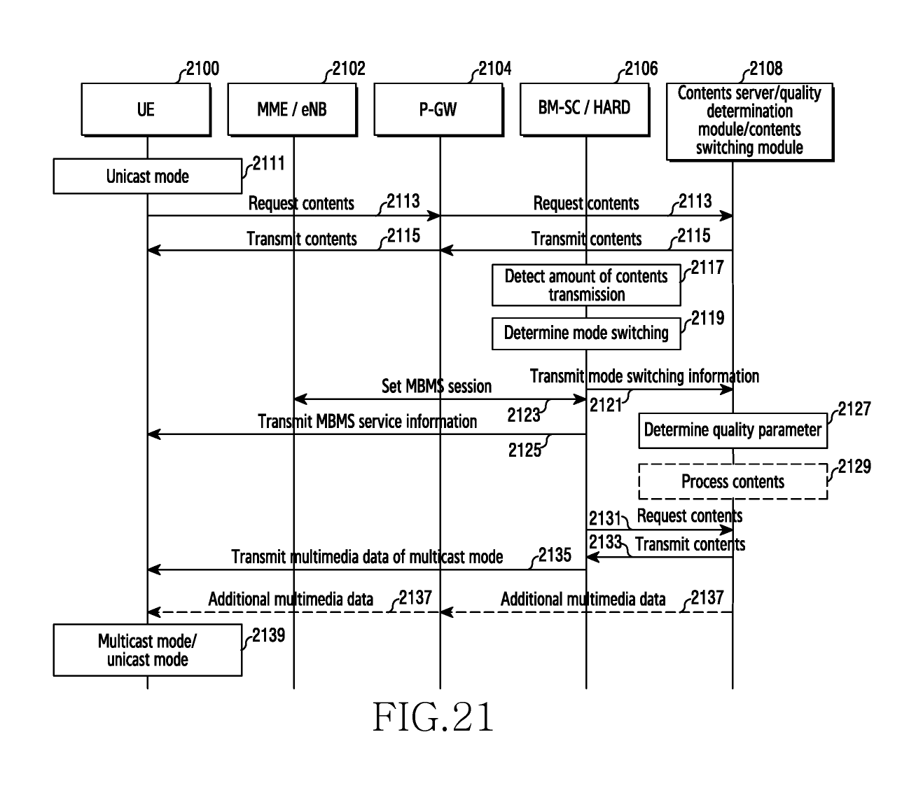

FIG. 21 is a signal flow diagram illustrating a process of switching to an MBMS mode and transmitting multimedia content according to an embodiment of the present disclosure.

Referring to FIG. 21, a UE 2100 provides a multimedia service in a unicast mode in operation 2111.

In operation 2113, the UE 2100 transmits a content request signal to a content server 2108 through the unicast session.

In operation 2115, the content server 2108 transmits multimedia content, to the UE 2100, through the unicast session, in response to the content request signal.

In operation 2117, a HARD module of the BM-SC 2106 detects the total amount of multimedia content, which is transmitted to each UE through each unicast session from the P-GW 2104.

In operation 2119, the BM-SC 2106 determines to switch the corresponding multimedia content transmission type to an MBMS mode, based on the total amount of transmitted multimedia content, as detected through the HARD module.

In operation 2121, the BM-SC 2106 transmits MBMS mode switching information to the content server 2108, in response to the MBMS mode switching determination.

In operation 2123, the BM-SC 2106 sets an MBMS session with the eNB 2102, in response to the MBMS mode switching determination.

In operation 2125, the BM-SC 2106 transmits MBMS service information, to the UE 2100, through the eNB 2102, in response to MBMS session setup, and may set an MBMS session with the UE 2100.

In operation 2127, the content server 2108 determines the quality parameter of the MBMS mode through the quality determination module, in response to the MBMS mode switching information. For example, the quality determination module may determine the quality parameter of multimedia content, which is to be transmitted in the MBMS mode, based on the service quality information transmitted from the content server 2108 to each UE through a unicast session.

In operation 2129, the content server 2108 processes multimedia content, which is to be transmitted through the MBMS session, based on the quality parameter of multimedia content related to the MBMS mode. For example, when the multimedia content has not been encoded hierarchically, the content server 2108 may hierarchically encode the multimedia content through a content switching module in operation 2129. The content server 2108 may select at least a part of the hierarchically encoded multimedia content, based on the quality parameter of the multimedia content. For example, when the multimedia content has been encoded hierarchically, the content server 2108 may omit the content processing operation of operation 2129.

In operation s 2131 and 2133, the content server 2108 transmits at least a part (e.g., multimedia data) of multimedia content, which corresponds to the quality parameter of the MBMS mode, to the BM-SC 2106, in response to a content request of the BM-SC 2106.

In operation 2135, the BM-SC 2106 transmits at least a part (e.g., multimedia data) of the multimedia content, to the UE 2100, through the MBMS session.

In operation 2139, the UE 2100 provides a multimedia service in a multicast mode. For example, the UE 2100 restores and reproduces multimedia content, based on the multimedia data provided through the MBMS session.

Alternatively, when the service quality regarding multimedia content should be improved, the UE 2100 may receive additional multimedia data from the content server 2108 through a unicast session in operation 2137. Thereafter, in operation 2139, UE 2100 restores and reproduces multimedia content with improved quality, based on the multimedia data provided through the MBMS session and the additional multimedia data provided through the unicast session.

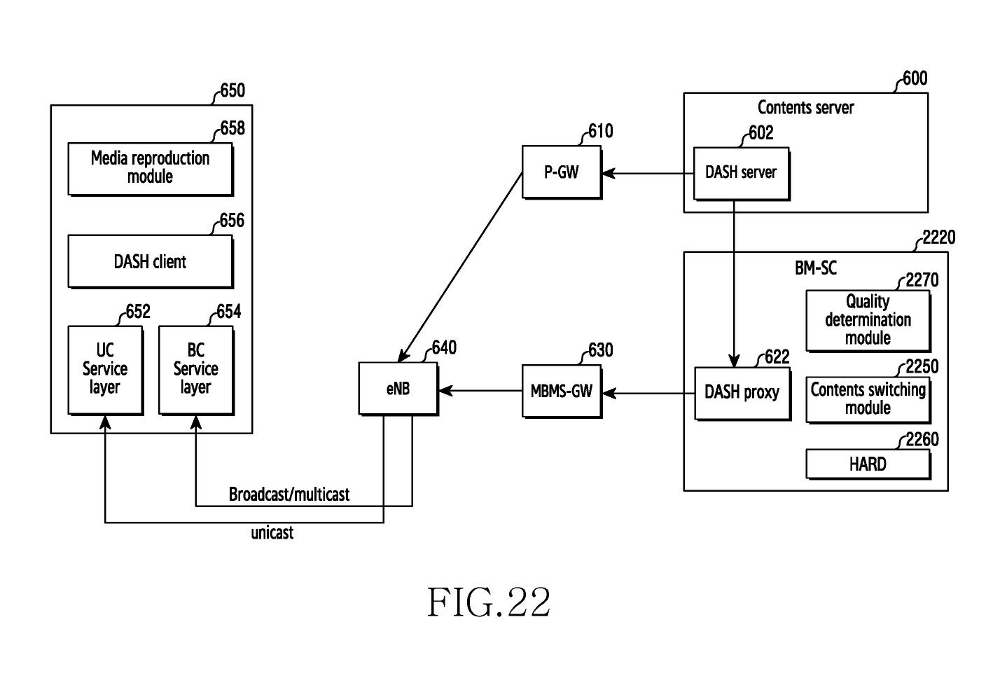

FIG. 22 illustrates a wireless communication system for switching to an MBMS mode according to an embodiment of the present disclosure. Notably, the elements in FIG. 22 are the same as those illustrated in FIGS. 6 and 7, except that the BM-SC 620 is replaced with a BM-SC 2220, which includes the DASH proxy 622, a HARD module 2250, a content switching module 2260, and a quality determination module 2270.

Referring to FIG. 22, the HARD module 2250 in the BM-SC 2220 may detect the total amount of multimedia content, which is transmitted to each UE through each unicast session from the P-GW 610.

The BM-SC 2220 may determine whether or not to switch the corresponding multimedia content transmission type to an MBMS mode, based on the total amount of transmitted multimedia content, as detected by the HARD module 2250.

When switching to the MBMS mode has been determined, the BM-SC 2220 may set an MBMS session with the UE 650. The BM-SC 2220 may transmit MBMS mode switching information to the content server 600.

When switching to the MBMS mode has been determined, the quality determination module 2270 of the BM-SC 2220 may determine the quality parameter in the MBMS mode, based on the service quality required by each UE that receives multimedia content. For example, the quality determination module 2270 may acquire the service quality, which is required by the UE 650, from the UE 650 or from the content server 600.

The content server 600 may transmit multimedia content information, which is to be transmitted to the UE 650 through an MBMS session, to the BM-SC 2220. in response to MBMS mode switching information. For example, the multimedia content information may include original copy data of multimedia content, which has been transmitted to the UE 650 through a unicast session.

The BM-SC 620 may conduct processing such that multimedia content, which has been provided from the content server 600, based on the quality parameter of multimedia content determined by the quality determination module 2270, can be transmitted through the MBMS session. For example, the content switching module 2260 of the BM-SC 2220 may hierarchically encode multimedia content, which has been provided from the content server 600. The BM-SC 2220 may select at least a part of the multimedia content, which has been hierarchically encoded by the content switching module 2260, the selected part corresponding to the quality parameter of the multimedia content.

The BM-SC 2220 may transmit at least a part (e.g., multimedia data) of multimedia content, which corresponds to the quality parameter of the multimedia content, to the UE 650 through the MBMS session.

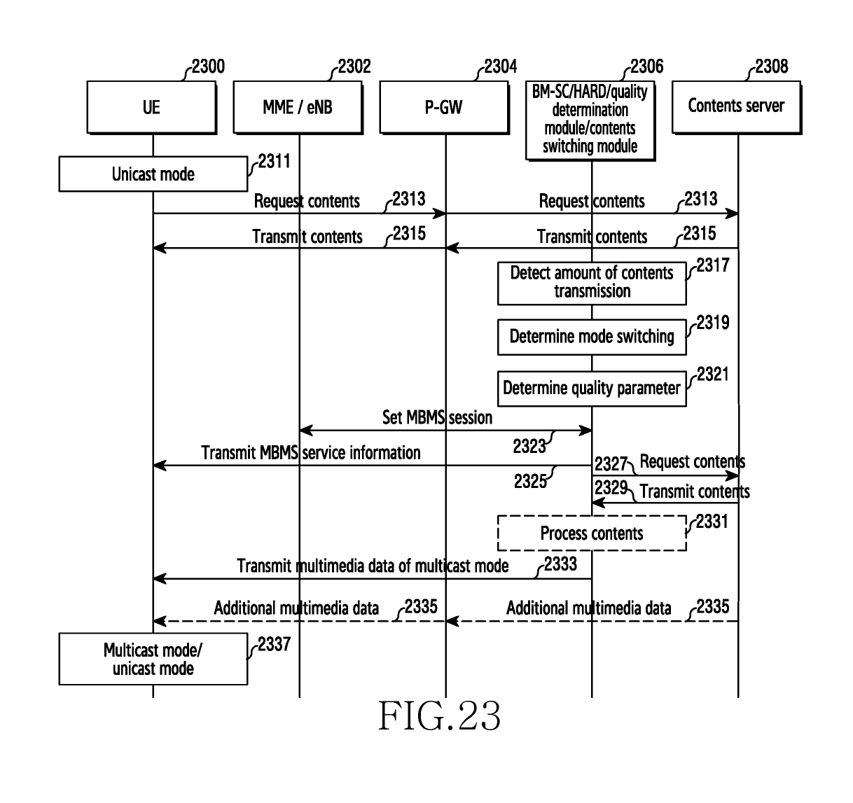

FIG. 23 is a signal flow diagram illustrating a process of switching to an MBMS mode and transmitting multimedia content according to an embodiment of the present disclosure.

Referring to FIG. 23, a UE 2300 provides a multimedia service in a unicast mode in operation 2311.

In operation 2313, the UE 2300 transmits a content request signal to a content server 2308 through the unicast session.

In operation 2315, the content server 2308 transmits multimedia content, to the UE 2300, through the unicast session, in response to the content request signal.

In operation 2317, a HARD module of the BM-SC 2306 detects the total amount of multimedia content, which is transmitted to each UE through each unicast session from the P-GW 2304.

In operation 2319, the BM-SC 2306 determines to switch the corresponding multimedia content transmission type to an MBMS mode, based on the total amount of transmitted multimedia content, as detected through the HARD module.

In operation 2321, the BM-SC 2306 determines the quality parameter of the MBMS mode through a quality determination module, in response to the MBMS mode switching determination. For example, the quality determination module may determine the quality parameter of the MBMS mode, based on the service quality required by each UE that receives multimedia content through a unicast session.

In operation 2323, the BM-SC 2306 sets an MBMS session with the eNB 2302, in response to the MBMS mode switching determination.

In operation 2325, the BM-SC 2306 transmits MBMS service information, to the UE 2300, through the eNB 2302, in response to MBMS session setup, and may set an MBMS session with the UE 2300.

In operations 2327 and 2329, the content server 2308 transmits multimedia content to the BM-SC 2306, in response to the content request of the BM-SC 2306. For example, when multimedia content that has been encoded hierarchically is stored in a content storage module, the content server 2308 may transmit the hierarchically encoded multimedia content to the BM-SC 2306, in response to the content request of the BM-SC 2306.

When multimedia content that has not been encoded hierarchically is received from the content server 2308, the BM-SC 2306 may hierarchically encode the received multimedia content, through the content switching module in operation 2331. The BM-SC 2306 may select at least a part of the hierarchically encoded multimedia content, based on the quality parameter of the multimedia content.

When the hierarchically encoded multimedia content is received from the content server 2306, the BM-SC 2308 may omit the content processing operation of operation 2331. Particularly, the BM-SC 2306 may select at least a part of the hierarchically encoded multimedia content, which has been provided from the content server 2308, based on the quality parameter of the multimedia content.

In operation 2333, the BM-SC 2306 transmits at least a part (e.g., multimedia data) of the multimedia content, to the UE 2300, through the MBMS session.

In operation 2337, the UE 2300 provides a multimedia service in a multicast mode. For example, the UE 2300 restores and reproduces multimedia content, based on the multimedia data provided through the MBMS session.

Alternatively, when the service quality regarding multimedia content should be improved, the UE 2300 receives additional multimedia data from the content server 2308 through a unicast session in operation 2335. Thereafter, in operation 2337, the UE 2300 restores and reproduces the multimedia content with improved quality, based on the multimedia data provided through the MBMS session and the additional multimedia data provided through the unicast session.

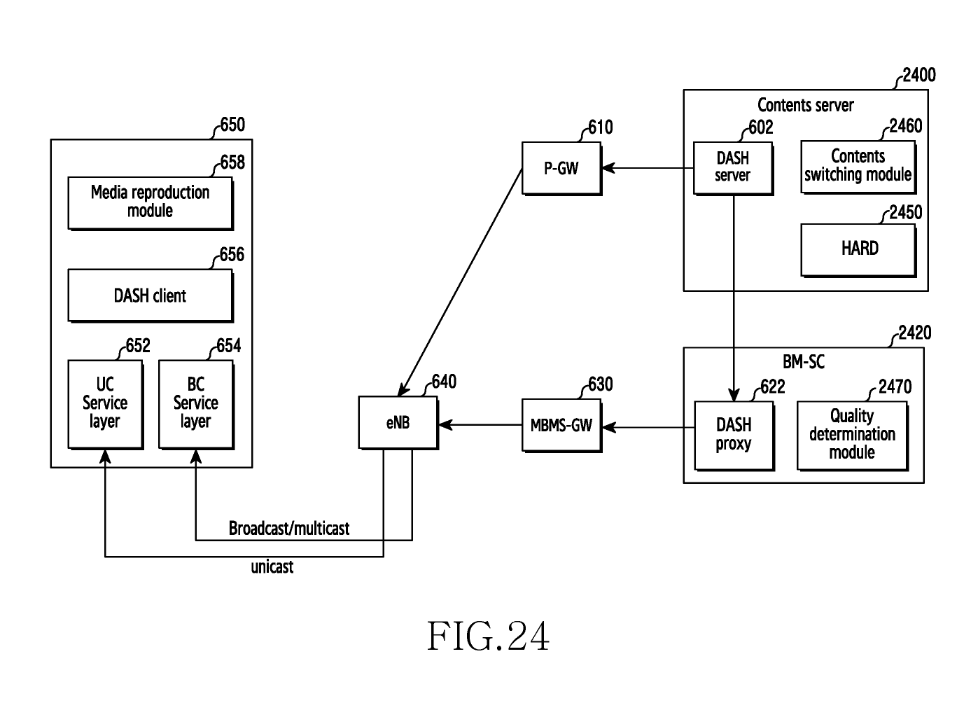

FIG. 24 illustrates a wireless communication system for switching to an MBMS mode according to an embodiment of the present disclosure. Notably, the elements in FIG. 24 are the same as those illustrated in FIGS. 6 and 7, except that the content server 600 is replaced with a content server 2400, which includes the DASH server 602, a content switching module 2460, and a HARD module 2450, and the BM-SC 620 is replaced with a BM-SC 2420, which includes the DASH proxy 622 and a quality determination module 2470.

Referring to FIG. 24, the HARD module 2450 in the content server 2400 may detect the total amount of multimedia content, which is transmitted to each UE through the P-GW 610.

The BM-SC 2420 may determine whether or not to switch the corresponding multimedia content transmission type to an MBMS mode, based on the total amount of transmitted multimedia content, which is provided from the HARD module 2450 of the content server 2400.

When switching to the MBMS mode has been determined, the quality determination module 2470 of the BM-SC 2420 may determine the service quality parameter in the MBMS mode, based on the service quality required by each UE that receives multimedia content. In this case, the quality determination module 2470 may acquire the service quality required by the UE 650, from the UE 650 or from the content server 2400.

The content server 2400 may process multimedia content, which is to be transmitted through the MBMS session, based on the quality parameter of multimedia content provided from the quality determination module 2470. For example, when information regarding hierarchically encoded multimedia content is stored in a content storage module (i.e., the content storage module 604 of FIG. 6), the content server 2400 may select at least a part of the hierarchically encoded multimedia content, which corresponds to the quality parameter of the multimedia content. For example, when hierarchically encoded multimedia content is not stored in the content storage module, the content switching module 2460 of the content server 2400 may hierarchically encode the corresponding multimedia content. The DASH server 602 of the content server 2400 may select at least a part of the multimedia content, which has been hierarchically encoded by the content switching module 2460, based on the quality parameter of the multimedia content.

The content server 2400 may transmit at least a part (e.g., multimedia data) of the multimedia content, which corresponds to the quality parameter of multimedia content determined by the quality determination module 2470, to the UE 650, through the MBMS session.

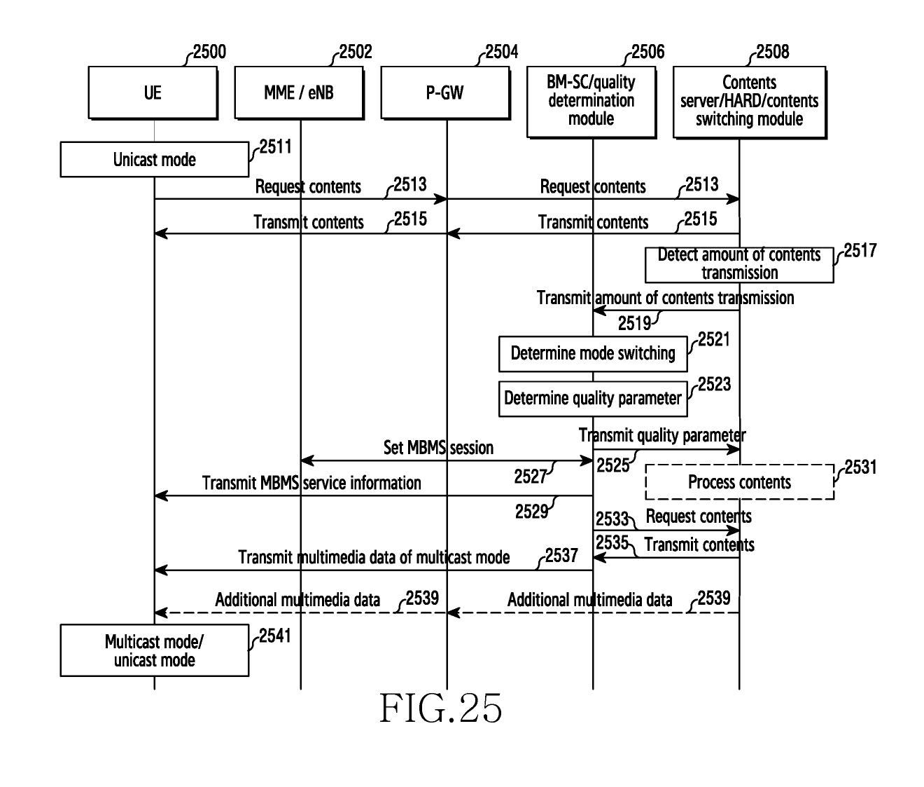

FIG. 25 is a signal flow diagram illustrating a process of switching to an MBMS mode and transmitting multimedia content according to an embodiment of the present disclosure.

Referring to FIG. 25, a UE 2500 provides a multimedia service in a unicast mode in operation 2511.

In operation 2513, the UE 2500 transmits a content request signal to a content server 2508 through the unicast session.

In operation 2515, the content server 2508 transmits multimedia content, to the UE 2500, through the unicast session, in response to the content request signal. For example, the content server 2508 may transmit multimedia content to the UE 2500 through a P-GW 2506.

In operation 2517, a HARD module of the content server 2508 detects the total amount of multimedia content, which is transmitted to each UE through each unicast session from the P-GW 2504.

In operation 2519, the content server 2508 transmits the total amount of transmitted multimedia content, as detected by the HARD module, to a BM-SC 2506. For example, when the total amount of transmitted multimedia content detected by the HARD module exceeds a reference value, the content server 2508 may transmit the corresponding total amount of multimedia content to the BM-SC 2506. The content server 2508 may also periodically transmit the total amount of transmitted multimedia content, as detected by the HARD module, to the BM-SC 2506.

In operation 2521, the BM-SC 2506 determines to switch the corresponding multimedia content transmission type to an MBMS mode, based on the total amount of transmitted multimedia content, which has been provided from the content server 2508.

In operation 2523, the quality determination module of the BM-SC 2506 determines the quality parameter of the MBMS mode, in response to the MBMS mode switching determination. For example, the quality determination module may determine the quality parameter of the MBMS mode, based on the service quality required by each UE. The quality determination module may receive the service quality that is required by the UE 2500, from the UE 2500 or from the content server 2508.

In operation 2525, the BM-SC 2506 transmits the quality parameter of the MBMS mode, as determined by the quality determination module, to the content server 2508.

In operation 2527, the BM-SC 2506 sets an MBMS session with the eNB 2502, in response to the MBMS mode switching determination.

In operation 2529, the BM-SC 2506 transmits MBMS service information, to the UE 2500, through the eNB 2502, in response to MBMS session setup, and may set an MBMS session with the UE 2500.

In operation 2531, the content server 2508 may process multimedia content, which is to be transmitted through the MBMS session, based on the quality parameter of the MBMS mode. For example, when the multimedia content has not been encoded hierarchically, the content server 2508 may hierarchically encode the multimedia content through a content switching module in operation 2531. The content server 2508 may select at least a part of the hierarchically encoded multimedia content, based on the quality parameter of the multimedia content. However, when the multimedia content has been encoded hierarchically, the content server 2508 may omit the content processing operation of operation 2531.

In operations 2533 and 2535, the content server 2508 transmits at least a part (e.g., multimedia data) of multimedia content, which corresponds to the quality parameter of the MBMS mode, to the BM-SC 2506, in response to a content request of the BM-SC 2506.

In operation 2537, the BM-SC 2506 transmits at least a part (e.g., multimedia data) of the multimedia content, to the UE 2500, through the MBMS session.

In operation 2541, the UE 2500 provides a multimedia service in a multicast mode. For example, the UE 2500 restores and reproduces multimedia content, based on the multimedia data provided through the MBMS session.

Alternatively, when the service quality regarding multimedia content should be improved, the UE 2500 may receive additional multimedia data from the content server 2508 through a unicast session in operation 2539. Thereafter, in operation 2541, the UE 2500 restores and reproduces the multimedia content with improved quality, based on the multimedia data provided through the MBMS session and the additional multimedia data provided through the unicast session.

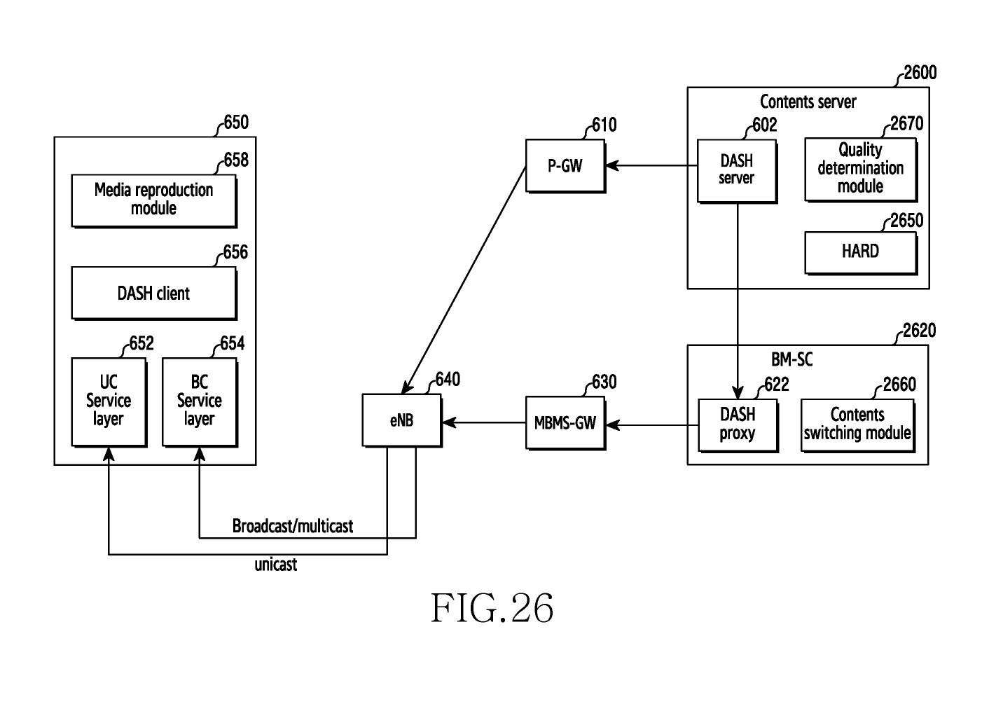

FIG. 26 illustrates a wireless communication system for switching to an MBMS mode according to an embodiment of the present disclosure. Notably, the elements in FIG. 26 are the same as those illustrated in FIGS. 6 and 7, except that the content server 600 is replaced with a content server 2600, which includes the DASH server 602, a quality determination module 2670, and a HARD module 2650, and the BM-SC 620 is replaced with a BM-SC 2620, which includes the DASH proxy 622 and a content switching module 2660.

Referring to FIG. 26, the HARD module 2650 in the content server 2600 may detect the total amount of multimedia content, which is transmitted to each UE through each unicast session from the P-GW 610.

The BM-SC 2620 may determine whether or not to switch the corresponding multimedia content transmission type to an MBMS mode, based on the total amount of transmitted multimedia content, as provided from the HARD module 2600 of the content server 2600.

When switching to the MBMS mode has been determined, the BM-SC 2620 may set an MBMS session with the UE 650. The BM-SC 2620 may transmit MBMS mode switching information to the content server 2600.

The quality determination module 2670 of the content server 2600 may determine the quality parameter in the MBMS mode, based on the service quality required by each UE that receives multimedia content, in response to the MBMS mode switching information.

When the original copy of multimedia content is stored in a content storage module (i.e., the content storage module 604 of FIG. 6), the content server 2600 may transmit the quality parameter of multimedia content, which has been determined by the quality determination module 2670, and the corresponding multimedia content, to the BM-SC 2620.

The BM-SC 2620 may conduct processing such that, based on the quality parameter of multimedia content provided from the content server 2600, the corresponding multimedia content can be transmitted through the MBMS session. For example, the content switching module 2660 of the BM-SC 2620 may hierarchically encode multimedia content, which has been provided from the content server 2600. The BM-SC 2620 may select at least a part of the multimedia content, which has been hierarchically encoded by the content switching module 2660, based on the quality parameter of the multimedia content.

The BM-SC 2620 may transmit at least a part (e.g., multimedia data) of multimedia content, which corresponds to the quality parameter of the multimedia content, to the UE 650, through the MBMS session.

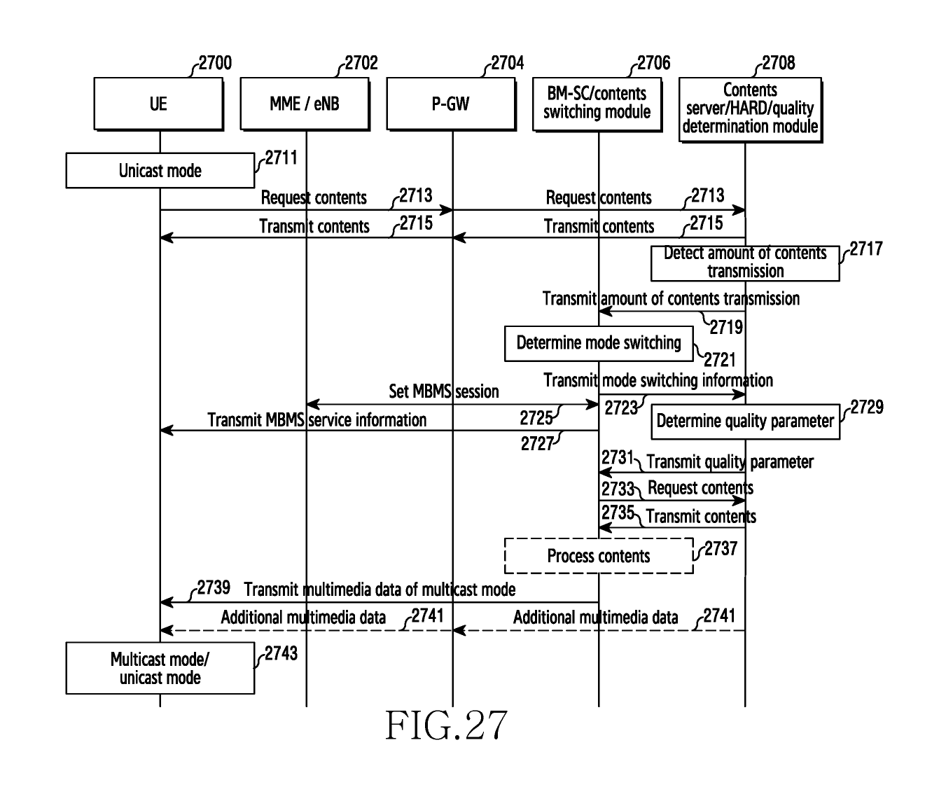

FIG. 27 is a signal flow diagram illustrating a process of switching to an MBMS mode and transmitting multimedia content according to an embodiment of the present disclosure.

Referring to FIG. 27, a UE 2700 provides a multimedia service in a unicast mode in operation 2711.

In operation 2713, the UE 2700 transmits a content request signal to a content server 2708 through the unicast session.

In operation 2715, the content server 2708 transmits multimedia content, to the UE 2700, through the unicast session, in response to the content request signal.

In operation 2717, a HARD module of the content server 2708 detects the total amount of multimedia content, which is transmitted to each UE through each unicast session from a P-GW 2704.

In operation 2719, the content server 2708 transmits the total amount of transmitted multimedia content, as detected by the HARD module, to a BM-SC 2706.

In operation 2721, the BM-SC 2706 determines to switch the corresponding multimedia content transmission type to an MBMS mode, based on the total amount of transmitted multimedia content, which has been provided from the content server 2708.

In operation 2723, the BM-SC 2706 transmits MBMS mode switching information, to the content server 2708, in response to the MBMS mode switching determination.

In operation 2725, the BM-SC 2706 sets an MBMS session with the eNB 2702, in response to the MBMS mode switching determination.

In operation 2727, the BM-SC 2706 transmits MBMS service information, to the UE 2700, through the eNB 2702, in response to MBMS session setup. For example, the BM-SC 2706 may set an MBMS session with the UE 2702, based on the MBMS service information through the eNB 2700.

In operation 2729, the content server 2708 determines the quality parameter of the MBMS mode through the quality determination module, in response to the MBMS mode switching information. For example, the quality determination module may determine the quality parameter of multimedia content, which is to be transmitted in the MBMS mode, based on the information regarding the service quality of multimedia content, which has been transmitted from the content server 2708 to each UE through the P-GW 2724.

In operation 2731, the content server 2708 transmits the quality parameter of the MBMS mode to the BM-SC 2706.

In operations 2733 and 2735, the content server 2708 transmits multimedia content to the BM-SC 2706, in response to the content request of the BM-SC 2706. For example, when multimedia content that has not been encoded hierarchically is stored in a content storage module, the content server 2708 may transmit multimedia content to the BM-SC 2706, in response to the content request of the BM-SC 2706. When hierarchically encoded multimedia content is stored in the content storage module, the content server 2708 may select at least a part of the hierarchically encoded multimedia content, which corresponds to the quality parameter of the MBMS mode, and transmit the selected part to the BM-SC 2706.

When multimedia content that has not been encoded hierarchically is received from the content server 2708, the BM-SC 2706 may hierarchically encode the multimedia content, which has been received from the content server 2708, through the content switching module in operation 2737. The BM-SC 2706 may select at least a part of the hierarchically encoded multimedia content, based on the quality parameter of the multimedia content.

However, when at least a part of the hierarchically encoded multimedia content is received from the content server 2708, the BM-SC 2706 may omit the content processing operation of operation 2737.

In operation 2739, the BM-SC 2706 transmits at least a part (e.g., multimedia data) of the multimedia content, to the UE 2700, through the MBMS session.

In operation 2743, the UE 2700 provides a multimedia service in a multicast mode. For example, the UE 2700 restores and reproduces multimedia content, based on the multimedia data provided through the MBMS session.

Alternatively, when the service quality regarding multimedia content should be improved, the UE 2700 may receive additional multimedia data from the content server 2708 through a unicast session in operation 2741. Thereafter, in operation 2743, the UE 2700 restores and reproduces the multimedia content with improved quality, based on the multimedia data provided through the MBMS session and the additional multimedia data provided through the unicast session.

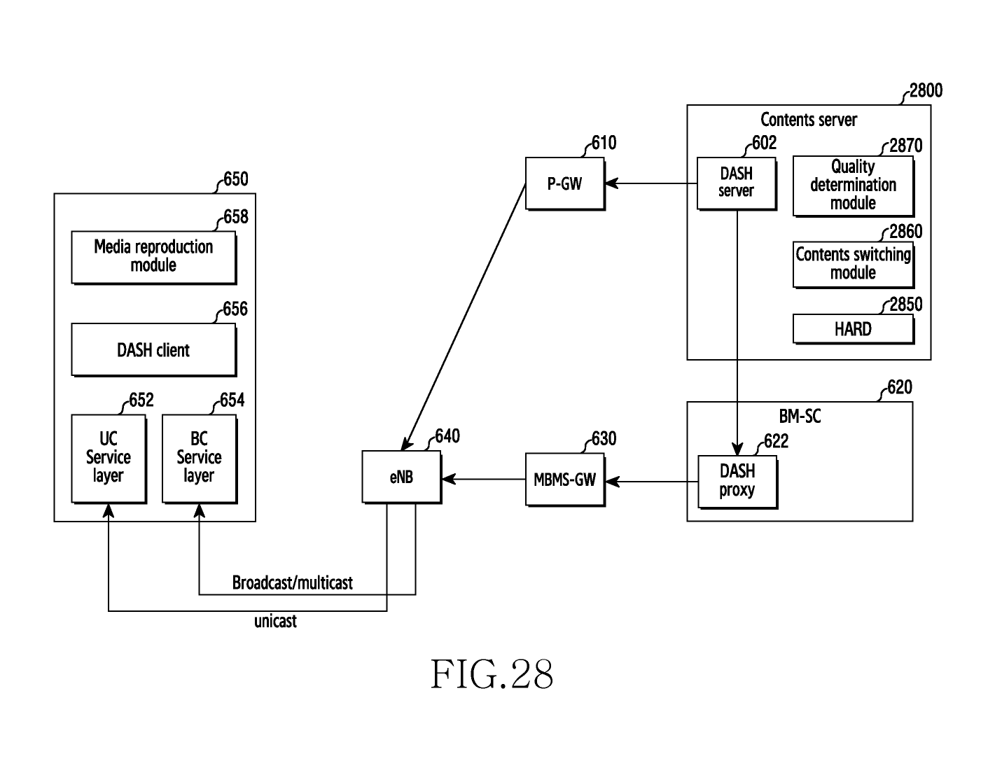

FIG. 28 illustrates a wireless communication system for switching to an MBMS mode according to an embodiment of the present disclosure. Notably, the elements in FIG. 28 are the same as those illustrated in FIGS. 6 and 7, except that the content server 600 is replaced with a content server 2800, which includes the DASH server 602, a content switching module 2860, a quality determination module 2870, and a HARD module 2850.

Referring to FIG. 28, the HARD module 2850 in the content server 2800 may detect the total amount of multimedia content, which is transmitted to each UE through the P-GW 610.

The BM-SC 620 may determine whether or not to switch the corresponding multimedia content transmission type to an MBMS mode, based on the total amount of transmitted multimedia content, as provided from the HARD module 2850 of the content server 2800.

When switching to the MBMS mode has been determined, the BM-SC 620 may set an MBMS session with the UE 650. The BM-SC 620 may transmit MBMS mode switching information to the content server 2800.

The quality determination module 2870 of the content server 2800 may determine the quality parameter in the MBMS mode, based on the service quality required by each UE that receives multimedia content, in response to the MBMS mode switching information.

The content server 2800 may process multimedia content, which is to be transmitted through the MBMS session, based on the quality parameter of multimedia content determined by the quality determination module 2870. For example, when information regarding hierarchically encoded multimedia content is stored in a content storage module (i.e., the content storage module 604 of FIG. 6), the content server 2800 may select at least a part of the hierarchically encoded multimedia content, which corresponds to the quality parameter of the multimedia content.

For example, when the original copy of multimedia content is stored in the content storage module, the content switching module 2860 may hierarchically encode the corresponding multimedia content. The DASH server 602 may select at least a part of the multimedia content, which has been hierarchically encoded by the content switching module 2860, based on the quality parameter of the multimedia content.

The content server 2800 may transmit at least a part (e.g., multimedia data) of multimedia content, which has been processed to correspond to the quality parameter of multimedia content, to the BM-SC 620.

The BM-SC 620 may transmit at least a part (e.g., multimedia data) of multimedia content, which has been provided from the content server 2800, to the UE 650, through the MBMS session.

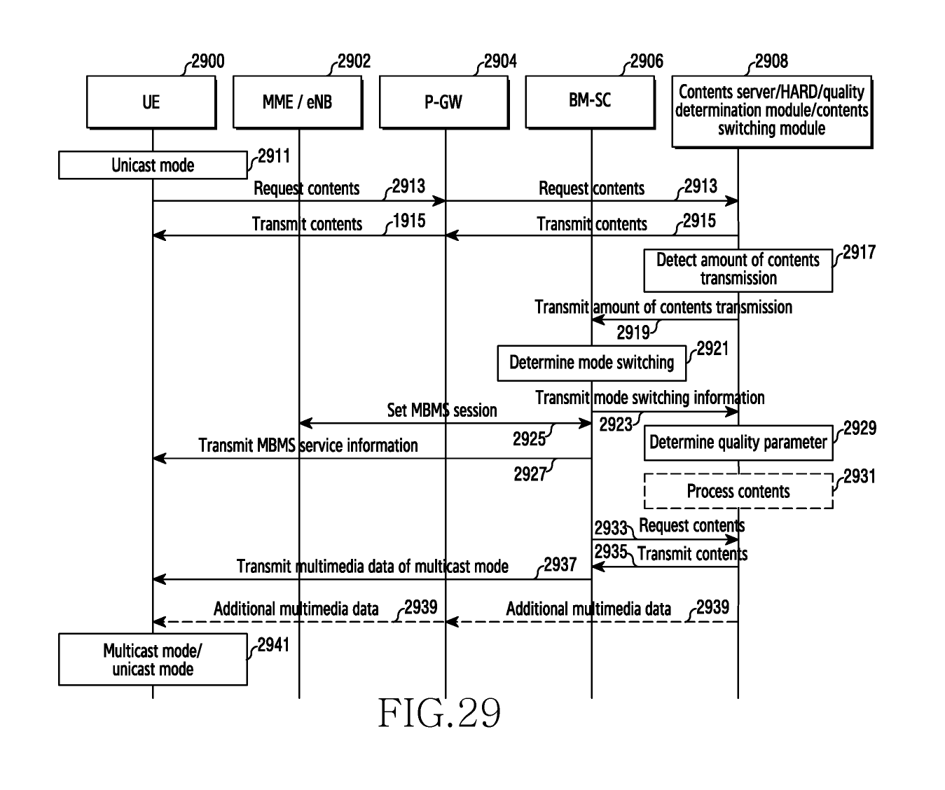

FIG. 29 is a signal flow diagram illustrating a process of switching to an MBMS mode and transmitting multimedia content according to an embodiment of the present disclosure.

Referring to FIG. 29, a UE 2900 provides a multimedia service in a unicast mode in operation 2911.

In operation 2913, the UE 2900 transmits a content request signal to a content server 2908 through the unicast session.

In operation 2915, the content server 2908 transmits multimedia content, to the UE 2900, through the unicast session, in response to the content request signal.

In operation 2917, 1 HARD module of the content server 2908 detects the total amount of multimedia content, which is transmitted to each UE through each unicast session from the P-GW 2904.

In operation 2919, the content server 2908 transmits the total amount of transmitted multimedia content, which has been detected by the HARD module, to a BM-SC 2906. For example, the content server 2908 may transmit the total amount of transmitted multimedia content, as detected by the HARD module, to the BM-SC 2906, in response to occurrence of a transmission event. The transmission event may occur periodically, or may be determined when the total amount of transmitted multimedia content exceeds a reference value.

In operation 2921, the BM-SC 2906 determines to switch the corresponding multimedia content transmission type to an MBMS mode, based on the total amount of transmitted multimedia content, which has been provided from the content server 2908.

In operation 2923, the BM-SC 2906 transmits MBMS mode switching information to the content server 2908, in response to the MBMS mode switching determination.

In operation 2925, the BM-SC 2906 sets an MBMS session with the eNB 2902, in response to the MBMS mode switching determination.

In operation 2927, the BM-SC 2906 transmits MBMS service information, to the UE 2900, through the eNB 2902, in response to MBMS session setup, and may set an MBMS session with the UE 2900.

In operation 2929, the content server 2908 determines the quality parameter of the MBMS mode through the quality determination module, in response to the MBMS mode switching information. For example, the quality determination module may determine the quality parameter of multimedia content, which is to be transmitted in the MBMS mode, based on the service quality information transmitted from the content server 2908 to each UE through a unicast session.

In operation 2931, the content server 2908 may process multimedia content, which is to be transmitted through the MBMS session, based on the quality parameter of multimedia content related to the MBMS mode. For example, when the multimedia content has not been encoded hierarchically, the content server 2908 may hierarchically encode the multimedia content through a content switching module in operation 2931. The content server 2908 may select at least a part of the hierarchically encoded multimedia content, based on the quality parameter of the multimedia content. However, when the multimedia content has been encoded hierarchically, the content server 2908 may omit the content processing operation of operation 2931.

In operations 2933 and 2935, the content server 2908 transmits at least a part (e.g., multimedia data) of multimedia content, which corresponds to the quality parameter of the MBMS mode, to the BM-SC 2906, in response to a content request of the BM-SC 2906.

In operation 2937, the BM-SC 2906 transmits at least a part (e.g., multimedia data) of the multimedia content, to the UE 2900, through the MBMS session.

In operation 2941, the UE 2900 provides a multimedia service in a multicast mode. For example, the UE 2900 restores and reproduces multimedia content, based on the multimedia data provided through the MBMS session.

Alternatively, when the service quality regarding multimedia content should be improved, the UE 2900 may receive additional multimedia data from the content server 2908 through a unicast session in operation 2939. Thereafter, in operation 2941, UE 2900 restores and reproduces the multimedia content with improved quality, based on the multimedia data provided through the MBMS session and the additional multimedia data provided through the unicast session.

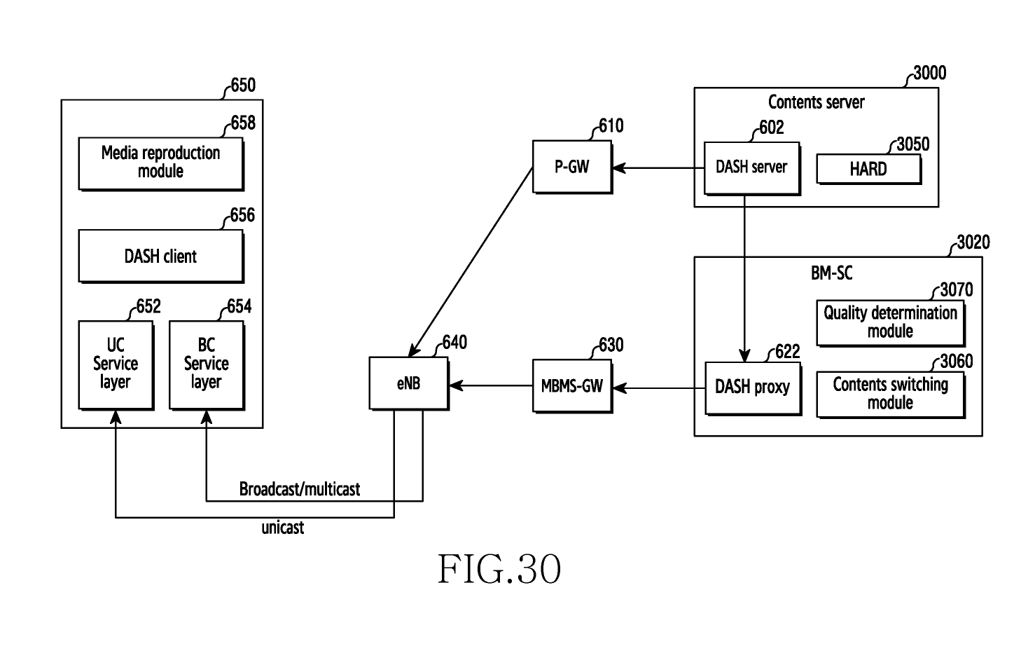

FIG. 30 illustrates a wireless communication system for switching to an MBMS mode according to an embodiment of the present disclosure. Notably, the elements in FIG. 30 are the same as those illustrated in FIGS. 6 and 7, except that the content server 600 is replaced with a content server 3000, which includes the DASH server 602 a HARD module 3050, and the BM-SC 620 is replace with a BM-SC 3020, which includes the DASH proxy 622, a content switching module 3060, and a quality determination module 3070.

Referring to FIG. 30, the HARD module 3050 in the content server 3000 may detect the total amount of multimedia content, which is transmitted to each UE through the P-GW 610.

The BM-SC 3020 may determine whether or not to switch the corresponding multimedia content transmission type to an MBMS mode, based on the total amount of transmitted multimedia content, as provided from the HARD module 3050 of the content server 3000.

When switching to the MBMS mode has been determined, the BM-SC 3020 may set an MBMS session with the UE 650. The BM-SC 620 may transmit MBMS mode switching information to the content server 3000.

When switching to the MBMS mode has been determined, the quality determination module 3070 of the BM-SC 3020 may determine the quality parameter in the MBMS mode, based on the service quality required by each UE that receives multimedia content. For example, the quality determination module 3070 may acquire the service quality that is required by the UE 650, from the UE 650 or from the content server 3000.

The content server 3000 may transmit multimedia content information, which is to be transmitted to the UE 650 through an MBMS session, to the BM-SC 3020, in response to MBMS mode switching information.

The BM-SC 3020 may conduct processing such that multimedia content, which has been provided from the content server 3000, based on the quality parameter of multimedia content determined by the quality determination module 3070, can be transmitted through the MBMS session. For example, the content switching module 3060 of the BM-SC 3020 may hierarchically encode multimedia content, which has been provided from the content server 3000. The BM-SC 3020 may select at least a part of the multimedia content, which has been hierarchically encoded by the content switching module 3060, the selected part corresponding to the quality parameter of the multimedia content.

The BM-SC 3020 may transmit at least a part (e.g., multimedia data) of multimedia content, which corresponds to the quality parameter of the multimedia content, to the UE 650, through the MBMS session.

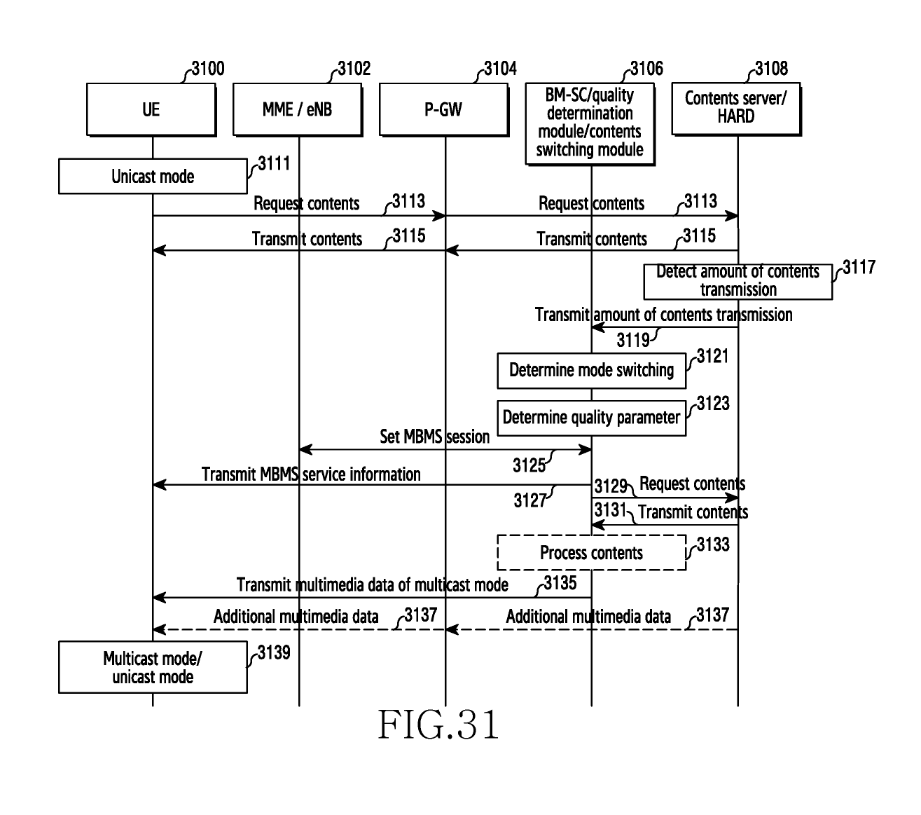

FIG. 31 is a signal flow diagram illustrating a process of switching to an MBMS mode and transmitting multimedia content according to an embodiment of the present disclosure.

Referring to FIG. 31, a UE 3100 provides a multimedia service in a unicast mode in operation 3111.

In operation 3113, the UE 3100 transmits a content request signal, to a content server 3108, through the unicast session.

In operation 3115, the content server 3108 transmits multimedia content, to the UE 3100, through the unicast session, in response to the content request signal.

In operation 3117, a HARD module of the content server 3108 detects the total amount of multimedia content, which is transmitted to each UE through each unicast session from the P-GW 3104.

In operation 3119, the content server 3108 transmits the total amount of transmitted multimedia content, which has been detected by the HARD module, to a BM-SC 3106.

In operation 3121, the BM-SC 3106 determines to switch the corresponding multimedia content transmission type to an MBMS mode, based on the total amount of transmitted multimedia content, which has been provided from the content server 3108.

In operation 3123, the BM-SC 3106 determines the quality parameter of the MBMS mode through a quality determination module, in response to the MBMS mode switching determination. For example, the quality determination module may determine the quality parameter of the MBMS mode, based on the service quality required by each UE that receives multimedia content through a unicast session. The quality determination module may receive information regarding the service quality of multimedia content that is required by the UE 3100, from the UE 3100 or from the content server 3108.

In operation 3125, the BM-SC 3106 sets an MBMS session with the eNB 3102, in response to the MBMS mode switching determination.

In operation 3127, the BM-SC 3106 transmits MBMS service information, to the UE 3100, through the eNB 3102, in response to MBMS session setup, and may set an MBMS session with the UE 3100.

In operations 3129 and 3131, the content server 3108 transmits multimedia content to the BM-SC 3106, in response to the content request of the BM-SC 3106.

In operation 3133, when multimedia content that has not been encoded hierarchically is received from the content server 3106, the BM-SC 3106 may hierarchically encode the multimedia content, which has been received from the content server 3108, through the content switching module. The BM-SC 3106 may select at least a part of the hierarchically encoded multimedia content, based on the quality parameter of the multimedia content. However, when the hierarchically encoded multimedia content is received from the content server 3108, the BM-SC 3106 may omit the content processing operation of operation 3133. Particularly, the BM-SC 3106 may select at least a part of the hierarchically encoded multimedia content, which have been provided from the content server 3108, based on the quality parameter of the multimedia content.

In operation 3135, the BM-SC 3106 transmits at least a part (e.g., multimedia data) of the multimedia content, to the UE 3100, through the MBMS session.

In operation 3139, the UE 3100 provides a multimedia service in a multicast mode. For example, the UE 3100 restores and reproduces multimedia content, based on the multimedia data provided through the MBMS session.

Alternatively, when the service quality regarding multimedia content should be improved, the UE 3100 may receive additional multimedia data from the content server 3108 through a unicast session in operation 3137. Thereafter, in operation 3139, UE 3100 restores and reproduces the multimedia content with improved quality, based on the multimedia data provided through the MBMS session and the additional multimedia data provided through the unicast session.

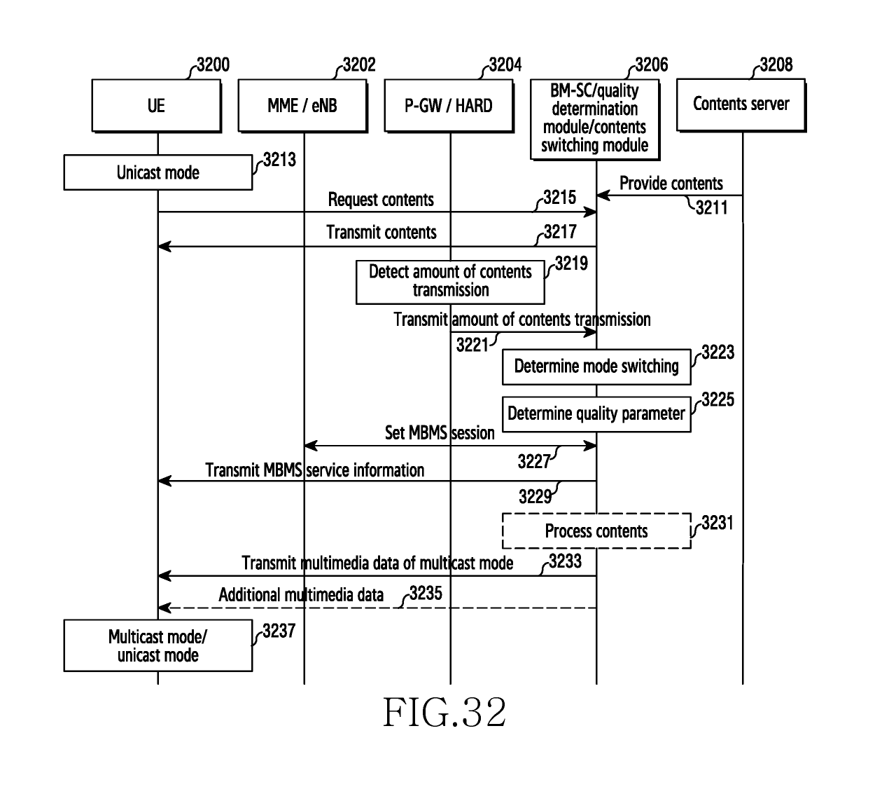

FIG. 32 is a signal flow diagram illustrating a process of transmitting multimedia content in connection with a network element according to an embodiment of the present disclosure. Specifically, the process illustrated in FIG. 32 is directed to a signal flow for controlling transmission of multimedia content by a BM-SC 3206, which includes a content storage module. However, when a different network element includes the content storage module, the corresponding network element may also control transmission of the multimedia content.

Referring to FIG. 32, the BM-SC 3206 receives multimedia content from a content server 3208 in operation 3211. For example, when a multimedia content use event occurs, the BM-SC 3206 may transmit a signal for requesting the corresponding multimedia content to a content server 3208. The content server 3208 may transmit the corresponding multimedia content to the BM-SC 3206, in response to the multimedia content request signal.

In operation 3213, the UE 3200 provides a multimedia service in a unicast mode. For example, the UE 3200 may set a unicast session through an eNB 3202 and a P-GW 3204.

In operation 3215, the UE 3200 transmits a content request signal to the BM-SC 3206 through the unicast session.

In operation 3217, the BM-SC 3206 transmits multimedia content, to the UE 3200, through the unicast session, in response to the content request signal.

In operation 3219, a HARD module of the P-GW 3204 detects the total amount of multimedia content, which is transmitted to each UE through each unicast session from the P-GW 3204.

In operation 3221, the P-GW 3204 transmits the total amount of transmitted multimedia content, as detected by the HARD module, to the BM-SC 3206. For example, when a transmission event has occurred, the P-GW 3204 may transmit the total amount of transmitted multimedia content, as detected by the HARD module, to the BM-SC 3206. For example, the transmission event may occur periodically or when the total amount of transmitted multimedia content exceeds a reference value.

In operation 3223, the BM-SC 3206 determines to switch the corresponding multimedia content transmission type to an MBMS mode, based on the total amount of transmission of multimedia content, which has been provided from the P-GW 3204.

In operation 3225, the BM-SC 3206 determines the quality parameter of the MBMS mode through a quality determination module, in response to the MBMS mode switching determination. For example, the quality determination module may determine the quality parameter of the MBMS mode, based on the quality of multimedia content, which is provided to each UE 3200 through the unicast session from the BM-SC 3206.

In operation 3227, the BM-SC 3206 sets an MBMS session with the eNB 3202, in response to the MBMS mode switching determination.

In operation 3229, the BM-SC 3206 transmits MBMS service information, to the UE 3200, through the eNB 3202, in response to MBMS session setup, and may set an MBMS session with the UE 3200. For example, the eNB 3202 may transmit MBMS session setup information to the UE 3200, in response to setup of an MBMS session with the BM-SC 3206, and may set a physical MBMS session with the UE 3200. The BM-SC 3206 may transmit MBMS service information, to the UE 3200, through the MBMS session. The MBMS service information may include the kind of the MBMS service (e.g., multimedia characteristics), service quality information, etc.

In operation 3233, the BM-SC 3206 transmits at least a part (e.g., multimedia data) of the multimedia content, to the UE 3200, through the MBMS session. For example, when hierarchically encoded multimedia content is stored in the content storage module of the BM-SC 3206, the BM-SC 3206 may select at least a part (e.g., multimedia data) of the hierarchically encoded multimedia content, which corresponds to the quality parameter of the MBMS mode, and transmit the selected part.

However, when the multimedia content stored in the content storage module has not been encoded hierarchically, the BM-SC 3206 may hierarchically encode the multimedia content through a content switching module in operation 3231. The BM-SC 3206 may then select at least a part (e.g., multimedia data) of the hierarchically encoded multimedia content, which corresponds to the quality parameter of the MBMS mode, and transmit the selected part.

In operation 3237, the UE 3200 provides a multimedia service in a multicast mode. For example, the UE 3200 restores and reproduces multimedia content, based on the multimedia data provided through the MBMS session.

Alternatively, when the service quality regarding multimedia content should be improved, the UE 3200 may receive additional multimedia data from the BM-SC 3206 through a unicast session in operation 3235. Thereafter, in operation 3237, the UE 3200 restores and reproduces the multimedia content with improved quality, based on the multimedia data provided through the MBMS session and the additional multimedia data provided through the unicast session.

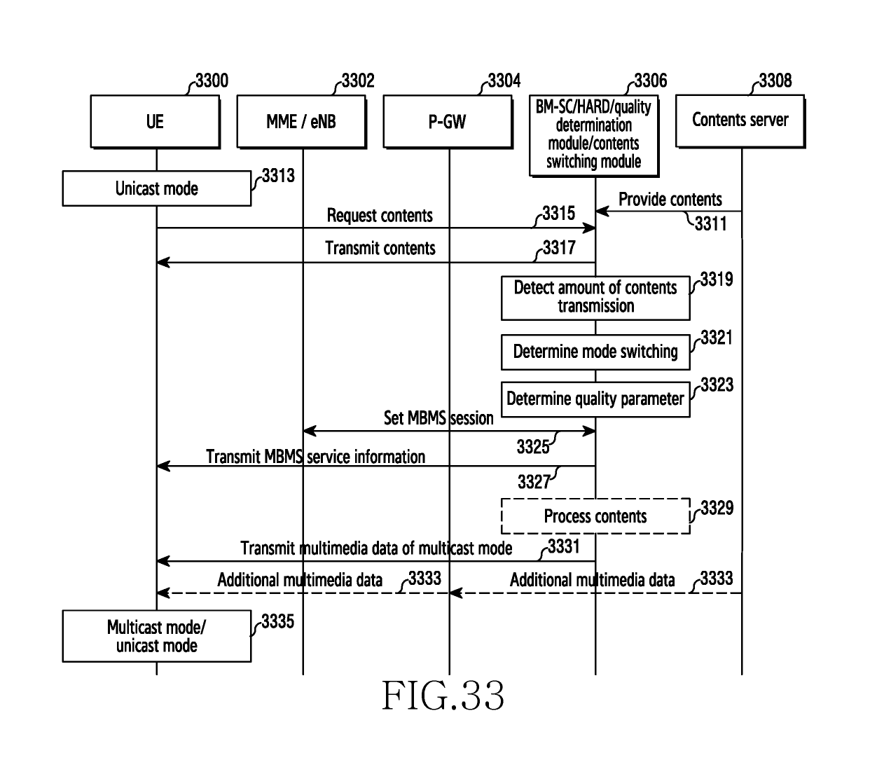

FIG. 33 is a signal flow diagram illustrating a process for transmitting multimedia content in connection with a network element according to an embodiment of the present disclosure. Specifically, the process illustrated in FIG. 33 is directed to a signal flow for controlling transmission of multimedia content by a BM-SC 3306, which includes a content storage module. However, when a different network element includes the content storage module, the corresponding network element may also control transmission of multimedia content.

Referring to FIG. 33, the BM-SC 3306 receives multimedia content from a content server 3308 in operation 3311. For example, the content server 3308 may transmit the corresponding multimedia content to the BM-SC 3306, in response to the multimedia content request signal from the BM-SC 3306.

In operation 3313, the UE 3300 provides a multimedia service in a unicast mode.

In operation 3315, the UE 3300 transmits a content request signal to the BM-SC 3306 through the unicast session.

In operation 3317, the BM-SC 3306 transmits multimedia content, to the UE 3300, through the unicast session, in response to the content request signal.

In operation 3319, a HARD module of the BM-SC 3306 detects the total amount of multimedia content, which is transmitted to each UE through a unicast session from the P-GW 3304.

In operation 3321, the BM-SC 3306 determines to switch the corresponding multimedia content transmission type to an MBMS mode, based on the total amount of transmitted multimedia content, as detected by the HARD module.

In operation 3323, the BM-SC 3306 determines the quality parameter of the MBMS mode through a quality determination module, in response to the MBMS mode switching determination. For example, the quality determination module may determine the quality parameter of the MBMS mode, based on the quality of multimedia content transmitted to each UE through a unicast session.

In operation 3325, the BM-SC 3306 set an MBMS session with the eNB 3302, in response to the MBMS mode switching determination.

In operation 3327, the BM-SC 3306 transmits MBMS service information, to the UE 3300, through the eNB 3302, in response to MBMS session setup, and may set an MBMS session with the UE 3300.

In operation 3331, the BM-SC 3306 transmits at least a part (e.g., multimedia data) of the multimedia content, to the UE 3300, through the MBMS session. For example, when the multimedia content stored in the content storage module has not been encoded hierarchically, the BM-SC 3306 may hierarchically encode the multimedia content through a content switching module in operation 3329. The BM-SC 3306 may then select at least a part (e.g., multimedia data) of the hierarchically encoded multimedia content, which corresponds to the quality parameter of the MBMS mode, and transmit the selected part. However, when hierarchically encoded multimedia content is stored in the content storage module of the BM-SC 3306, the BM-SC 3306 may omit the content processing operation of operation 3329. Particularly, the BM-SC 3306 may select at least a part of the hierarchically encoded multimedia content, so as to correspond to the quality parameter of the MBMS mode, and may transmit the selected part.

In operation 3335, the UE 3300 provides a multimedia service in a multicast mode. For example, the UE 3300 restores and reproduces multimedia content, based on the multimedia data provided through the MBMS session.

Alternatively, when the service quality regarding multimedia content should be improved, the UE 3300 may receive additional multimedia data from the BM-SC 3306 through a unicast session in operation 3333. Thereafter, in operation 3335, the UE 3300 restores and reproduces the multimedia content with improved quality, based on the multimedia data provided through the MBMS session and the additional multimedia data provided through the unicast session.

According to various embodiments of the present disclosure, an electronic device may include: a communication interface that transmits/receives signals; a processor electrically connected to the communication interface; and a memory electrically connected to the processor, wherein the memory may store instructions that, when executed, causes the processor to establish an MBMS session through the communication interface; to receive multimedia data through the MBMS session; to receive additional multimedia data through a unicast session in response to a user request; and to reproduce a high quality multimedia content corresponding to the multimedia data by decoding the received multimedia data with the received additional multimedia data.

According to various embodiments, the instructions may cause the processor to determine if the MBMS service corresponding to multimedia content is provided through the communication interface; to establish the MBMS session through the communication interface, if the MBMS service is provided.

According to various embodiments, the multimedia data may include a portion of the multimedia content encoded hierarchically, and the additional multimedia data may include a remaining portion of the multimedia content encoded hierarchically.

According to various embodiments, at least one of the multimedia data and the additional multimedia data is determined by a content providing node, based on service quality information required by the electronic device.

According to various embodiments, the additional multimedia data may be determined by the content providing node, further based on additional consideration of at least one of information regarding service settings of the electronic device, information regarding a billing system to which the electronic device is subscribed, and an amount of remaining data of the electronic device.

According to various embodiments, the instructions may cause the processor to receive, when the MBMS service regarding the multimedia content is not provided, information regarding the multimedia content through the unicast session and to reproduce the multimedia content based on the information regarding the multimedia content.

According to various embodiments, the instructions may cause the processor to determine whether an MBMS service corresponding to the multimedia content is provided through an MCCH.

According to various embodiments, the instructions may cause the processor to decode multimedia content based on the multimedia data, and to reproduce the decoded multimedia content.

According to various embodiments, the instructions may cause the processor to determine whether a service quality improvement is necessary based on quality of the decoded multimedia content, to transmit a quality improvement request signal to the content providing node in response to the service quality improvement determination, and to receive additional multimedia data through the unicast session in response to the quality improvement request signal.

According to various embodiments, the unicast session may be establish before the MBMS session is establish.

According to various embodiments, the instructions may cause the processor to set a unicast session in response to the service quality improvement and to receive additional multimedia data through the unicast session.

According to various embodiments of the present disclosure, an electronic device may include: a communication interface that transmits/receives signals; a processor electrically connected to the communication interface; and a memory electrically connected to the processor, wherein the memory may store instructions that, when executed, causes the processor to transmit multimedia content to at least one external device through at least one unicast session; to determine whether to switch an MBMS mode based on the amount of transmission of the multimedia content; to establish an MBMS session through the communication interface in response to the MBMS mode switching determination; to determine a quality parameter based on service quality required by the at least one external device; and to transmit at least a part of the multimedia content, which correspond to the quality parameter, through the MBMS session.

According to various embodiments, the instructions may cause the processor to determine, based on service quality required by the at least one external device, whether to improve service quality regarding the external device and to transmit additional multimedia data to an external device, service quality of which is deemed to require improvement, and the additional multimedia data may include at least a part of data remaining after excluding at least a part of the multimedia content.

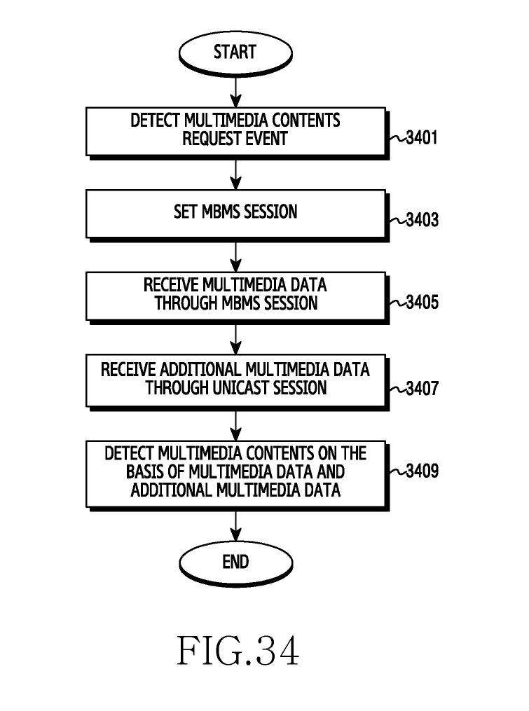

FIG. 34 is a flowchart illustrating a method for providing a multimedia service in connection with an electronic device according to an embodiment of the present disclosure.

Referring to FIG. 34, in operation 3401, an electronic device detects a multimedia content request event. For example, the electronic device may detect that multimedia content to be reproduced has been selected, based on input information, which is detected through an input/output interface, or sensor data, which is detected through a sensor module. When the selection of multimedia content is detected, the electronic device detects that a multimedia content request event has occurred.

In operation 3403, the electronic device sets an MBMS session with network elements in order to receive multimedia content. For example, the electronic device may receive corresponding multimedia content through a unicast session, in response to the multimedia content request event. The electronic device may confirm whether or not an MBMS service related to the corresponding multimedia content is provided, through an MCCH, while receiving the multimedia content. When an MBMS service related to the multimedia content is provided, the electronic device may set an MBMS session through an eNB and a BM-SC.

In operation 3405, the electronic device receives multimedia data through an MBMS session. For example, the electronic device may restore and reproduce multimedia data received through the MBMS session. The multimedia data may include at least a part (e.g., BL, EL1) of hierarchically encoded multimedia content. The multimedia data may be determined based on a quality parameter of an MBMS mode determined by a quality determination module.

In operation 3407, the electronic device receives additional multimedia data through a unicast session. For example, when the quality of multimedia content should be improved, the electronic device may transmit a quality improvement request signal to a multimedia content providing node. The electronic device may receive additional multimedia data through a unicast session, in response to the quality improvement request signal. The additional multimedia data may include at least a part (e.g., EL2) of data remaining after excluding multimedia data, which has already been received through the MBMS session, from hierarchically encoded multimedia content. The additional multimedia data may be determined based on the service quality required by the electronic device.

The multimedia content providing node may include a content server, which includes a content storage module, or at least one network element. The unicast session may be set, before MBMS session setup, in order to receive multimedia content, or may be set, after MBMS session setup, in order to improve the quality.

In operation 3409, the electronic device detects multimedia content using the multimedia data received through the MBMS session, and the additional multimedia data received through the unicast session.

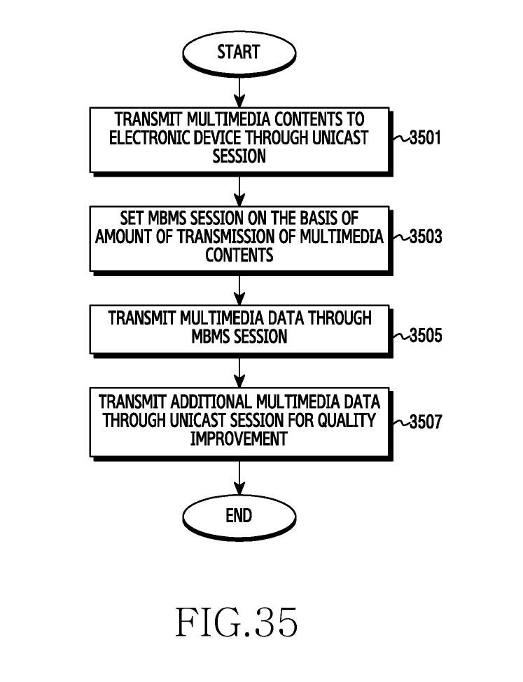

FIG. 35 is a flowchart illustrating a method for providing an MBMS service in connection with an electronic device for providing multimedia content according to an embodiment of the present disclosure.

Referring to FIG. 35, in operation 3501, an electronic device (for example, content server or a BM-SC) transmits multimedia content to at least one external device through a unicast session. For example, the electronic device may set a unicast session with the external device, in response to a multimedia content request signal provided from the external device. The electronic device may transmit multimedia content, which correspond to the multimedia content request signal, to the external device through the unicast session.

In operation 3503, the electronic device sets an MBMS session for providing multimedia content to at least one external device, based on the amount of multimedia content, which is transmitted through the unicast session. For example, if the total amount of multimedia content transmitted through each unicast session exceeds a reference value, the electronic device may transmit an MBMS mode switching request signal (e.g., MCCH, MBMS service announcement, etc.) to the external device and may set an MBMS session.

In operation 3505, the electronic device transmits multimedia data through an MBMS session. For example, the electronic device may determine the quality parameter of the MBMS mode, based on the service quality required by the external devices. The electronic device may select at least a part (e.g., multimedia data) of hierarchically encoded multimedia content, based on the quality parameter of the MBMS mode. The electronic device may transmit at least a part (e.g., multimedia data) of the hierarchically encoded multimedia content through an MBMS session.

In operation 3507, the electronic device transmits additional multimedia data through a unicast session, in order to improve the quality of multimedia content. For example, the electronic device may transmit, in response to a quality improvement request of an external device, additional multimedia data through a unicast session with the corresponding external device. The additional multimedia data may be determined based on the service quality required by the external device.

For example, the electronic device may determine whether or not to improve the quality based on the information regarding the state of the external device. When it is determined that the quality of multimedia content related to the external device should be improved, the electronic device may transmit additional multimedia data through unicast session. The electronic device may receive information regarding the state of the external device from a network element that stores user information, such as a home location register/home subscriber server (HLR/HSS). Information regarding the state of the external device may include at least one of the service quality required by the external device, information regarding service setup of the external device, information regarding the billing system to which the external device has subscribed, and the amount of remaining data for the external device.

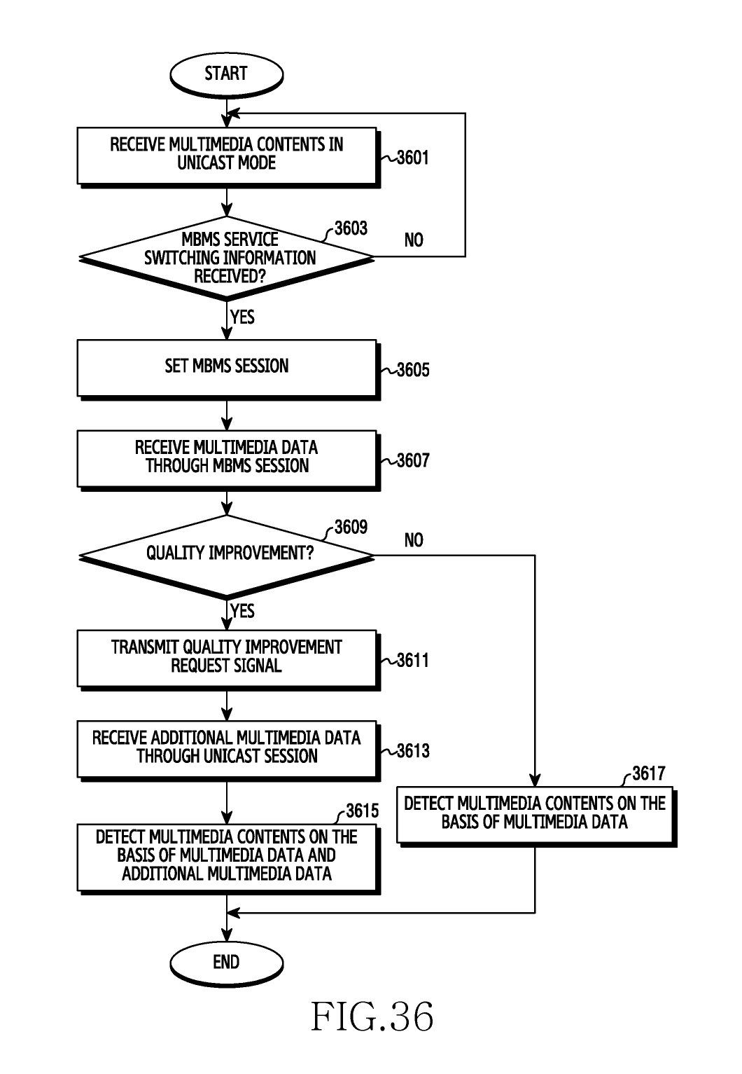

FIG. 36 is a flowchart illustrating a method for improving a quality of multimedia content through a unicast session in connection with an electronic device according to an embodiment of the present disclosure.

Referring to FIG. 36, in operation 3601, an electronic device receives multimedia content through a unicast session. For example, the electronic device may set a unicast session with a network element and a P-GW, in response to a multimedia content request event. The electronic device may transmit a multimedia content request signal, which corresponds to the multimedia content request event, through a unicast session, and may receive multimedia content, which corresponds to the request signal, through the unicast session.

In operation 3603, the electronic device determines whether or not MBMS service switching information is received, e.g., through a MCCH, while providing a multimedia service in a unicast mode.

When MBMS service switching information is not received in operation 3603, the electronic device receives multimedia content through the unicast session in operation 3601.

However, when MBMS service switching information is received in operation 3603, the electronic device sets an MBMS session in response to reception of the MBMS service switching information in operation 3605.

In operation 3607, the electronic device receives multimedia data through an MBMS session.

In operation 3609, the electronic device determines whether or not the quality of multimedia content should be improved. For example, the electronic device may control a display to display MBMS mode switching information in response to MBMS mode switching. The electronic device may determine whether or not the quality of multimedia content should be improved, based on user input information, which corresponds to MBMS mode switching information, the user's watching quality maintenance setup information, the user's free-of-charge preference setup information, etc.

In operation 3611, when it is determined that the quality of multimedia content should be improved in operation 3609, the electronic device transmits a quality improvement request signal to a multimedia content providing node.

In operation 3613, the electronic device receives additional multimedia data through a unicast session, in response to the quality improvement request signal.

In operation 3615, the electronic device detects multimedia content using the multimedia data received through the MBMS session, and the additional multimedia data received through the unicast session.

In operation 3617, when it has been determined that the quality of multimedia content should not be improved in operation 3609, the electronic device detects multimedia content using the multimedia data received through the MBMS session.

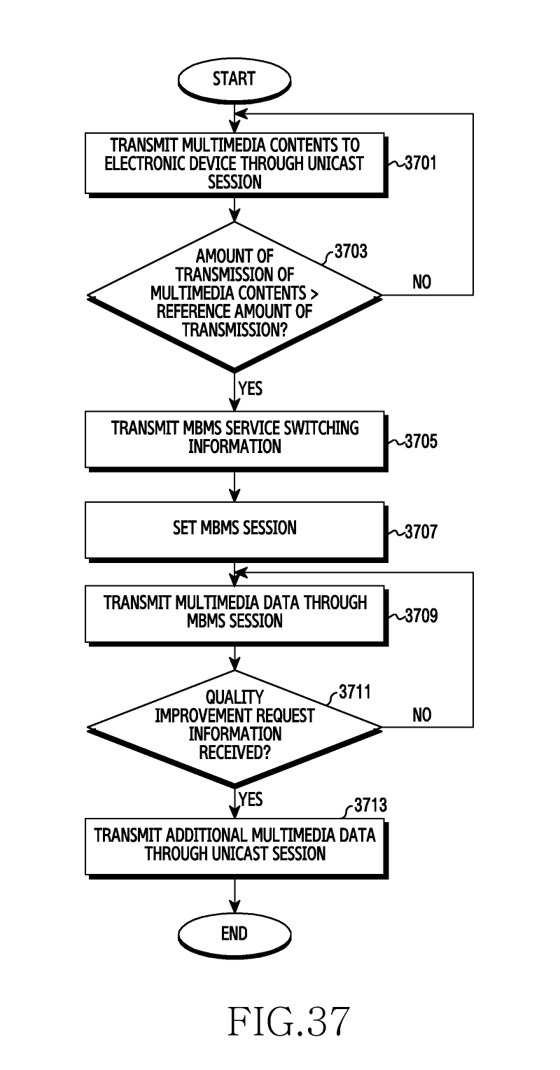

FIG. 37 is a flowchart illustrating a method for transmitting additional multimedia data through a unicast session in connection with an electronic device for transmitting multimedia content according to an embodiment of the present disclosure.

Referring to FIG. 37, in operation 3701, an electronic device (e.g., a content server or a BM-SC) transmits multimedia content to at least one external device through each unicast session.

In operation 3703, the electronic device determines whether or not the total amount of multimedia content, which is transmitted through each unicast session, exceeds a reference value. For example, a HARD module determine the total amount of transmitted multimedia content.

When the total amount of transmitted multimedia content is below the reference value in operation 3703, the electronic device continues to transmit multimedia content through each unicast session in operation 3701.

However, when the total amount of transmitted multimedia content exceeds the reference value in operation 3703, the electronic device transmits MBMS service switching information to the external device in operation 3705.

In operation 3707, the electronic device sets an MBMS session with the external device, in response to transmission of the MBMS service switching information.

In operation 3709, the electronic device transmits multimedia data through an MBMS session.

In operation 3711, the electronic device determines whether or not a quality improvement request signal is received from the external device.

When no quality improvement request signal is received from the external device in operation 3711, the electronic device continuously transmits multimedia data through the MBMS session in operation 3709.

However, when a quality improvement request signal is received from the external device in operation 3711, in operation 3713, the electronic device transmits additional multimedia data through a unicast session, in order to improve the quality of multimedia content. As described above, the additional multimedia data may be determined based on the service quality required by the external device.

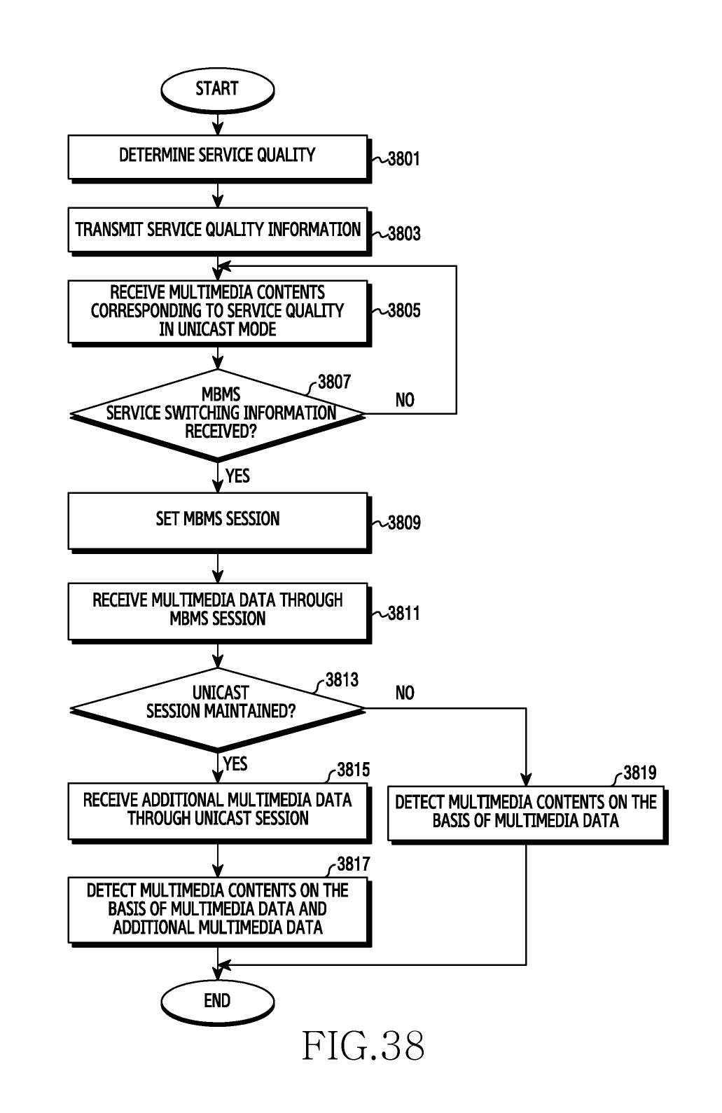

FIG. 38 is a flowchart illustrating a method for improving a quality of multimedia content through a unicast session, during MBMS service switching, in connection with an electronic device according to an embodiment of the present disclosure.

Referring to FIG. 38, in operation 3801, an electronic device determines a service quality of multimedia content for providing a multimedia service. For example, the electronic device may select multimedia content for providing a multimedia service, in response to a multimedia content request event, or may determine the service quality of multimedia content, based on input information detected through an input/output interface.

In operation 3803, the electronic device transmits multimedia content service quality information to a content providing node. For example, the electronic device may transmit a multimedia content request signal, which includes multimedia content service quality information, to a content providing node.

In operation 3805, the electronic device receives multimedia content corresponding to the service quality. For example, the electronic device may receive the multimedia content corresponding to the service quality through a unicast session.

In operation 3807, the electronic device determines or not whether MBMS service switching information is received, e.g., through an MCCH.

When no MBMS service switching information is received in operation 3807, the electronic device continues to receive multimedia content through the unicast session in operation 3805.

However, when MBMS service switching information is received in operation 3807, the electronic device sets an MBMS session in operation 3809.

In operation 3811, the electronic device receives multimedia data through the MBMS session.

In operation 3813, the electronic device determines whether or not the unicast session, which has been set to receive multimedia content in the unicast mode, is maintained.

When the unicast session is maintained in operation 3813, the electronic device receives additional multimedia data through the unicast session in operation 3815.

In operation 3817, the electronic device detects multimedia content using the multimedia data received through the MBMS session, and the additional multimedia data received through the unicast session.

In operation 3819, when the unicast session has been released in operation 3813, the electronic device detects multimedia content using the multimedia data received through the MBMS session.

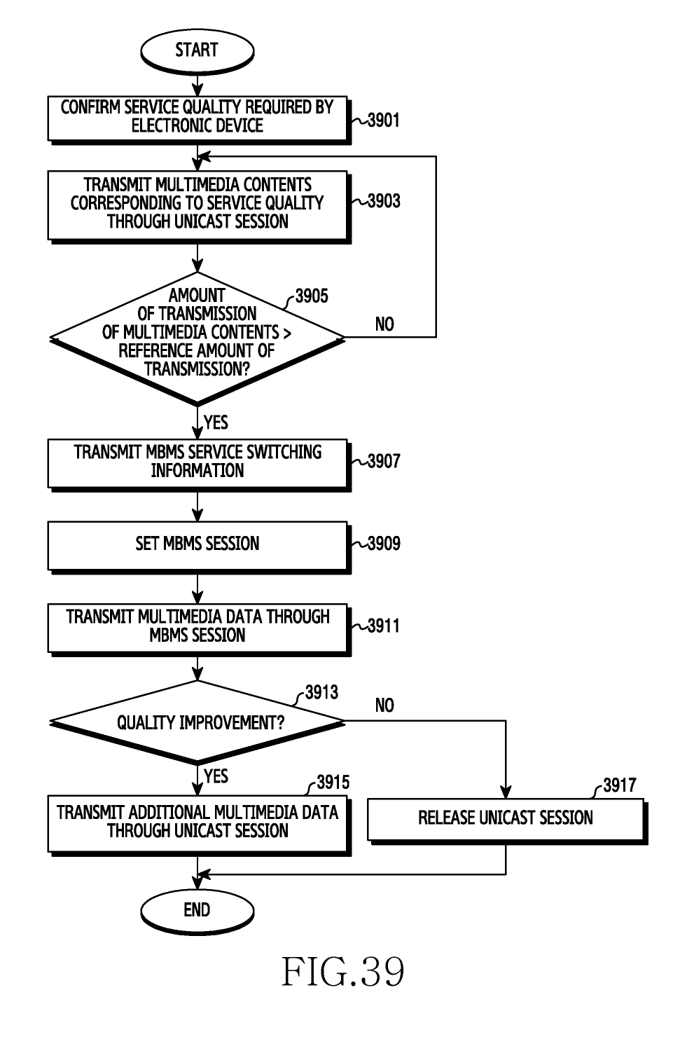

FIG. 39 is a flowchart illustrating a method for transmitting additional multimedia data through a unicast session, during MBMS service switching, in connection with an electronic device for transmitting multimedia content according to an embodiment of the present disclosure.

Referring to FIG. 39, in operation 3901, an electronic device (e.g., a content server or a BM-SC) identifies a service quality required by an external device in a unicast mode. For example, the electronic device may extract information regarding the service quality of multimedia content that is required by the external device, from a multimedia content request signal received from the external device.

In operation 3903, the electronic device transmits multimedia content corresponding to the service quality of each external device, through each unicast session.

In operation 3905, the electronic device determines whether or not the total amount of multimedia content transmitted through each unicast session exceeds a reference value.

When the total amount of transmission of multimedia content transmitted through the unicast session is below the reference value in operation 3905, the electronic device continues to transmit multimedia content through each unicast session in operation 3903.

In operation 3907, when the total amount of transmission of multimedia content transmitted through the unicast session exceeds the reference value in operation 3905, the electronic device transmits MBMS service switching information to the external device.

In operation 3909, the electronic device sets an MBMS session with the external device, in response to transmission of the MBMS service switching information.

In operation 3911, the electronic device transmits multimedia data through an MBMS session.

In operation 3913, the electronic device determines whether or not the external device should receive quality improvement.

In operation 3915, when it has been determined that the external device should receive quality improvement in operation 3913, the electronic device transmits additional multimedia data through a unicast session set during a unicast mode. The additional multimedia data may be determined based on the service quality required by the external device.

In operation 3917, when it has been determined that the external device should not receive quality improvement, the electronic device releases the unicast session set during the unicast mode.

During operations 3913, 3915, and 3917, the electronic device may continuously transmit multimedia data through the MBMS session.

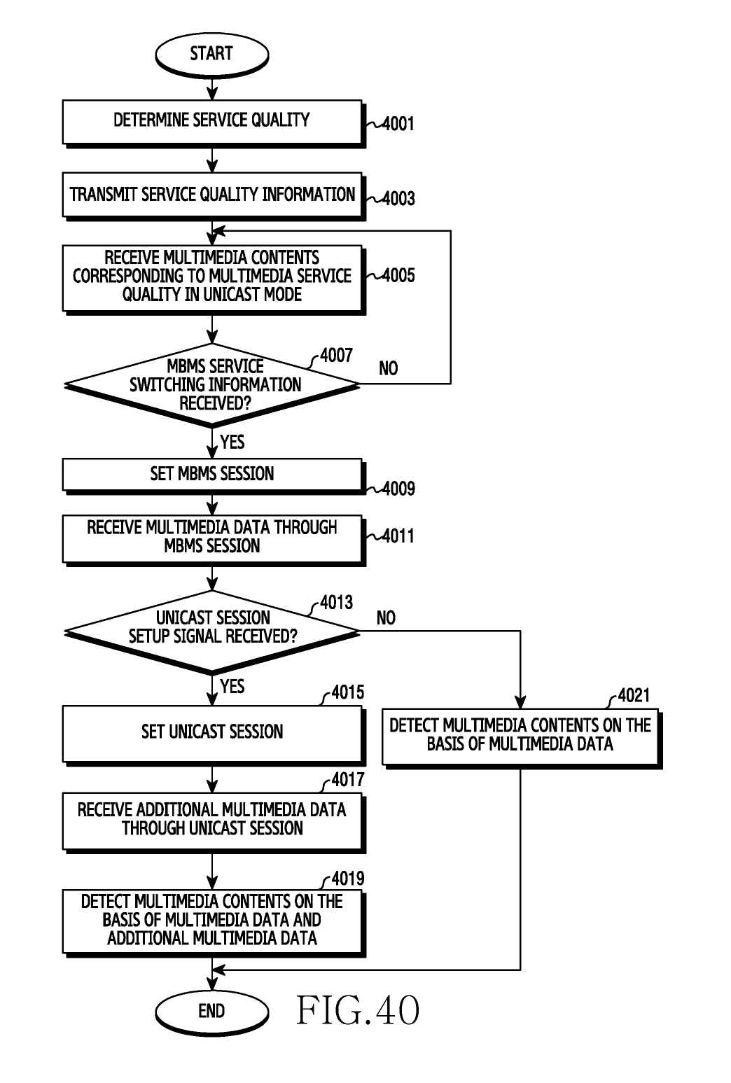

FIG. 40 is a flowchart illustrating a method for additionally setting a unicast session, during MBMS service switching, and improving quality of multimedia content in connection with an electronic device according to an embodiment of the present disclosure.

Referring to FIG. 40, in operation 4001, an electronic device determines a service quality of multimedia content for providing a multimedia service. For example, the electronic device may determine the service quality of multimedia content for providing a multimedia service in response a multimedia content request event.

In operation 4003, the electronic device transmits multimedia content service quality information to a content providing node. For example, the electronic device may transmit a multimedia content request signal to a content providing node in response to a multimedia content request event. The multimedia content request signal may include multimedia content service quality information.

In operation 4005, the electronic device receives multimedia content corresponding to the service quality. For example, the electronic device may reproduce multimedia content received through a unicast session.

In operation 4007, the electronic device determines whether or not MBMS service switching information is received, e.g., through an MCCH.

When no MBMS service switching information is received in operation 4007, the electronic device continuously receives multimedia content through the unicast session in operation 4005.

However, when MBMS service switching information is received in operation 4007, the electronic device sets an MBMS session in operation 4009. For example, the electronic device may set a physical MBMS session with a network element based on the MBMS service switching information provided from an eNB through an MCCH. The electronic device may determine MBMS service information based on the service announcement information provided from a BM-SC through an MBMS session.

In operation 4011, the electronic device receives multimedia data through an MBMS session. For example, the electronic device may decode at least a part (e.g., multimedia data) of hierarchically encoded multimedia content, which has been received through the MBMS session, and may restore multimedia content.

In operation 4013, the electronic device determines whether or not a unicast session setup request signal is received from a content providing node (e.g., a content server or a BM-SC).

When the unicast session setup request signal is received in operation 4013, the electronic device sets a unicast session with a network element in operation 4015. For example, the electronic device may control a communication interface to set a unicast session.

In operation 4017, the electronic device receives additional multimedia data through a unicast session. The additional multimedia data may have been determined by the content providing node, based on the multimedia content service quality information determined in operation 4001.

In operation 4019, the electronic device detects multimedia content using the multimedia data received through the MBMS session, and the additional multimedia data received through the unicast session.

When no unicast session setup request signal has been received in operation 4013, the electronic device restores multimedia content using the multimedia data received through the MBMS session in operation 4021.

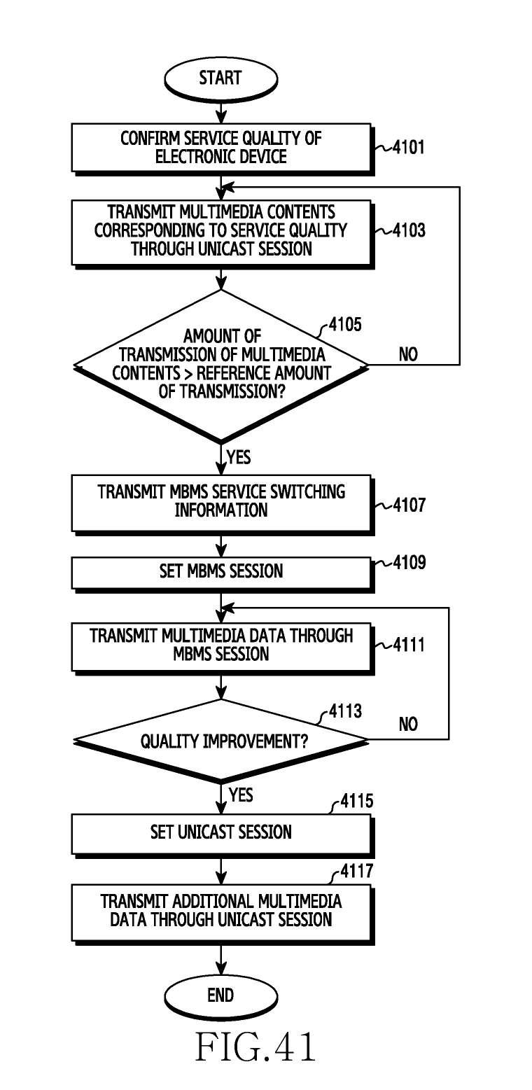

FIG. 41 is a flowchart illustrating a method for additionally setting a unicast session, during MBMS service switching, and transmitting additional multimedia data in connection with an electronic device for transmitting multimedia content according to an embodiment of the present disclosure.

Referring to FIG. 41, in operation 4101, an electronic device (e.g., a content server or a BM-SC) identifies a service quality required by an external device in a unicast mode. For example, the electronic device may identify information regarding the service quality of corresponding multimedia content from a multimedia content request signal received from the external device.

In operation 4103, the electronic device transmits multimedia content corresponding to the service quality required by the external device, through a unicast session with the external device.

In operation 4105, the electronic device determines whether or not the total amount of transmission of multimedia content, which is transmitted through at least one unicast session, exceeds a reference value. For example, the electronic device may determine whether or not the total amount of transmitted multimedia content, as detected by a HARD module, exceeds a reference value.

When the total amount of transmitted multimedia content is below the reference value in operation 4105, the electronic device may transmit multimedia content through a unicast session with the external device in operation 4103.

In operation 4107, when the total amount of transmission of multimedia content transmitted through the unicast session exceeds the reference value in operation 4105, the electronic device transmits MBMS service switching information to the external device, e.g., through an MCCH.

In operation 4109, the electronic device sets an MBMS session with the external device.

In operation 4111, the electronic device transmits multimedia data through an MBMS session. For example, a quality determination module of the electronic device may determine a quality parameter of the MBMS mode, based on the service quality required by the external devices. A BM-SC may select at least a part (e.g., multimedia data) of hierarchically encoded multimedia content, based on the quality parameter of the MBMS mode and may transmit the selected part to the external device through the MBMS session.

In operation 4113, the electronic device determines whether or not the external device needs quality improvement. For example, the electronic device may compare the service quality required by an external device and the quality parameter of the MBMS mode, in order to determine whether or not the external device requires quality improvement. Additionally, the electronic device may determine whether or not it can support quality improvement of an external device, based on information regarding service setup of the external device, information regarding the billing system, to which the external device has subscribed, and/or the amount of remaining data of the external device (amount of free-of-charge data).

When the external device requires no quality improvement in operation 4113, the electronic device continuously transmits multimedia data through the MBMS session in operation 4111.

In operation 4115, when the external device requires quality improvement in operation 4113, the electronic device sets a unicast session with the external device.

In operation 4117, the electronic device transmits additional multimedia data through the unicast session, in response to unicast session setup. The additional multimedia data may be determined based on the information regarding the state of the external device.

The electronic device may release the unicast session with the external device after determining MBMS service switching. For example, the electronic device may release the unicast session with the external device in response to MBMS session setup. The electronic device may also release the unicast session with the external device in response to multimedia data transmission through an MBMS session.

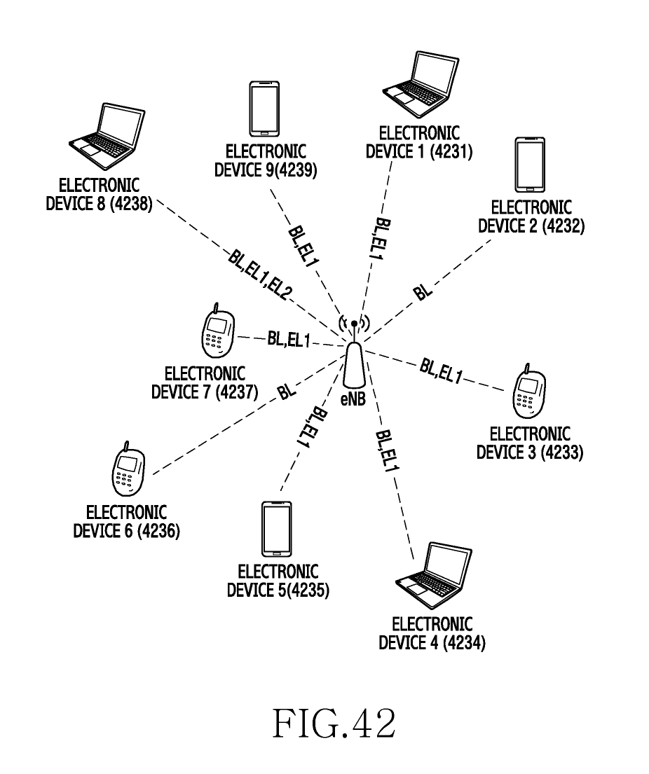

FIG. 42 illustrates a configuration for transmitting multimedia data corresponding to different service qualities of multimedia content of electronic devices according to an embodiment of the present disclosure.

Referring to FIG. 42, a content providing node (e.g., a BM-SC) may determine a service quality of an MBMS mode based on respective multimedia service qualities required by electronic devices.

The content providing node may transmit at least a part (e.g., multimedia data) of hierarchically encoded multimedia content, based on the service quality of the MBMS mode, through an MBMS session. For example, the content determination module may hierarchically encode multimedia content in order to generate multimedia data of BL, EL1, and EL2. The content providing node may transmit “BL” multimedia data, which corresponds to the service quality of the MBMS mode, among the hierarchically encoded multimedia content to electronic devices 4231 to 4239, through the MBMS session.

The content providing node may determine whether or not a service quality improvement is necessary, based on the information regarding the state of each electronic device. For example, the content providing node may determine that the electronic device 1 4231, the electronic device 3 4233, the electronic device 4 4234, the electronic device 5 4235, the electronic device 7 4237, the electronic device 8 4238, and the electronic device 9 4239 need service quality improvements.

The content providing node may transmit additional multimedia data that is determined based on information regarding the state of each electronic device, to each electronic device through a unicast session. For example, the content providing node may determine additional multimedia data of the electronic device 1 4231, the electronic device 3 4233, the electronic device 4 4234, the electronic device 5 4235, the electronic device 7 4237, and the electronic device 9 4239 as EL1, based on information regarding the state of each electronic device. The content providing node may transmit additional multimedia data EL1 to the corresponding electronic devices through each unicast session. For example, the content providing node may determine additional multimedia data of the electronic device 8 4238 as EL1 and EL2, based on the information regarding the state of electronic device 8 4238, and then transmit the additional multimedia data EL1 and EL2 to the electronic device 8 4238, through a unicast session with the electronic device 8 4238.

The electronic device may receive additional multimedia data using a different communication type, such as Wi-Fi, Bluetooth, BLE (Bluetooth low energy), etc.

According to various embodiments of the present disclosure, a method for operating an electronic device may include: establishing an MBMS session through a communication interface; receiving multimedia data through the MBMS session; receiving additional multimedia data through a unicast session in response to a user request; and reproducing a high quality multimedia content corresponding to the multimedia data by decoding the received multimedia data with the received additional multimedia data.

According to various embodiments, the method may further include: determining if the MBMS service corresponding to multimedia content is provided; establishing an MBMS session through a communication interface, if the MBMS service is provided.

According to various embodiments, the method may further include: receiving, when an MBMS service regarding the multimedia content is not provided, information regarding the multimedia content through the unicast session and reproducing the multimedia content based on the information regarding the multimedia content.

According to various embodiments, the determining whether an MBMS service is provided may further include determining whether an MBMS service corresponding to the multimedia content is provided through a MCCH (multicast control channel).

According to various embodiments, the method may further include: decoding multimedia content based on the multimedia data received through the MBMS session; and reproducing the decoded multimedia content.

According to various embodiments, the receiving additional multimedia data may further include: determining whether a service quality improvement is necessary or not based on quality of the decoded multimedia content, transmitting a quality improvement request signal to a content providing node in response to the service quality improvement determination, and receiving additional multimedia data through the unicast session in response to the quality improvement request signal.

According to various embodiments, the receiving additional multimedia data may further include: establishing a unicast session in response to the service quality improvement; and receiving additional multimedia data through the unicast session.

According to various embodiments of the present disclosure, a method for operating an electronic device may include: transmitting multimedia content to at least one external device through at least one unicast session; determining whether to switch an MBMS mode based on the amount of transmission of the multimedia content; establishing an MBMS session through the communication interface in response to the MBMS mode switching determination; determining a quality parameter based on service quality required by the at least one external device; and transmitting at least a part of the multimedia content, which correspond to the quality parameter, through the MBMS session.

According to various embodiments, the method may further include: determining, based on service quality required by the at least one external device, whether to improve service quality regarding the external device and transmitting additional multimedia data to an external device, service quality of which is deemed to require improvement, and the additional multimedia data may include at least a part of data remaining after excluding at least a part of the multimedia content.

A node (for example, network device or content server) that provides multimedia content and a method for operating the same, according to various embodiments, provide multimedia content to each electronic device based on the service quality required by electronic devices that receive multimedia content, thereby improving the service quality related to the electronic devices.

An electronic device and a method for operating the same, according to various embodiments, receive and decode hierarchically encoded multimedia data through an MBMS session or through MBMS session and a unicast session, based on the service quality required by the user of the electronic device, thereby satisfying the service quality required by the user of the electronic device.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

Herein, the term “module” may mean a unit including one of hardware, software, and firmware or a combination of two or more of them. The term “module” may be interchangeably used with “unit”, “logic”, “logical block”, “component”, or “circuit”. A “module” may be a minimum unit of an integrated component element or a part thereof. A “module” may be a minimum unit for performing one or more functions or a part thereof. A “module” may be mechanically or electronically implemented. For example, a “module” may include at least one of an Application-Specific Integrated Circuit (ASIC) chip, a Field-Programmable Gate Arrays (FPGA), and a programmable-logic device for performing operations which has been known or are to be developed hereinafter.

According to various embodiments described above, at least some of the devices (e.g., modules or functions thereof) or the method (e.g., operations) according to the present disclosure may be implemented by a command stored in a computer-readable storage medium in a program module form. The instructions, when executed by a processor (e.g., the processor 220), may cause the one or more processors to execute the function corresponding to the instruction. The computer-readable storage medium may be, for example, the memory 230.

The computer readable recoding medium may include a hard disk, a floppy disk, magnetic media (for example, a magnetic tape), optical media (for example, a Compact Disc Read Only Memory (CD-ROM) and a DVD), magneto-optical media (for example, a floptical disk), a hardware device (for example, a Read Only Memory (ROM), a Random Access Memory (RAM), a flash memory), etc. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. An electronic device comprising:
a communication interface;
a processor; and
a memory that stores instructions that, when executed, cause the processor to:
establish an MBMS session through the communication interface;
receive multimedia data through the MBMS session;
receive additional multimedia data through a unicast session in response to a user request; and
reproduce a high quality multimedia content corresponding to the multimedia data by decoding the received multimedia data with the received additional multimedia data.

2. The electronic device of claim 1, wherein the multimedia data comprises a portion of the multimedia content encoded hierarchically, and
wherein the additional multimedia data comprises a remaining portion of the multimedia content encoded hierarchically.

3. The electronic device of claim 2, wherein at least one of the multimedia data and the additional multimedia data is determined by a content providing node, based on service quality information required by the electronic device.

4. The electronic device of claim 3, wherein the additional multimedia data is determined by the content providing node, further based on at least one of information regarding service settings of the electronic device, information regarding a billing system to which the electronic device is subscribed, and an amount of remaining data of the electronic device.

5. The electronic device of claim 1, wherein the instructions further cause the processor to:
receive, if the MBMS service is not provided, information regarding the multimedia content through the unicast session, and
reproduce the multimedia content, based on the information regarding the multimedia content.

6. The electronic device of claim 1, wherein the instructions further cause the processor to determine whether the MBMS service corresponding to the multimedia content is provided through a multicast control channel (MCCH).

7. The electronic device of claim 1, wherein the instructions further cause the processor to:
decode the multimedia content based on the received multimedia data,
reproduce the decoded multimedia content.

8. The electronic device of claim 7, wherein the instructions further cause the processor to:
determine whether a service quality improvement is necessary, based on a quality of the multimedia content,
transmit a quality improvement request signal to the content providing node, in response to determining the service quality improvement is necessary, and
receive the additional multimedia data through the unicast session, in response to the quality improvement request signal.

9. The electronic device of claim 1, wherein the unicast session is establish before the MBMS session is establish.

10. The electronic device of claim 1, wherein the instructions further cause the processor to set the unicast session in response to a service quality improvement request signal.

11. A method for operating an electronic device, the method comprising:
establishing an MBMS session through a communication interface;
receiving multimedia data through the MBMS session;
receiving additional multimedia data through a unicast session in response to a user request, and
reproducing a high quality multimedia content corresponding to the multimedia data by decoding the received multimedia data with the received additional multimedia data.

12. The method of claim 11, wherein the multimedia data comprises a portion of the multimedia content encoded hierarchically, and
wherein the additional multimedia data comprises a remaining portion of the multimedia content encoded hierarchically.

13. The method of claim 12, wherein at least one of the multimedia data and the additional multimedia data is determined by a content providing node, based on service quality information required by the electronic device.

14. The method of claim 11, further comprising:
receiving, when an MBMS service regarding the multimedia content is not provided, information regarding the multimedia content through the unicast session; and
reproducing the multimedia content, based on the information regarding the multimedia content.

15. The method of claim 11, wherein determining whether the MBMS service is provided comprises determining if the MBMS service corresponding to the multimedia content is provided through a multicast control channel (MCCH).

16. The method of claim 11, wherein reproducing the multimedia content comprises:
decoding the multimedia content based on the received multimedia data; and
reproducing the decoded multimedia content.

17. The method of claim 16, further comprising:
determining whether a service quality improvement is necessary, based on a quality of the multimedia content;
transmitting a quality improvement request signal to a content providing node, in response to determining the service quality improvement is necessary; and
receiving the additional multimedia data through the unicast session, in response to the quality improvement request signal.

18. The method of claim 11, further comprising establishing a unicast session before the MBMS session is establish.

19. An electronic device comprising:
a communication;
a processor; and
a memory that stores instructions that, when executed, cause the processor to:
transmit multimedia content to an external device through a unicast session;
determine whether to switch an MBMS mode, based on an amount of the multimedia content transmitted;
establish an MBMS session through the communication interface, in response to determining to switch the MBMS mode;
determine a quality parameter, based on a service quality required by the external device; and
transmit a first portion of the multimedia content, which corresponds to the quality parameter, through the MBMS session.

20. The device of claim 19, wherein the instructions further cause the processor to:
determine, based on the service quality required by the external device, whether a service quality improvement is required by the external device, and
transmit additional multimedia data to the external device, in response to determining the service quality improvement is required, and
wherein the additional multimedia data comprises a second portion of the multimedia content.
